(19) United States
(12) Patent Application Publication
(10) Pub. No.: US 2022/0058531 A1
(43) Pub. Date: Feb. 24, 2022

(54) SYSTEM AND METHOD FOR CASCADING DECISION TREES FOR EXPLAINABLE REINFORCEMENT LEARNING

(71) Applicant: ROYAL BANK OF CANADA, Toronto (CA)

(72) Inventors: Zihan DING, Yantai (CN); Pablo Francisco HERNANDEZ-LEAL, Edmonton (CA); Weiguang DING, Toronto (CA); Changjian LI, Edmonton (CA); Ruitong HUANG, Toronto (CA)

(21) Appl. No.: 17/406,759

(22) Filed: Aug. 19, 2021

Related U.S. Application Data
(60) Provisional application No. 63/067,590, filed on Aug. 19, 2020.

(51) Int. Cl. G06N 20/20; G06F 16/901

(52) U.S. Cl. CPC G06N 20/20; G06F 16/9027

(57) ABSTRACT

The approaches described herein are adapted to provide a technical, computational mechanism to aid in improving explainability of machine learning architectures or for generating more explainable machine learning architectures. Specifically, the approaches describe a proposed implementation of cascading decision tree (CDT) based representation learning data models which can be structured in various approaches to learn features of varying complexity.

### CROSS REFERENCE

This application is a non-provisional of, and claims all benefit, including priority to U.S. Application No. 63/067,590, dated 2020 Aug. 19, entitled “SYSTEM AND METHOD FOR CASCADING DECISION TREES FOR EXPLAINABLE REINFORCEMENT LEARNING”, incorporated herein by reference in its entirety.

### FIELD

Embodiments of the present disclosure relate to the field of machine learning, and more specifically, embodiments relate to devices, systems and methods for using cascading decision tree approaches for explaining or varying machine learning outputs.

### INTRODUCTION

A core challenge with machine learning and artificial intelligence is a lack of explainability in outputs provided by the machine learning mechanisms. In particular, for reinforcement learning (RL), explaining the policy of RL agents still remains an open problem due to several factors, one being the complexity of explaining neural networks decisions.

Accordingly, this reduces widespread adoption of machine learning, especially for sensitive applications or particularly high value applications of machine learning. For example, a machine learning system that lacks transparency in how it ultimately operates can inadvertently emphasize unconscious biases of the engineers that developed the models, or biases prevalent in training and/or arising from the architecture of the machine learning model itself.

When the models are to be deployed in the domains where the accountability of the decisions is critical, such as in healthcare or in law enforcement, the demand on model interpretability is inevitable and sometimes may outweigh model performance.

Indeed, in these domains, the model can be adopted only after the trust on the model can be built, which heavily depends on the model interpretability.

### SUMMARY

An approach to aiding in the interpretation of machine learning models is the conversion of a difficult to explain machine learning model into a more explainable model. A number of different embodiments proposed herein are directed to training cascading decision trees to mimic representations of the input machine learning model, such that the decision nodes of the cascading decision trees can be utilized to obtain explanations in respect of outcomes generated by the machine learning model. As noted here, this conversion is technically challenging in practical implementations where computing resources are finite, and thus different embodiments are described that aid in improving accuracy or reducing overall complexity in the computation. For example, a partitioned decision tree is proposed in some embodiments having two separate nodal networks, at least one feature learning tree data structure (F) and a decision making tree data structure (D). The approach can be provided in the form of a physical computing device such as a computer server or a hardware computing appliance that is adapted to receive input machine learning models and output data sets representing a cascading decision tree-based representation.

Soft decision trees (SDTs) and discretized differentiable decision trees (DDTs) have been demonstrated to achieve both good performance and share the benefit of having explainable policies. Traditional decision tree approaches, however, suffer from weak expressivity and therefore low accuracy. While alternate approaches include differentiable decision trees (differentiable DTs), in imitation learning settings and full RL settings, DTs in these methods only conduct partitions in raw feature spaces without representation learning that could lead to complicated combinations of partitions, possibly hindering both model interpretability and scalability. Even worse, some methods have axis-aligned partitions (univariate decision nodes) with much lower model expressivity.

Proposed approaches for tree-based explainable RL are described in various proposed embodiments, adapted to improve both computational performance and explainability. A target trained black box machine learning data architecture model (e.g., a neural network) is utilized along with input features to train a tree-based explainable data architecture model (e.g., a decision tree architecture), which itself can be the output (e.g., for downstream analysis or sensitivity analysis), or can be used as an alternative (or alongside) to the target trained black box machine learning data architecture model. As noted herein, the output tree-based explainable data architecture model can be structured with decision nodes representing decision points that are more understandable by a human and can be more amenable to changing for scenario analysis (e.g., setting a node representing a decision point between an interest rate increase and an interest rate decrease, which can then be tweaked for downstream scenario analysis).

The approaches described herein are adapted to provide a technical, computational mechanism to aid in improving explainability of machine learning architectures or for generating more explainable machine learning architectures.

The approaches provide a “middle ground” between the rigidity of a decision tree based approach and a difficulty in explaining a neural network based approach, where a neural network is first trained, and then the trained neural network is used to train a decision tree architecture. Computational performance and model accuracy are important considerations in transforming the neural network into the decision tree architecture representation, as described herein. The proposed approaches aid in improving model capacity and simplicity, for example, by unifying the decision making process based on different intermediate features with a single decision making tree, which follows the low-rank decomposition of a large matrix with linear models.

Specifically, the approaches describe a proposed implementation of cascading decision tree (CDT) based representation learning data models which can be structured in various approaches to learn features of varying complexity. CDTs apply representation learning on the decision path to allow richer expressivity, and empirical results show that in both situations, where CDTs are used as policy function approximators or as imitation learners to explain black-box policies, CDTs can achieve better performances with more succinct and explainable models than SDTs. As a second contribution, the described herein are experimental results from a study indicating limitations of explaining blackbox policies via imitation learning with tree-based explainable models, due to inherent instability.

Variations on the CDT architecture are proposed having regard to alternate potential structures of the CDT architecture. Some embodiments of the proposed approaches were experimentally validated on a number of different machine learning tasks, indicating that the proposed CDTs share the benefits of having a significantly smaller number of parameters (and a more compact tree structure) and better performance than alternate approaches. The experiments described herein also demonstrated that the imitation-learning approach is less reliable for interpreting the RL policies with DTs, since the imitating DTs maybe prominently different in several runs, which also leads to divergent feature importances and tree structures.

In operation, the proposed CDT representation can be instantiated, trained, and then used in different use cases, such as where one is given a black box machine learning architecture, and the CDT is adapted to “distill” it by mimicking its input-output functions by training against it to tune parameter weights (e.g., w, w, w′) of the CDT, such that a similar CDT can be established that has, instead of unexplainable connections, more explainable decision-tree architectures. In another use case, the CDT itself can be used directly without a black box machine learning architecture, and rather, the CDT is created to generate a machine learning model that both performs well computationally and is easier to explain.

Mimicking can include taking the target ML architecture and train the CDT to try to mimic the input-output function of the target ML architecture. The parameter weights thus are tuned by comparing against the output of the black-box. The approach effectively includes transforming the NN into a CDT by training the CDT to become a proxy to explain the black-box model.

Computational performance is an important consideration, as the technical approaches proposed herein need to function well in real-world computational environments, including any limitations in terms of processing time and computational resources. Additional simplification and/or compression approaches can be used to transform the CDT into a more readily computable form.

In some embodiments, for example, discretization approaches are utilized to transform all of the CDT or some of the CDT (e.g., just the feature learning tree data structures F) to reduce a computational complexity, albeit at the cost of some accuracy, which can be useful in situations where there are not enough available computational resources. The discretization is a replacement of a soft decision boundary—(e.g., a probability of for 80% go right, 20% go left) with a deterministic boundary, which is a hard boundary. Instead of 80% right, 20% left, the decision boundary is changed to GO RIGHT (as 80% is greater than 20%). This transformation, in a variant embodiment, improves performance at the cost of accuracy.

As described in various embodiments, the proposed CDT approaches are directed to a technical trade-off between model expressiveness and model interpretability, and provides improvements in respect of alternate approaches, such as linear models and soft decision trees (SDTs). For example, while linear models and SDTs are useful in some contexts, there are technical limitations that arise quickly in respect of scalability and complexity (e.g., limitations in respect to model capacity, flexibility of space partitions, or limitations in respect of axis-aligned space partitions, over-reliance on performance of manually designed feature presentations yielding a vulnerability to overfitting). Model performance when used in real-world applications can suffer such that the linear models and/or SDTs are no longer useful.

Where the CDT is potentially technically superior to other approaches is in relation to the proposed structure of the decision trees. Instead of a naïve decision tree, a partitioned architectural structure is proposed, whereby there is a at least one feature learning tree data structure (F) and a decision making tree data structure (D).

The tree structures F and D are coupled to one another such that decision nodes of F feed into D so that an intermediate learned feature set can be utilized for computation of a final output distribution data structure.

From the leaf decision nodes of F, in some embodiments, a selected leaf node is used to feed values into D. The tree F is adapted to support a decision as to which leaf is used as an input for tree D (i.e., in some embodiments, the approach is not using all of the F, but rather, one selected leaf node). Based on the input x, the system decides one set of F for use with the D tree. In a variant embodiment where there are parallel trees F, a combination can be selected, picking one set of leaf nodes f from each F tree, both of which are then used as a feature for D to ultimately generate the output distribution.

As described herein, it is important that F is interpretable. For example, when F uses a linear model, one can observe which co-efficient is dominating. Example interpretable F decision points in the context of a game playing decision tree data structure can be time remaining and another is a distance to the end of the game, and the output distribution, for example, can be which action (e.g., button) for the control to actuate. In this example, F can be compared by the co-efficients. However, F may be more complicated than this simplified example. This can be conducted, for example, through assignments of values for L possibilities, and in an inference process, the leaf node with the highest probability can be used to assign values for the intermediate features. A core distinction is that the CDT's tree structure is greatly simplified compared to SDT.

Alternate structures are possible, such as a variant embodiment where there are multiple F data structures that are connected in series (e.g., “cascade”) or in parallel, or some combination thereof. Furthermore, in more specific variant embodiments, it is important to provide a balance or an approximate balance in terms of complexity (e.g., depths) between the F data structures and the D data structures. In other variant embodiments, a balance can be adjusted such that the overall CDT is top heavy or bottom heavy, which can be used to vary performance vs. explainability trade-offs. Differing depth weightings are possible in variant embodiments. For example, a bottom heavy CDT might be worse than SDT in performance but might be better in interpretation. The reason is that one can still establish a heavy constraint on F—e.g., F has to be a linear model, by that constraint F won't be able to capture too much information no matter how big F is. By doing that, it can be difficult in getting good performance but better in interpretability.

In the tuning variation, in some embodiments, the depth sizes of each of the F and D data structures can be tuned (e.g., in the ideal case you want F and D to be as simple as possible. If Applicants put a constraint on F to be linear, it guarantees interpretability. If one can establish the depth from SDT (let's say 6), the layers of F+D can be 2+3 or 2+4 or 3+3 in an attempt to at least match the performance of the SDT.

The CDT approach can be implemented in the form of a policy function approximator engine for deep reinforcement learning tasks, for example, or as a function approximator engine. The CDT approaches described here can be used in some scenarios for generating data sets representative of a predicted explanation for a particular output, or, in some other scenarios, for generating new outputs established by perturbing a particular explainable feature (e.g., whether the “jump” action recommended to the game sprite would change to a “run” action if the amount of time available on the game's countdown clock was reduced).

A number of embodiments were experimentally validated against two different computational task environments, and the experiments indicated the tested embodiments of the proposed CDT approaches were able to attain a good balance between performance and a number of parameters for a model.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1A-1C shows tree diagrams of comparisons of three different tree structures on a classification problem. From left to right: FIG. 1A multivariate DT; FIG. 1B univariate DT; FIG. 1C differentiable rule lists.

FIG. 1D shows a heuristic decision tree for LunarLander-v2, with the left branch and right branch of each node yielding the “True” and “False” cases respectively. x is an 8-dimensional observation, a is the univariate discrete action given by the agent. at, ht are two intermediate variables, corresponding to the “angle-to-do” and “hover-to-do” in the heuristic solution.

FIG. 2 is a diagram illustrating a comparison of two different tree structures on a complicated classification problem.

FIG. 3 is an example soft decision tree node. σ(·) is the sigmoid function with function values on decision nodes as input.

FIG. 4 provides two illustrations of decision boundaries and mappings thereof two example decision trees with different decision boundaries: (a) hard decision boundary; (b) soft decision boundary (soft decision trees).

FIG. 5 shows a simplified CDT architecture.

FIG. 6 shows multiple soft decision boundaries. The boundaries closer to the instance are less important in determining the feature importance since they are less distinctive for the instance.

FIG. 7A is a hierarchical feature abstraction architecture with three feature learning models {F_1, F_2, F_3} in a cascading manner before inputting to the decision module D; FIG. 7B is a parallel feature extraction architecture with two feature learning models {F_1, F_2} before concatenating all features into D.

FIG. 8 is a graph showing a comparison of CDT, SDT and MLP as policy function approximators for PPO in a RL setting, and the environment is LunarLander-v2.

FIG. 9 is a graph showing a outputs for a comparison of CDT, SDT and MLP as policy function approximators for PPO in a RL setting, and the environment is CartPole-v1.

FIG. 10 is a visualization of learned CDT (depth 1+2) after discretization for CartPole-v1: top is the discretized feature learning tree, and bottom is the decision making tree.

FIG. 11 is a visualization of learned CDT (depth 1+2) after discretization for CartPole-v1: top is the discretized feature learning tree, and bottom is the discretized decision making tree.

FIG. 12 shows a detailed architecture of CDT: the feature learning tree is parameterized by w and b, and its leaves are parameterized by \tilde{w}, which represents L possible intermediate feature values with a dimension of K; the decision making tree is parameterized by w′ and b′.

FIG. 13A-D show observation statistics for each dimension in LunarLander-v2 with heuristic agent: the top six dimensions are continuous spaces, the last two are binary spaces. Means and modes are given in each dimension.

FIG. 14 shows a visualization of learned CDT for LunarLander-v2: top is the feature learning tree, and bottom is the decision making tree.

FIG. 15 is a rendering of the discretized feature learning tree.

FIG. 16 is a visualization of learned SDT (depth 3) for CartPole-v1.

FIG. 17 is a visualization of learned CDT (depth 1+2) for CartPole-v1: top is the feature learning tree, and bottom is the decision making tree.

FIG. 18 is a block schematic of an example system adapted for instantiating the cascading differentiable tree data structure, according to some embodiments.

FIG. 19 is an example method is shown where the training includes attempting to mimic the outputs of deep learning reinforcement learning model in this example by tuning the specific weights of the feature learning tree(s) and the decision learning tree.

FIG. 20 is a set of graphs showing a comparison of SDTs and CDTs on three environments in terms of average rewards in RL setting: (a)(c)(e) use normalized input states while (b)(d)(f) use unnormalized ones.

FIG. 21 are a set of graphs showing a comparison of SDTs and CDTs with different depths (state normalized). (a) and (b) are trained on CartPole-v1, while (c) and (d) are on LunarLander-v2., showing the learning curves of SDTs and CDTs in RL with different tree depths for the two environments, using normalized states as input,

FIG. 22 are a set of diagrams showing on the left, learned CDT (after discretization) is shown, and on the right, a game scene of MountainCar-v0.

FIG. 23 shows the learned CDT (after discretization) for LunarLander-v2 with game scene at the right bottom corner.

FIG. 24 is a graph showing a comparison of numbers of model parameters in CDTs and SDTs. The left vertical axis is the number of model parameters in log-scale.

FIGS. 25-28 are graphs showing comparison of feature importance (local explanation 1) for SDT of depth 3, 5, 7 with HDT on an episodic decision making process.

FIGS. 29-31 provide a comparison of feature importance for three SDTs (depth=5, trained under the same setting) with three different local explanations.

FIGS. 32-35 are outputs showing a comparison of four runs with the same setting for SDT (before discretization) imitation learning on LunarLander-v2.

FIGS. 36-39 show comparisons of four runs with the same setting for SDT (after discretization) imitation learning on LunarLander-v2.

FIG. 40 shows comparisons of four runs with the same setting for SDT (before discretization) imitation learning on CartPole-v1.

FIG. 41 shows comparisons of four runs with the same setting for SDT (after discretization) imitation learning on CartPole-v1.

FIG. 42, FIG. 43 shows comparisons of four runs with the same setting for CDT (before discretization) imitation learning on LunarLander-v2: feature learning trees (FIG. 42) and decision making trees (FIG. 43).

FIG. 44, FIG. 45 shows comparison of four runs with the same setting for CDT (after discretization) imitation learning on LunarLander-v2: feature learning trees (FIG. 44) and decision making trees (FIG. 45).

FIG. 46, FIG. 47 shows comparison of four runs with the same setting for CDT (before discretization) imitation learning on CartPole-v1: feature learning trees (FIG. 46) and decision making trees (FIG. 47).

FIG. 48, FIG. 49 shows comparison of four runs with the same setting for CDT (after discretization) imitation learning on CartPole-v1: feature learning trees (FIG. 48) and decision making trees (FIG. 49).

FIG. 50, FIG. 51 are graphs showing comparison of SDTs and CDTs with different depths (state unnormalized). (a) and (b) are trained on CartPole-v1, while (c) and (d) are on LunarLander-v2.

FIG. 52 is a diagram showing the learned CDT (before discretization) of depth 1+2 for CartPole-v1.

FIG. 53 is a diagram showing the learned SDT (before discretization) of depth 3 for CartPole-v1.

FIG. 54 is a diagram showing the learned CDT (before discretization) of depth 2+2 for MountainCar-v0.

FIG. 55 is an example computer system that can be used to implement a system as described in various embodiments herein.

### DETAILED DESCRIPTION

Alternate approaches in explainable AI have explored using decision trees (DTs) recently for RL. As described herein, there are technical limitations of some of these approaches and Applicants highlight that there is often a trade-off between accuracy and explainability/interpretability of the model. A series of works were developed in the past two decades along the direction of differentiable DTs. For example, there are approaches to distill a SDT from a neural network where ensemble of decision trees and neural decision forests were utilized. Approaches included transforming decision forests into singular trees, as well as convolutional decision trees for feature learning from images, adaptive neural trees (ANTs), neural-backed decision trees (NBDTs, transferring the final fully connected layer of a NN into a DT with induced hierarchies)) among others.

However, all of these approaches either employ multiple trees with multiplicative numbers of model parameters, or heavily incorporate deep learning models like CNNs in the DTs. Model interpretability in these approaches is severely hindered due to their model complexity. For example, the non-linear transformations of an ANT hinders potential interpretability.

Soft decision trees (SDTs) and discretized differentiable decision trees (DDTs) have been demonstrated to achieve both good performance and share the benefit of having explainable policies. As described in embodiments herein, a technical approach and corresponding computing systems are proposed to further improve the results for tree-based explainable RL in both performance and explainability.

The proposed approach, Cascading Decision Trees (CDTs) apply representation learning on the decision path to allow richer expressiveness, and therefore strikes a better balance between alternate approaches, potentially yielding high accuracy and improving on interpretability. Results for experimentation of various embodiments are presented in both supervised learning via imitation learning of a learned policy and reinforcement learning with CDT as policy function approximators for DRL tasks. In particular, empirical results show that in both situations, where CDTs are used as policy function approximators or as imitation learners to explain black-box policies, CDTs can achieve better performances with more succinct and explainable models than SDTs. As a second contribution, the study herein reveals limitations of explaining black-box policies via imitation learning with tree-based explainable models, due to its inherent instability.

There is generally a trade-off between model expressiveness and model interpretability. Deep neural networks (DNN), arguably the biggest advance in machine learning research in the last decade that has been demonstrated to achieve better performances across different domains, fails to meet the model interpretation demand.

The high complexity of DNN leads to the model being a “black-box” (e.g., unexplainable) to its users, and thus hinders a satisfactory interpretation. For example, it is unclear how the latent/hidden layers are tuned over time as the interconnections have highly complex mechanisms and representations. Accordingly, investigating a machine vision neural network system typically cannot explain “why” an image object is a cat or why it is not a cat. On the other hand, a human would be able to explain that the cat image has the correct dimensions, partial image areas representing limbs, whiskers, among others.

On the other hand of black-box models, although linear models enjoy great interpretability as one can perform a reasoning on the model based on its linear boundary, linear models fails to achieve good performances on many tasks due to its lack of model expressiveness.

A practical use of the proposed approaches described herein can include processing for explainability various reinforcement learning agents, such as an automated securities trading agent that conducts algorithmic trading automatically based on estimations from a trained machine learning model. A challenge is that the algorithmic trading model, after being trained, ends up being difficult to explain. The CDTs generated by the proposed approach in various embodiments can be used to automatically generate an alternate explainability model where humans are able to investigate decision nodes to understand why the agent is making certain decisions based on parameters that describe the market. The trained model (e.g., a neural network) agent can be treated as a black box model that is an input that is then provided to the system to learn the CDT representation. Decision trees (DT) are another type of interpretable model whose decision making process can be easily understood via visualizing the decision path. However, decision tree approaches also suffers from the lack of model expressiveness and several extensions have been proposed to improve its model expressiveness, as discussed later in subsec: interpretTreeModel.

In this disclosure, an improved approach using proposed Cascading Decision Trees (CDTs) is described that strikes a better balance between model expressiveness and model interpretability. There are a variety of desiderata for interpretability, including trust, causality, transferability, informativeness, etc.

In summary, model interpretability requires the model to satisfy two necessary conditions: (1) it needs the model variables and inference mechanisms to be correlated to physical meanings that can be directly understood by humans; (2) model simplicity w.r.t. a complexity measure. Achieving any of the two aspects can increase the potential of interpreting a model; on the contrary, missing either of the two aspects can hinder human interpretation of the model. CDTs compared to previous tree models, can learn a succinct linear feature representation so that the constructed features are easier to interpret and greater model simplicity in terms of number of parameters or computational complexity, while still maintain enough model capacity for good learning performances.

Applicants describe the interpretability of CDT in the reinforcement learning setting, but it is important to note that the embodiments are not thus limited. In some embodiments, the methods discussed in this paper is transferable to the a supervised learning setting. Explainable reinforcement learning (XRL) is a relatively less explored domain. How to interpret the action choices in reinforcement learning (RL) policies remains a critical challenge, especially as the gradually increasing trend of applying RL in various domains involving transparency and safety. As described herein, Applicants demonstrate the interpretability and good performance of CDT on a number of RL tasks. In particular, the experiments show that CDT manages to achieves similar or better performance, while maintain a succinct feature set and an interpretable decision making procedure.

Tree Models as Interpretable Models

Traditional DTs (with hard decision boundaries) are usually regarded as models with readable interpretations for humans. In contrast, neural networks are considered a stronger function approximator (often achieving higher accuracy) but lacking interpretability. Differentiable DTs lie in the middle of the two and have gained increased interest, especially for their apparent improved interpretability. Soft/fuzzy DT (shorten as SDT), is a primitive approach.

Differentiable DT for interpreting RL policies can be used in an imitation learning manner or a RL setting, using different tree structures. However, the DTs in the above methods only conduct partitions in raw feature spaces without representation learning, which could lead to complicated combinations of partitions, therefore hinders both model interpretability and scalability. Even worse, some methods have axis-aligned partitions (univariate decision nodes) with much lower model expressivity.

The proposed Cascading Decision Trees (CDTs) approach strikes a balance between the model interpretability and accuracy, with adequate representation learning also based on interpretable models (e.g., linear models). During experimentation, the proposed technical architecture was validated to have potential benefits of a significantly smaller number of parameters and a more compact tree structure with even better performance. The experiments are conducted on RL tasks, in either a imitation-learning or a RL setting. Applicants first demonstrate that the imitation-learning approach is less reliable for interpreting the RL policies with DTs, since the imitating DTs may have be prominently different in several runs, which also leads to divergent feature importances.

The potential technical distinctions in the approach of cascading differential decision tree are listed below, compared with three main baselines with each representing a category of methods with different characteristics on differentiable decision tree:

The proposed CDT is distinguished from other main categories of methods with differentiable DTs for XRL in the following ways:

1. Compared with SDT, partitions not only happen in original input space, but also in transformed spaces by leveraging intermediate features. This is found to improve model capacity, and it can be further extended into hierarchical representation learning like a CNN.

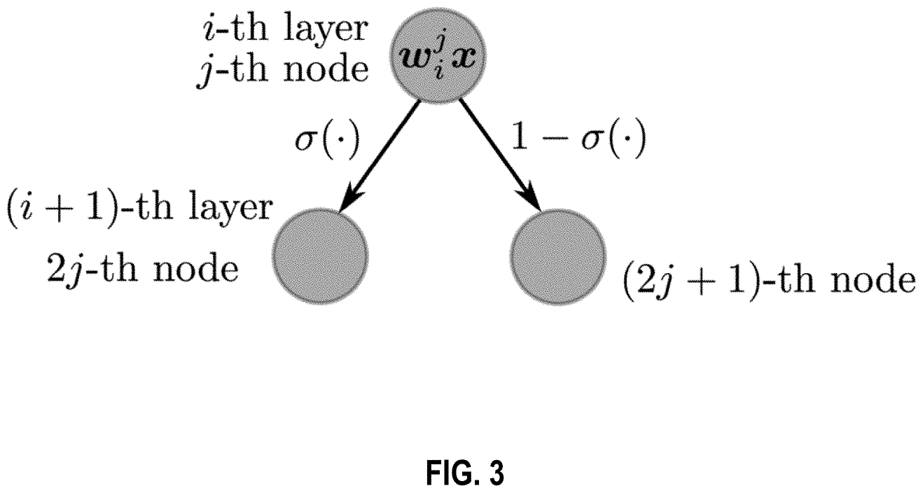

2. Space partitions are not limited to axis-aligned ones (which hinders the expressivity of trees with certain depths, as shown in the comparison within FIG. 3), but achieved with linear models of features as the routing functions. Linear models Applicants adopt in the example are only one type of feature transformation which is interpretable, other interpretable transformations are also allowed in a cascading decision tree. Moreover, the adopted linear models are not a restriction (but as an example) and other interpretable transformations are also allowed in the proposed CDT methods.

3. Compared with adaptive neural trees, the duplicative structure in decision making process based on different intermediate features is summarized into a single decision making tree, rather than allowing fully relaxed freedoms in tree structures as end-to-end solutions from raw inputs to final outputs (which hinders interpretability due to the model complexity). Although the duplicative structure may not always exist in all tasks, it can be observed in some heuristic agents of RL tasks. This is an important consideration to simplify the tree-based model for interpretability in a cascading decision tree. In particular, the CDT method unifies the decision making process based on different intermediate features with a single decision making tree, which follows the low-rank decomposition of a large matrix with linear models. It thus greatly improves the model simplicity for achieving interpretability.

A proposed approach is described in some embodiments. The approach has an aim to clarify the simplicity and its relationship with interpretability of DT models, so as to form not only the preferences in designing the tree structures but also criteria for evaluating them. Applicants investigate the approach of SDT as imitating model of RL policies, to evaluate the reliability of deploying it for achieving interpretability.

CDT is proposed and described herein as an improved policy function approximator, and experimentally validated to demonstrate potential advantages in model simplicity and performance.

Recently, an alternate approach proposed to distill a SDT from a neural network, tested on MNIST digit classification tasks. To further boost the prediction accuracy of tree-based models, extensions based on single SDT are proposed from as least two aspects: (1) ensemble of trees, or (2) unification of NNs and DTs. Ensembles of decision trees are used for increasing the accuracy or robustness of prediction, which also works for SDTs called neural decision forests. Since more than one tree need to be considered during inference process, transforming the decision forests into one tree can help with interpretability.

As for unification of NNs and DTs, other approaches also propose convolutional decision trees for feature learning from images. Adaptive Neural Trees (ANTs) incorporate representation learning in decision nodes of a differentiable tree with nonlinear transformations like convolutional neural networks (CNNs). The nonlinear transformations of an ANT, not only in routing functions on its decision nodes but also in feature spaces, guarantee the prediction performances in classification tasks on the one hand, but also hinder the potential of interpretability of such methods on the other hand. Another approach proposes the neural-backed decision tree (NBDT) which transfers the final fully connected layer of a neural network into a decision tree with induced hierarchies for the ease of interpretation, but shares the convolutional backbones with normal deep NNs, yielding the state-of-the-art performances on CIFAR10 and ImageNet classification tasks.

However, since these advanced methods either employ multiple trees with multiplicative numbers of model parameters, or heavily incorporate deep learning models like CNNs in the DTs, the interpretability is severely hindered due the their model complexity. Therefore these models are not good candidates for interpreting the RL policies.

For interpretable models in RL, another approach proposes distilling the RL policy into a differentiable decision tree by imitating a pre-trained policy. Similarly, one can apply an imitation learning framework but to the Q value function of the RL agent. They also propose Linear Model U-trees (LMUTs) which allow linear models in leaf nodes whose weights are updated with Stochastic Gradient Descent (the rest of the nodes follow the same criteria as in traditional trees). Another approach proposes to apply differentiable decision trees directly as function approximators for either Q function or the policy in RL training. This approach applies a discretization process and a rule list tree structure to simplify the trees for improving interpretability. Recently, an alternate approach also proposed DreamCoder, which learns to solve general problems with interpretability through writing programs. The final program for a task is composed of hierarchically organized layers of concepts, whereas those concepts are conceptual abstractions that represent common fragments across task solutions, as well as the primitives for the programming languages. The hierarchical conceptual abstraction and the program solutions built on top of that also make the DreamCoder a well-interpreted method. Another method, the VIPER method proposed also distills policy as NNs into a DT policy with theoretically verifiable capability, but for imitation learning settings and nonparametric DTs only.

Soft Decision Trees (SDT) Decision Tree (DT) architectures have served as one of the most important interpretable models for its rule-based nature. Given an input, the DT model itself represents the decision making process of the model to its output, and thus enjoys useful interpretability as its decision node only includes one variable.

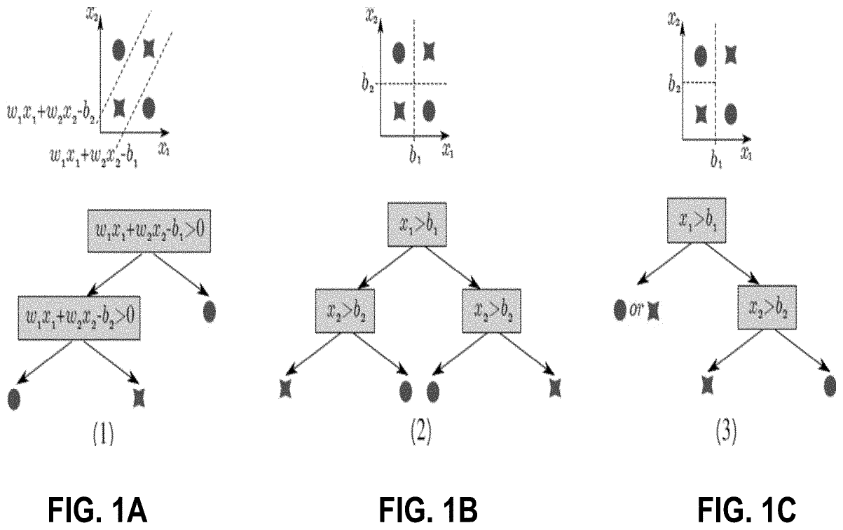

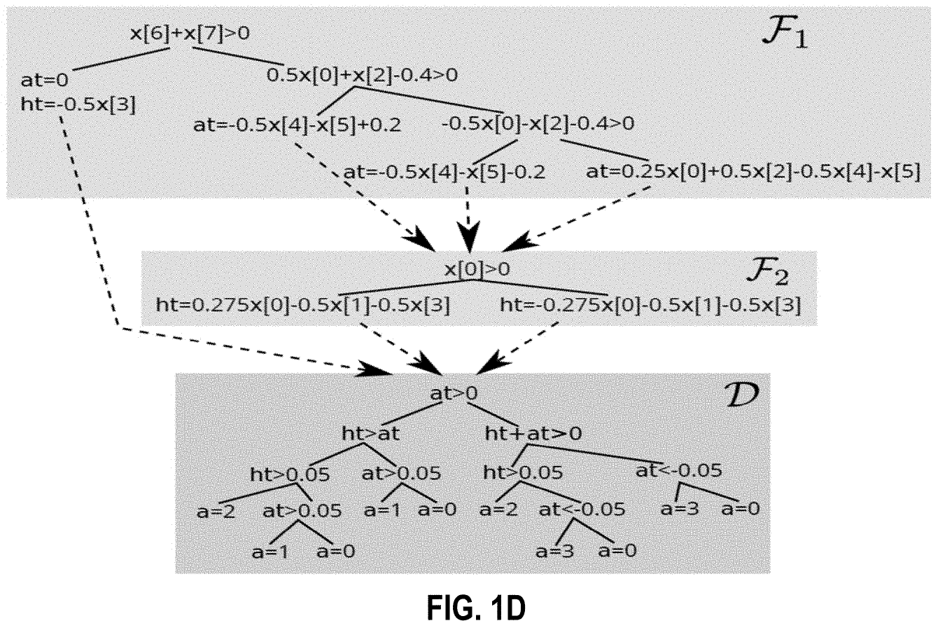

FIG. 1A-1C shows tree diagrams of comparisons of three different tree structures on a classification problem. From left to right: FIG. 1A multivariate DT; FIG. 1B univariate DT; FIG. 1C differentiable rule lists.

Multivariate vs. Univariate Decision Nodes: There have been proposed a variety of desiderata for interpretability, including trust, causality, transferability, informativeness, etc. Here Applicants summarize the answers in general into two aspects: (1) interpretable meta-variables that can be directly understood; (2) model simplicity. Human-understandable variables with simple model structures comprise most of the models interpreted by humans either in a form of physical and mathematical principles or human intuitions, which is also in accordance with the Occam's razor principle.

For model simplicity, a simple model in most cases is more interpretable than a complicated one. Different metrics can be applied to measure the model complexity, such as the number of model parameters, model capacity, computational complexity, non-linearity, etc.

There are ways to reduce the model complexity: model projection from a large space into a small sub-space, model distillation, merging the replicates in the model, etc. Feature importance (e.g., through estimating the sensitivity of model outputs with respect to inputs) is one type of methods for projecting a complicated high-dimensional parameter space into a scalar space across feature dimensions. The proposed method CDT in various embodiments herein is a way to improve model simplicity by merging the replicates through representation learning.

FIG. 1B gives an simple example of DT, where the decision process is sequentially checking the values of x₁ and x₂. Coming with the model simplicity, DT suffers from its limit model complexity. Indeed, even for approximating a linear decision boundary that is not orthogonal with any axis in the input space, DT would need to discretize the space of each variable to a good precision which generally creates exponentially many nodes in the tree.

FIG. 1D is a heuristic decision tree for LunarLander-v2, with the left branch and right branch of each node yielding the “True” and “False” cases respectively. x is an 8-dimensional observation, a is the univariate discrete action given by the agent. at, ht are two intermediate variables, corresponding to the “angle-to-do” and “hover-to-do” in the heuristic solution. As shown in FIG. 1D, the heuristic solution of LunarLander-v2 was analyzed and found that it contains duplicative structures after being transformed into a decision tree, which can be leveraged to simplify the models to be learned. Specifically, the two green modules [symbol] ₁ and [symbol] ₂ in the tree are basically assigning different values to two intermediate variables (ht and at) under different cases, while the grey module D takes the intermediate variables to achieve action selection. The modules [symbol] ₂ and D are used repeatedly on different branches on the tree, which forms a duplicative structure. This can help with the simplicity and interpretability of the model, which motivates the proposed approach of CDT methods for XRL.

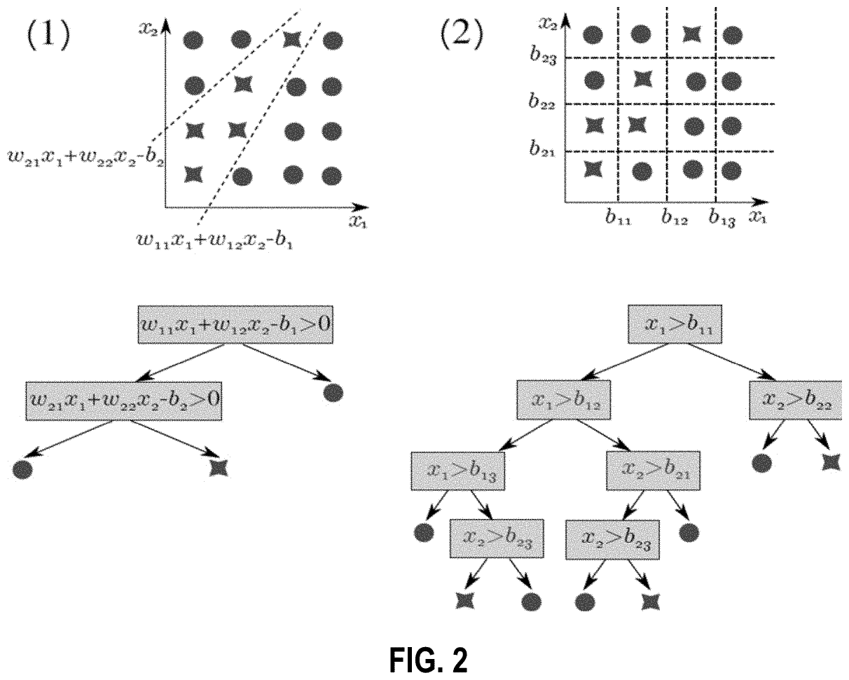

An illustrative example is shown in FIG. 2. FIG. 2 is a diagram illustrating a comparison of two different tree structures on a complicated classification problem.

In these examples, the success of a DT model heavily depends on a good manually-design feature representation of the input data, which is a technical deficiency.

Without a good manually designed feature representation, a DT model tend to represent a complex decision boundary by overfitting the data unless it is given a sufficiently large amount of data. One mitigation to this problem is the multivariate decision tree, where each node in the tree is defined by a linear/nonlinear discriminant as shown in FIG. 1A.

To clarify the choice of model in the proposed approaches in terms of simplicity, FIG. 2 is provided to compare different types of decision trees involving univariate and multivariate decision nodes. It shows the comparison of a multivariate DT and a univariate DT for a binary classification task. The multivariate DT is simpler than the univariate one in its structure, as well as with fewer parameters, which makes it potentially more interpretable. For even more complex cases, the multivariate tree structure is more likely to achieve necessary space partitioning with simpler model structures.

SDTs further extend multivariate DT in that each node defines a probabilistic decision boundary with the sigmoid function, and therefore SDT is a differentiable model with non-zero gradients. Considering one can have a DT of depth D, each node in the SDT can be represented as a weight vector (with the bias as an additional dimension) wᵢ^{j}, where i and j indicate the index of the layer and the index of node in that layer respectively, as shown in FIG. 3. The corresponding node is represented as nᵤ, where u=2ⁱ⁻¹+j uniquely indices the node.

FIG. 3 is an example soft decision tree node. σ(·) is the sigmoid function with function values on decision nodes as input.

The decision path for a single instance can be represented as set of nodes [symbol] ⊂ [symbol] , where [symbol] is the set for all nodes. There is [symbol] =argmax_{{u}}Πᵢ₌₁^{D}p_{i-1→i}^{└j/2┘→j}, where p_{i-1→i}^{└j/2┘→j} is the probability of going from node n₂_{^{i−2}}_{+└j/2┘} to n₂_{^{i−1}}₊ⱼ The {u} indicates that the arg max is taken over a set of nodes rather than a single one.

Note that p_{i-1→i}^{└j/2┘→j} will always be 1 for a hard DT.

Therefore the path probability to a specific node nᵤ is: P^{u}=Π_{i′=1}^{j′}p_{i′-1→i′}^{└j′/2┘→j′}, u′∈ [symbol] . In the following, all DTs are named using probabilistic decision path as SDT-based methods.

As noted by Silva 2019, to discretize the learning differential SDTs into univariate DTs for improving interpretability, for a decision node with a (k+1)-dimensional vector w (the first dimension w₁ is the bias term), the discretization process (i) selects the index of largest weight dimension as k*=arg maxₖ wₖ and (ii) divides w₁ by wₖ., to construct a univariate hard DT. The default discretization process in the experiments described herein for both SDTs and CDTs also follows this manner.

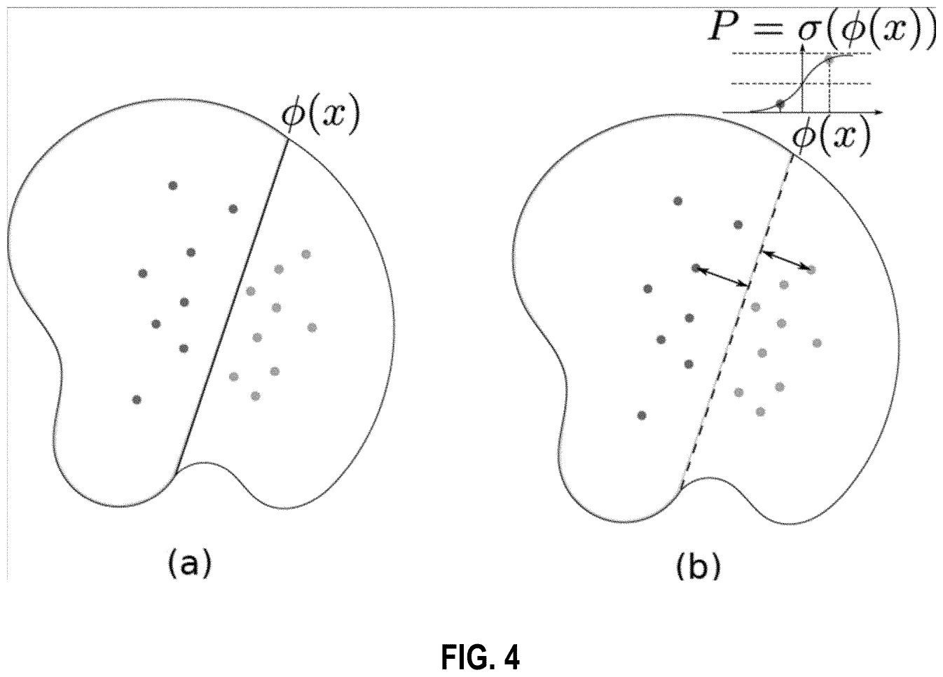

FIG. 4 shows the difference of a boundary in hard decision trees and SDTs, where the distance from the instance to the decision boundary is positively correlated to the confidence that the instance belongs to the corresponding category in SDTs. FIG. 4 includes two illustrations of decision boundaries and mappings thereof two example decision trees with different decision boundaries: (a) hard decision boundary; (b) soft decision boundary (soft decision trees).

A cross-entropy regularization is proposed in SDT learning process, which ensures a balanced usage of both left and right sub-trees, especially for the nodes closer to the root (by exponentially decaying the penalty strength with depth). The cross-entropy loss is written as:

C=−λΣᵤ½ log(αᵤ)+½ log(1−αᵤ), u∈ [symbol] (1)

where αᵤ indicates a weighted average of probability on node nᵤ,

$${α}_{u} = \frac{{\sum }_{x} {P}^{u} ( x ) {p}_{i \to i + 1}^{j \to 2 j} ( x )}{{\sum }_{x} {P}^{u} ( x )} \qquad ( 2 )$$

The λ in Eq. (1) is a hyper-parameter for tuning the overall magnitude of this regularization. The larger λ is, the more balanced usage of sub-trees, and α will be closer to 0.5.

The interpretability of SDT mostly relies on the depth and the number of the nodes of the tree. As soft decision boundaries are used in SDT, the decision of SDT involves all the sub-trees rather than only the decision path in DT, the number of which grows exponentially with the depth of the tree. It is generally difficult to interpret an exponential number of decision nodes too.

Therefore, balancing the sub-trees may cause more difficulty in interpreting the model. This is also the case for the heuristic agent in LunarLander-v2 provided by OpenAI gym. Although this agent can be represented as a multivariate decision tree, the number of nodes make it difficult to interpret. Instead, an alternate approach proposed use of a discretization process to further increase the interpretability of a SDT, by converting each multivariate node into univariate and changing the sigmoid soft decision boundaries into hard decision boundaries.

As shown later, naively apply this method to SDT results in a dramatic drop in the model's performance. This motivates Applicants to propose CDTs, where the model is encouraged to learn a succinct feature representation and shallow decision making trees.

Simplicity and Interpretability

Before proposing the approaches described herein, one first need to answer the following questions:
What are necessary conditions of or constituting the interpretability of a model?
What is the relationship of model simplicity and model interpretability?

There are a variety of desiderata for interpretability, including trust, causality, transferability, informativeness, etc. Here, Applicants summarized the answers into two aspects: (1) one needs the model variables and inference mechanisms to be correlated to physical meanings that can be directly understood by humans; (2) model simplicity w.r.t. some specific complexity measure. Achieving any of the two aspects can increase the potential of interpreting a model; on the contrary, missing either of the two aspects can hinder human interpretation of the model. These conditions are necessary for a fully human-interpretable model. However, partial satisfaction can sometimes lead to partial interpretations-like a probing process-to spy upon the model through tunnels.

To demonstrate the importance of the first aspect, Applicants use the heuristic agent of a RL environment LunarLander-v2 as an example. The heuristic solution is literally an if-else rule list, which can be equally transformed into a decision tree. Even if the program of heuristic solution for this environment is provided, it is still hard for a normal person to directly interpret the solution, unless the meaning of variables and overall mechanisms are additionally provided.

As for model simplicity, a simple model in most cases is more interpretable than a complicated one. Different metrics can be applied to measure the model complexity such as number of model parameters, model capacity, computational complexity, non-linearity, etc. There are ways to reduce the model complexity: model projection from a large space into a small sub-space, merging the replicates in the model, etc. Feature importance (e.g., through estimating model sensitivity to changes of inputs) is one type of methods for projecting a complicated model into a scalar space across feature dimensions. The proposed method using a CDT is a way to achieving model simplicity through merging the replicates.

Strictly speaking, the relationship of simplicity and interpretability is irreversible, i.e. simplicity is neither a necessary nor a sufficient condition for interpretability, and vice versa. But in most practical cases, simplicity is necessary for interpretability.

For a simple classification problem, three different tree structures and their decision boundaries are compared in FIG. 1A-1C: (1) multivariate DT; (2) univariate DT; (3) differentiable rule lists. The problem is that one need to define the simplicity of DT and choose which type of tree is the one prefer for the consideration of interpretability.

For the first two, one may not be able to draw conclusions for their simplicity since it seems one has simpler tree structure but more complex decision boundaries while the other one is the opposite. The engineer will have another example to clarify it. But one can draw a conclusion for the second and the third ones since the structure of differentiable rule lists is simpler, as it has asymmetric structure and the left nodes are always leaves. However, the problem of differentiable rule lists is also obvious, that it sacrifices the model capacity and therefore hurts the accuracy. For the first left node in the example it can only choose either one of the two labels, which is clearly not correct.

To clarify the problem of choosing between the first two structures, one can complicate the example as in FIG. 2. Now it is clear to see the advantages of the multivariate tree over the univariate tree in terms of simplicity. Moreover, the differences will become larger when the cases are more complicated.

The reason for selecting simpler models, i.e., the ones with fewer parameters or shallower tree structures, is related to the principles of Occam's razor. Simpler concepts and solutions tend to be more correct or human interpretable. One perspective to understand this is, although there could be more than one solutions/models for one task with a certain number of samples and without constraints on the model complexity, the conceptual understandings from humans are usually formed from multiple tasks. This is inherently a regularization that the concepts or features in one task need to be consistent with the other tasks, which requires the model to be as simple as possible while remaining the functionalities. Therefore, simple models tend to be more interpretable from human's perspective.

One approach to explain a complex model is by training a interpretable proxy to mimic the behavior of the original model. In this section, Applicants study different properties of a SDT proxy.

Applicants tested the heuristic agent in the LunarLander-v2 environment, provided by OpenAI gym, as the ground truth. This agent can be expressed as a multivariate DT, denoted by heuristic DT (HDT) in this section. SDT clones the behavior of HDT on a collected state-action dataset, where 10k episodes of HDT samples are used to ensure a near-optimal policy imitation. Applicants compare the learned SDT agents with the ground truth multivariate DT under different metrics, to evaluate its (1) regularization and (2) stability.

Regularization

Applicants experimentally compare different values for λ in Eq. (1) during the training of a depth-5 SDT, with values range in {0.1,0.01,0.001, −0.1, −0.01, −0.001}.

Moreover, one can choose a negative value for A to penalize the balanced usage of sub-trees, which will tend to let the nodes always choose to go to one side of sub-trees with high probability. Since Applicants want to analyze discretization of the trees after training, a tree with more unbalanced nodes may suffer little degradation in performances.

In practice, one can take the average of a modified version of a during training to see how balanced the nodes become, which can be represented as:

$$\begin{matrix}\tilde{α} = \frac{1}{\vert 𝒩 \vert} {\sum }_{u ∈ 𝒩} {\tilde{α}}_{u} & ( 3 ) \\ = \frac{1}{\vert 𝒩 \vert} \frac{{\sum }_{x} {P}^{u} ( x ) max ( {p}_{i \to i + 1}^{j \to 2 j} ( x ) {p}_{i \to + 1}^{j \to 2 j} ( x ) )}{{\sum }_{x} {P}^{u} ( x )} & ( 4 )\end{matrix}$$

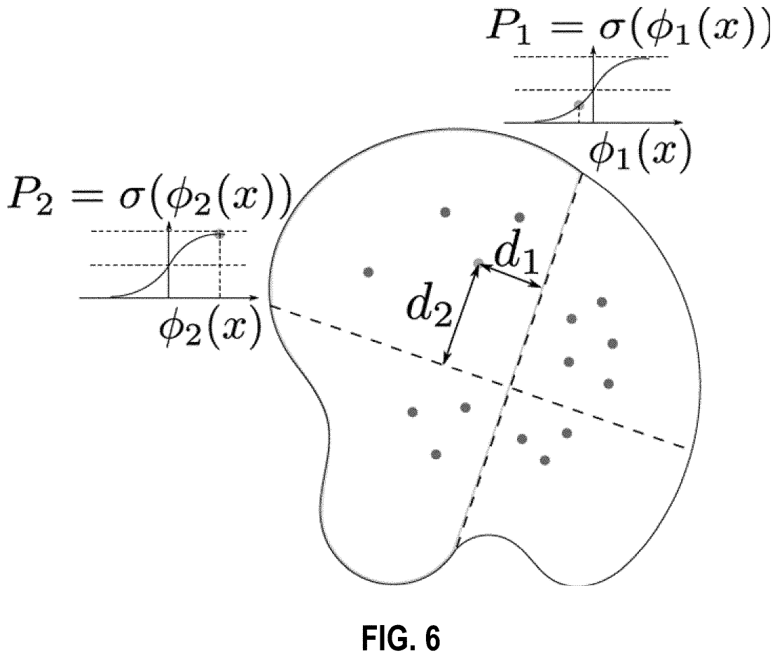

The comparison of \tilde{α} during SDT training with different values of λ is shown in FIG. 6.

Since the heuristic agent for LunarLander-v2 environment is obtained, it can be transformed the heuristic agent into a multivariate DT agent, and one obtains the decision boundaries of the tree on all its nodes. So Applicants also compare the differences of decision boundaries in heuristic tree agent H and those of the learned SDT agent L. Specifically, for normalized decision boundary vectors {hₘ|m=1, 2, . . . , M} in heuristic agent and {lₙ|n=1, 2, . . . , N} in SDT, the difference is evaluated with the following metric:

$$D ( H , L ) = \frac{1}{N} {\sum }_{n = 1}^{N} {min}_{m = 1 , 2 , … , M} {‖ {h}_{m} - {l}_{n} ‖}_{1} \qquad ( 5 )$$

Conclusions can be made from above experiments:

1. A negative value of λ for encouraging unbalanced usage of sub-trees for each node usually impedes the learning performances, and the smaller the negative values, the worse the performances are.

2. The first conclusion can be interpreted, where one can find the negative λ usually leads to an increasing differences between the decision boundaries of heuristic DT and the learned SDT, while the positive λ usually decreases the differences.

3. The negative correlation between the prediction accuracy and the weight differences is as expected, which indicates that the SDT is increasing the similarity of its decision boundaries towards those of the heuristic decision agent during training. The smaller the differences of those decision boundary vectors between the heuristic and learned, the higher the prediction accuracy the learned SDT can be.

4. The effects of negative A can increase the level of unbalance for decision nodes during training, and vice versa. It can be noted that the best SDT with A=0.001 actually has value \tilde{α}˜0.75, which is close to neither 1 nor 0.5.

Discretization

A discretization process can be used to further increase the interpretability after the SDT with soft decision boundaries is trained, which contains two subroutines: 1. change from multivariate decision nodes to be univariate ones with argmax operation on weights and normalization on bias; 2. change the soft decision boundaries with sigmoid activation to be hard decision boundaries. In practice, one can achieve the soft-to-hard change of decision boundaries by multiplying the temperature parameter β by a large enough value (e.g., 100).

Applicants compare the change of prediction accuracy on the test dataset with different λ values (same as in last section, in {0.1,0.001, 0.0001,−0.1,−0.01,−0.001}) during SDT training, and each setting is conducted with 3 runs. Surprisingly, negative A values does not provide any advantage in remaining the accuracy of model after discretization.

Applicants try to use an incremental β value during training for making the decision boundaries “harder” and therefore more immune to discretization. Specifically, the β is initialized to be 1.0 and doubled every 5 epochs during an overall training with 40 epochs, and A value is 0.001 in this case. Results show that: 1. it basically does not affect the original tree accuracy; 2. it helps maintain the accuracy after discretization to some extent. The remaining accuracy reduction is mainly caused by the transform of multivariate to univariate nodes.

Applicants argue that if the input features have very different scales in their values, the discretization operation by simply taking the argmaxᵢwᵢ as the remaining term can be problematic, since the input feature dimension can be scaling up/down and corresponding weight can be scaling down/up with the same ratio to keep the original formula unchanged. Therefore, normally Applicants require the input features to have a similar scale in their values. In original LunarLander-v2 environment this is shown to be true, with each feature dimension has a value range around 1.0. Some statistics about observation distribution for each dimension are noted, and 10000 episodes of samples are collected with the heuristic agent (from which the SDT is learning).

Cascading Differentiable Tree (CDT)

Multivariate decision tree incur a price of being less interpretable for its greater model expressiveness, as each node, especially when it is nonlinear, becomes more complicated. The interpretability of the tree model also decreases as the increase in its depth. To strike a balance between model expressiveness (thus better generalization) and interpretability, soft decision tree approaches can be used as an interpretable model with good model capacity.

Applicants propose Cascading Differentiable Tree (CDT) as an extension based on SDT with multivariate decision nodes, allowing it to have the capability of representation learning as well as decision making in transformed spaces. CDT is a tree model that have more succinct features, greater model expressiveness, and better model generalization. Applicants are motivated by a well-performing heuristic agent for LunarLander-v2 provided by OpenAI gym.

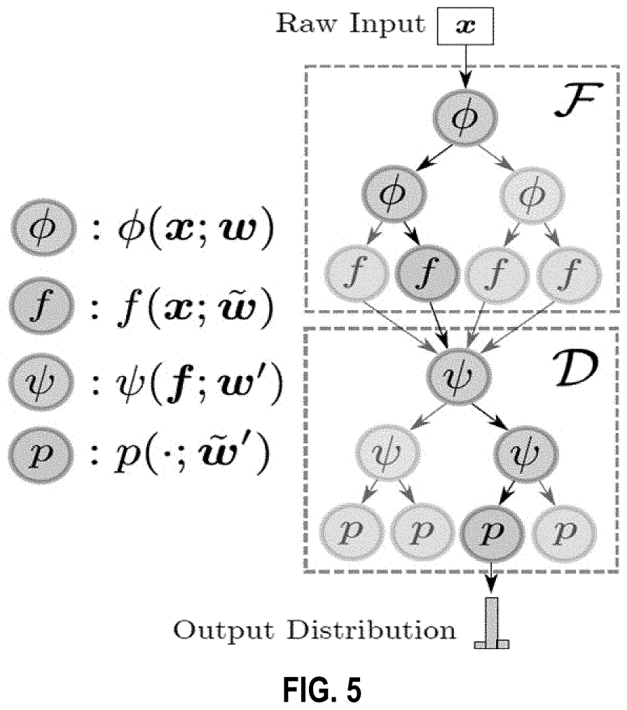

CDT is an improvement/extension of SDT with at least two trees in a cascading structure: a feature learning tree [symbol] and a decision making tree D, as shown in FIG. 5.

FIG. 5 shows a simplified CDT architecture.

A feature learning tree [symbol] is cascaded with a decision making tree D. In tree each decision node is a simple function of raw feature vector x given learnable parameters w: ϕ(x; w), while each leaf of it is a feature representation function: ƒ=ƒ(x;\tilde{w}) parameterized by \tilde{w}. In tree D, each decision node is a simple function of learned features ƒ rather than raw features x given learnable parameters w′: ψ(ƒ; w′). The output distribution of D is another parameterized function p(·; \tilde{w}′) independent of either x or ƒ. For simplicity and interpretability, all functions ϕ, ƒ and ψ are linear functions in the examples, but they are free to be extended with other interpretable models.

Specifically, the learned intermediate features {ƒₖ|k=0,1, . . . , K−1} are linear combinations (no bias terms) of the raw input features {xᵣ|r=0,1, . . . , R−1} with R dimensions as:

ƒₖ=Σ_{r=0,1, . . . ,R-1}\tilde{w}ₖᵣxᵣ (6)

So each leaf of the feature learning tree assigns the intermediate features with different values via different weights. For example, for the l-th leaf, the feature set will be {ƒₖ^{l}|k=0,1, . . . , K−1} with leaf weights {\tilde{w}ₖᵣ^{l}|k=0,1, . . . , K−1,r=0,1, . . . , R−1}.

In the decision making trees, those learned intermediate features will be taken as normal input features to a shallow SDT. During training, Applicants use the expected intermediate features from all leaves in the feature learning tree as input features to the decision making tree:

$$\begin{matrix}{f}_{k} = ϕ ( x ) & ( 7 ) \\ = {\sum }_{l = 0}^{L - 1} {P}_{l} {f}_{k}^{l} , k = 0 , 1 , … , K - 1 & ( 8 )\end{matrix}$$

where Pₗ is the path probability from the root node to the l-th leaf node in the feature learning tree, and ƒₖ^{l} is the k-th dimension of intermediate feature for the l-th leaf in the feature learning tree.

Each leaf of the feature learning tree represents one possible assignment of intermediate feature values, a total of L possibilities. During the inference process, the system can be adapted, in a variant embodiment, to take the leaf with largest probability to assign values for intermediate features, which may sacrifice little accuracy but increase interpretability. Other approaches are possible.

Applicants note that the modified tree structure of CDT is greatly simplified, compared to SDT. In fact, by sharing the same feature set in the decision tree [symbol] , CDT can be interpreted as a SDT with a low rank constraint in [symbol] . In terms of the number of parameters, considering the case where Applicants have raw feature dimension of inputs as R and the intermediate feature dimension to be K<R. Supposing the output dimension is 0, the number of parameters of a CDT with two cascading trees of depth d₁ and d₂ is

N(CDT)=[(R+1)(2^{d}^{₁}−1)+K·R·2^{d}^{₁}]+[(K+1)(2^{d}^{₂}−1)+O·2^{d}^{₂}] (9)

while the number of parameters of a SDT with depth d is:

N(SDT)=(R+1)(2^{d}−1)+O·2^{d} (10)

Considering an example with CDT of d₁=2, d₂=3 and SDT of depth d=d₁+d₂=5, raw feature dimension R=8, intermediate feature dimension K=4, and output dimension O=4, N(CDT)=222 and N(SDT)=407. It indicates a reduction of about half of the parameters in this case.

Specifically, Applicants provide detailed mathematical relationships based on linear functions as follows. For an environment with input state vector x and output discrete action dimension O, suppose that the CDT has intermediate features of dimension K (not the number of leaf nodes on [symbol] , but for each leaf node), there is the probability of going to the left/right path on the u-th node on [symbol] :

pᵤ^{GoLeft}=σ(wₖ·x), pᵤ^{GoRight}=1−pᵤ^{GoLeft}

which is the same as in SDTs. Then one has the linear feature representation function for each leaf node on [symbol] , which transforms the basis of the representation space with:

ƒₖ=\tilde{w}ₖ·x, k=0,1, . . . ,K−1, which gives the K-dimensional intermediate feature vector ƒ for each possible path.

Due to the symmetry in all internal layers within a tree, all internal nodes satisfy the two formulas above. In tree [symbol] , it is also a SDT but with raw input x replaced by learned representations ƒ for each node u′ in [symbol] :

p_{u′}^{GoLeft}=σ(\tilde{w}ₖ·ƒ), p_{u′}^{GoRight}=1−p_{u′}^{GoLeft},

Finally, the output distribution is feature-independent, which gives the probability mass values across output dimension O for each leaf of [symbol] as:

$${p}_{{k}^{′}} = \frac{exp ( {\tilde{w}}^{′} )}{{\sum }_{{k}^{′} = 0}^{O - 1} exp ( {\tilde{w}}_{{k}^{′}}^{′} )} , {k}^{k} = 0 , 1 , … , O - 1$$

Suppose there is a CDT of depth N₁ for [symbol] and depth N₂ for [symbol] , the probability of going from root of either [symbol] or [symbol] to u-th leaf node on each sub-tree both satisfies previous derivation in SDTs: P^{u}=Π_{i′=1}^{j′}p_{i′-1→i′}^{└j′/2┘→j′}, u′∈ [symbol] , where [symbol] is the set of nodes on path. Therefore the overall path probability of starting from the root of [symbol] to u₁-th leaf node of [symbol] and then u₂-th leaf node of D is:

P=P^{u}^{₁}P^{u}^{₂}

Each leaf of the feature learning tree represents one possible assignment for intermediate feature values, while they share the subsequent decision making tree. During the inference process, the system can be configured to simply take the leaf on [symbol] or [symbol] with the largest probability to assign values for intermediate features (in [symbol] ) or derive output probability (in [symbol] ), which may sacrifice little accuracy but increase interpretability.

Model Simplicity

Applicants analyze the simplicity of CDT compared with SDT in terms of the numbers of learnable parameters in the model. The reason for doing this is that in order to increase the interpretability, one needs to simplify the tree structure or reduce the number of parameters including weights and bias in the tree.

The model simplicity of CDT can be analyzed against a normal SDT with linear functions in a matrix decomposition perspective. Suppose there is a need for a total of M multivariate decision nodes in the R-dimensional raw input space [symbol] to successfully partition the space for high-performance prediction, which can be written as a matrix W_{M×R}^{x}.

CDT tries to achieve the same partitions through learning a transformation matrix T_{K×R}: [symbol] → [symbol] for all leaf nodes in [symbol] and a partition matrix W_{M×K}^{ƒ} for all internal nodes in [symbol] in the K-dimensional feature space [symbol] , such that:

W^{x}x=W^{ƒ}ƒ=W^{ƒ}Tx

⇒=W^{x}=W^{ƒ}T

Therefore the number of model parameters to be learned with CDT is reduced by M×R−(M×K+K×R) compared against a standard SDT of the same total depth, and it is a positive value as long as

$$K < \frac{M \times R}{M + R} ,$$

while keeping the model expressivity.

Hierarchical CDT

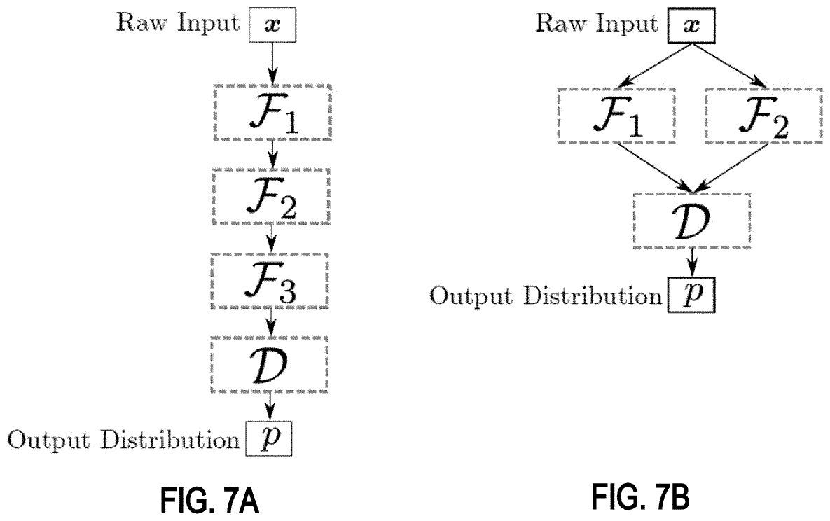

From above, a simple CDT architecture as in FIG. 5 with a single feature learning model [symbol] and single decision making model [symbol] can achieve intermediate feature learning with a significant reduction in model complexity compared with traditional SDT. However, sometimes the intermediate features learned with [symbol] may be unsatisfying for capturing complex structures in advanced tasks, therefore Applicants further extend the simple CDT architecture into more hierarchical ones. As shown on FIG. 7(a) and FIG. 7(b), two potential types of hierarchical CDT are displayed: (a) a hierarchical feature abstraction module with three feature learning models { [symbol] ₁, [symbol] ₂, [symbol] ₃} in a cascading manner before inputting to the decision module [symbol] ; (b) a parallel feature extraction module with two feature learning models { [symbol] ₁, [symbol] ₂} before concatenating all learned features into [symbol] .

One needs to bear in mind that whenever the model structures are complicating, the interpretability of the model decreases due to the loss of simplicity. Therefore Applicants did not apply the hierarchical CDTs in the experiments for maintaining interpretability. However, the hierarchical structure is one of the most preferred ways to keep simplicity as much as possible if trying to increase the model capacity and prediction accuracy, so it can be applied when necessary.

Feature Importance Assignment on Trees

One important question in explainable AI is to determine the importance of different features. The way of deriving importance values with decision nodes on the tree is neither trivial nor unique. The debate comes from the different weights for different nodes, and inside each node, the different weights for different features/variables. The importance of each variables/features can arguably depend on the loss function for training as well.

For SDT-based methods, since each node is linear, the system, in a variant embodiment, can take wᵢ^{j} as the importance assignment for those features within each node. A local explanation can be derived with the inference process of a single instance and its decision path on the tree. A global explanation can be defined as the average local explanation across instances, e.g., in an episode or several episodes under the RL settings. Applicants list several examples of assigning importance values for input features with SDT, to derive the feature importance vector I with the same dimension as the decision node vectors w and input feature.

1. A simple way of feature importance assignment on SDT would be simply adding up all weight vectors of nodes on the decision path: I(x)=Σ_{i,j}wᵢ^{j}(x). This is essentially assigning the same weight for each node.

2. Another way is a weighted average of the decision vectors, w.r.t the confidence of the decision boundaries for a specific instance. Considering the soft decision boundary on each node, Applicants assume that the more confident the boundary is applied to partition the data point into a specific region within the space, the more reliable Applicants can assign feature importance according to the boundary. The confidence of a decision boundary can be positively correlated with the distance from the data point to the boundary, or the probability of the data point falling into one side of the boundary. The latter one can be straightforward in certain settings.

Applicants define the confidence as p(x), where p(x)=p_{i-1→i}^{└j/2┘→j}(x) is the probability of choosing node j in i-th layer from its parent on instance x's decision path. It indicates how far the data point is from the middle of the soft boundary in a probabilistic view. Therefore the importance value is derived via multiplying the confidence value with each decision node vector: I(x)=Σ_{i,j}p_{i-1→i}^{└j/2┘→j}(x)wᵢ^{j}(x).

FIG. 6 helps to demonstrate the reason for using the decision confidence (i.e., probability) as a weight for assigning feature importance, which indicates that the probability of belonging to one category is positively correlated with the distance from the instance to the decision boundary. Therefore when there are multiple boundaries for partitioning the space (e.g., two in the figure), Applicants assign the boundaries with shorter distance to the data point with smaller confidence in determining feature importance, since based on the closer boundaries the data point is much easier to be perturbed into the contrary category and less confident to remain in the original. FIG. 6 shows multiple soft decision boundaries that partition the space. The boundaries closer to the instance are less important in determining the feature importance since they are less distinctive for the instance.

Since the tree Applicants use is differentiable, Applicants can also apply gradient-based methods for feature importance assignment, which is:

$$I ( x ) = \frac{\partial y}{\partial x} , \qquad$$

where y=SDT(x).

Other Extensions

One needs to bear in mind the balance between model capacity and model interpretability. In this description, Applicants only use CDT for the experiments. However, if more complex models are necessary to achieve acceptable performances, different extensions on CDT are also possible. Here Applicants present two possible extensions.

Soft Decision Forest (SDF) One can further combine multiple CDTs to improve model accuracy. Here the combination weights can be learned. The extension from CDT to SDF can be useful in some variant embodiments, no matter the trees are averaged or fused with learnable parameters. A combination of CDTs and SDTs or other decision trees can also be used in some embodiments to create a forest of potential models. Suppose that the weight parameter for each tree is aₖ, where k=1, 2, . . . , M is the index of the tree in a SDF of M trees. Given the importance vectors for each tree Iₖ, Applicants have the overall importance for the SDF as:

I=Σₖ₌₁^{M}aₖIₖ (11)

Hierarchical CDT CDT can also be extended to a hierarchical structure to learn more complex features. Two potential types of hierarchical CDT is presented in FIG. 7A and FIG. 7B: FIG. 7A is a hierarchical feature abstraction architecture with three feature learning models { [symbol] ₁, [symbol] ₂, [symbol] ₃} in a cascading manner before inputting to the decision module [symbol] ; FIG. 7B a parallel feature extraction architecture with two feature learning models { [symbol] ₁, [symbol] ₂} before concatenating all features into [symbol] . FIG. 7A and FIG. 7B show two possible types of hierarchical CDT architectures. FIG. 7A is an example architecture with hierarchical representation learning using three cascading F before one D, and FIG. 7B is an example architecture with two F in parallel, potentially with different dimensions of x as inputs.

### EXPERIMENTS

Applicants' experiments demonstrate that CDTs are able to strike a good balance between model capacity and model interpretability. In particular, Applicants present the results for both cases where CDTs are used as function approximators and where CDTs are used as proxy models to complex ones. Applicants focus on the reinforcement learning domain.

Applicants compare CDT and SDT on two settings for interpreting RL agents: (1) the imitation learning setting, whereas the RL agent with a black-box model (e.g. neural network) to interpret first generates a state-action dataset for imitators to learn from, and the interpretation is derived on the imitators; (2) the full RL setting, whereas the RL agent is directly trained with the policy represented with interpretable models like CDTs or SDTs, such that the interpretation can be derived by directly spying into those models. The environments are CartPole-v1, LunarLander-v2 and MountainCar-v0 in OpenAI Gym. The depth of CDT is represented as “d₁+d₂” in the following sections, where d₁ is the depth of feature learning tree [symbol] and d₂ is the depth of decision making tree D. Each setting is trained for five runs in imitation learning and three runs in RL.

Both the fidelity and stability of mimic models reflect the reliability of them as interpretable models. Fidelity is the accuracy of the mimic model, w.r.t. the original model. It is an estimation of similarity between the mimic model and the original one in terms of prediction results. However, fidelity is not sufficient for reliable interpretations. An unstable family of mimic models will lead to inconsistent explanations of original black-box models. The stability of the mimic model is a deeper excavation into the model itself and comparisons among several runs. Previous research has investigated the fidelity and stability of decision trees as mimic models, where the stability is estimated with the fraction of equivalent nodes in different random decision trees trained under the same settings. In the experiments, the stability analysis is conducted via comparing tree weights of different instances in imitation learning settings.

The main environment where experiments are conducted is the LunarLander-v2 environment, where there exists a well-performing heuristic agent that can be express as a multivariate DT. Therefore, a good solution in the hypothesis set of the possible models exists. Applicants also test on a relatively easier task CartPole-v1 for more comparisons.

CDT as a Function Approximator

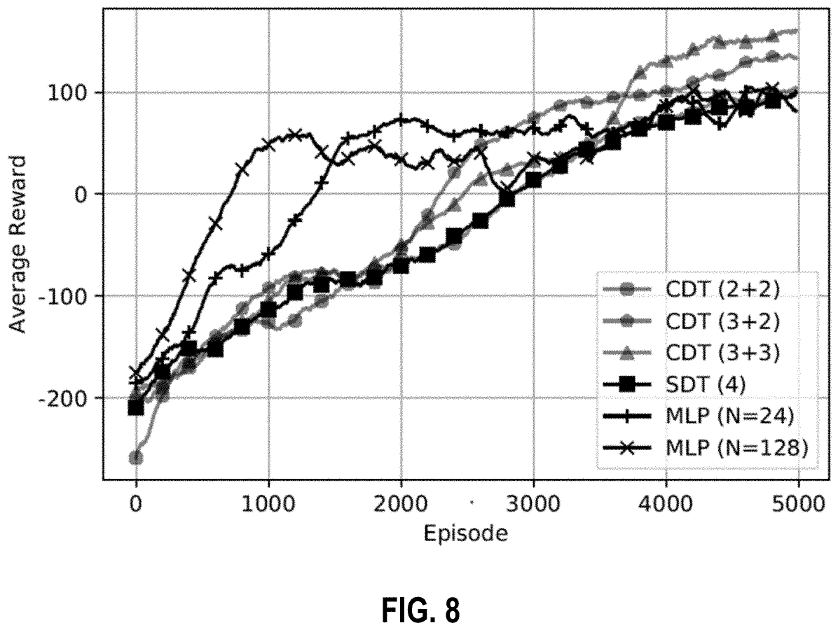

Applicants use CDT and SDT as the policy function approximators in PPO, and compare their learning performances with normal multilayer perceptron (MLP) on LunarLander-v2 environment, as shown in FIG. 8. CDT(x+y) represents the CDT model with depth x feature learning sub-tree and depth y decision making sub-tree. SDT(x) represents the SDT model with depth x.

In the MLP model, N is the number of hidden units. Applicants use ReLU as the activation function.

The MLP(N=24) network has 316 parameters which is compatible with the CDTs and SDTs in magnitude, while MLP(N=128) has 1668 parameters. The value function is approximated by a 2-layer network with 128 hidden nodes for all CDT, SDT and MLP settings above. All the results are averaged among multiple runs where the shadow area. As one can see from FIG. 8, CDT attains a good balance between its performance and the number of parameters for the model. CDT(3+3) achieves the best result while maintains a small number of parameters.

FIG. 8 is a graph showing a comparison of CDT, SDT and MLP as policy function approximators for PPO in a RL setting, and the environment is LunarLander-v2.

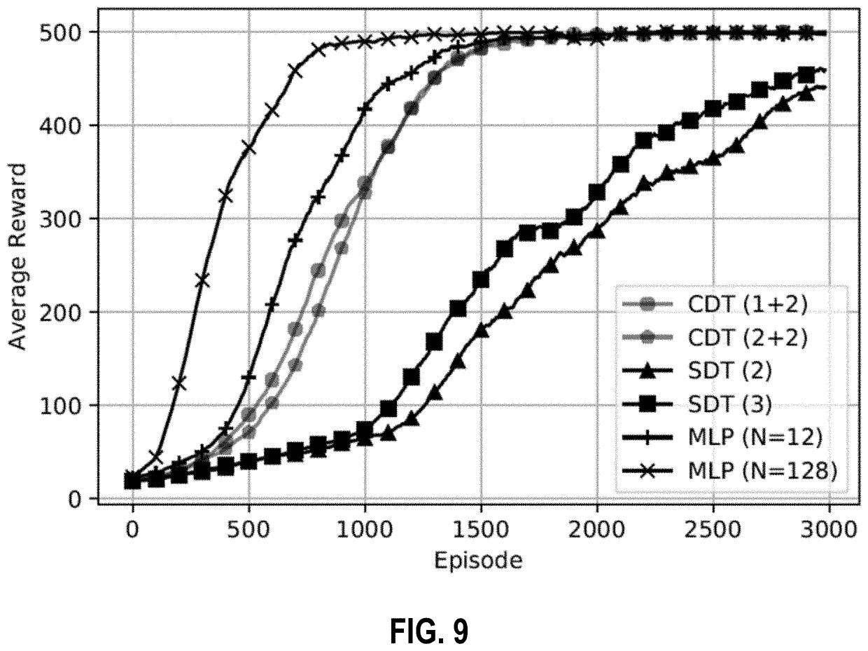

Applicants also test the performances of different models on CartPole-v1 environment, a relatively simpler task. The results are reported in FIG. 9.

Applicants observe that the CDT method almost converges as fast as the MLP (N=12), while the SDTs learn slower. Although the MLP with number of hidden nodes of 128 can learn even faster, it has far more parameters in the model and therefore is not interpretable at all. FIG. 9 is a graph showing a outputs for a comparison of CDT, SDT and MLP as policy function approximators for PPO in a RL setting, and the environment is CartPole-v1.

CDT to Explain a Black-Box Model

CDT can also be used as a proxy model to explain a more complex model, such as DNN. Using knowledge distillation/imitation learning to explain a complex model is a useful approach, where a more interpretable model is learned as a proxy of the true model, and thus explanation attained from the proxy model is used as an explanation for the original model. Typical interpretable proxy models include linear model and decision/regression trees. Applicants test CDT as a proxy model for black-box model interpretation.

Similarly, Applicants compare the accuracy of CDT and SDT (both without temperature parameters) with different depths and number of parameters. Applicants also include the discretized CDT (D-CDT) and discretized SDT (D-SDT).

The results are reported in Table 1. All CDTs have the number of intermediate features of 2 in the experiments. Each result is an average over 3 runs on the dataset by heuristic agent for the LunarLander-v2 environment, and both the mean and standard deviation of the accuracy are provided in the table.

For CDT, Applicants find that by discretizing the feature learning tree to improve the interpretability of the model, there is only a slight decrease in prediction accuracy, while discretizing the decision making tree may severely hurt the accuracy. This is also observed in SDTs. Therefore, the D-CDTs only discretize the feature learning trees in the experiments.

TABLE 1
Comparison of CDT and SDT for LunarLander-v2
with imitation learning setting

| | | # of |
|---|---|---|
| Tree Type | Accuracy (%) | Parameters |
| SDT (4) | 85.4 ± 0.4 | 199 |
| SDT (5) | 87.6 ± 0.5 | 407 |
| SDT (6) | 88.7 ± 1.3 | 823 |
| SDT (7) | 88.9 ± 0.5 | 1655 |
| CDT (2 + 2) | 88.2 ± 1.6 | 116 |
| CDT (2 + 3) | 88.3 ± 1.7 | 144 |
| CDT (3 + 2) | 90.4 ± 1.7 | 216 |
| CDT (3 + 3) | 90.4 ± 1.2 | 244 |
| D-SDT (4) | 54.8 ± 10.1 | 94 |
| D-SDT (5) | 51.6 ± 4.5 | 190 |
| D-SDT (6) | 60.2 ± 3.9 | 382 |
| D-SDT (7) | 62.7 ± 2.8 | 766 |
| D-CDT (2 + 2) | 78.0 ± 2.4 | 95 |
| D-CDT (2 + 3) | 70.2 ± 2.3 | 123 |
| D-CDT (3 + 2) | 72.2 ± 8.3 | 167 |
| D-CDT (3 + 3) | 72.0 ± 1.2 | 195 |

Table 2 shows the comparison of SDT and CDT on prediction accuracy and number of parameters in the models. CDT are trained for 40 epochs to converge while SDT are trained for 80. In the column of ‘Accuracy’, values in brackets are D-CDT with only discretization for decision making tree and discretization for both the feature learning tree and decision making tree.

| | | # of |
|---|---|---|
| Tree Type | Accuracy (%) | Parameters |
| SDT (2) | 94.1 ± 0.01 | 23 |
| SDT (3) | 94.5 ± 0.1 | 51 |
| SDT (4) | 94.3 ± 0.3 | 107 |
| CDT (1 + 2) | 95.4 ± 1.1 | 38 |
| CDT (2 + 1) | 95.6 ± 0.1 | 54 |
| CDT (2 + 2) | 96.6 ± 0.9 | 64 |
| D-SDT (2) | 49.7 ± 0.0 | 14 |
| D-SDT (3) | 50.0 ± 0.01 | 30 |
| D-SDT (4) | 50.1 ± 0.1 | 62 |
| D-CDT (1 + 2) | 94.4 ± 0.8 | 35 |
| | (84.1 ± 2.8, | |
| | 83.8 ± 2.6) | |
| D-CDT (2 + 1) | 92.7 ± 0.4 | 45 |
| | (88.4 ± 1.3, | |
| | 89.0 ± 0.4) | |
| D-CDT (2 + 2) | 91.6 ± 1.3 | 55 |
| | (82.9 ± 3.7, | |
| | 81.9 ± 1.8) | |

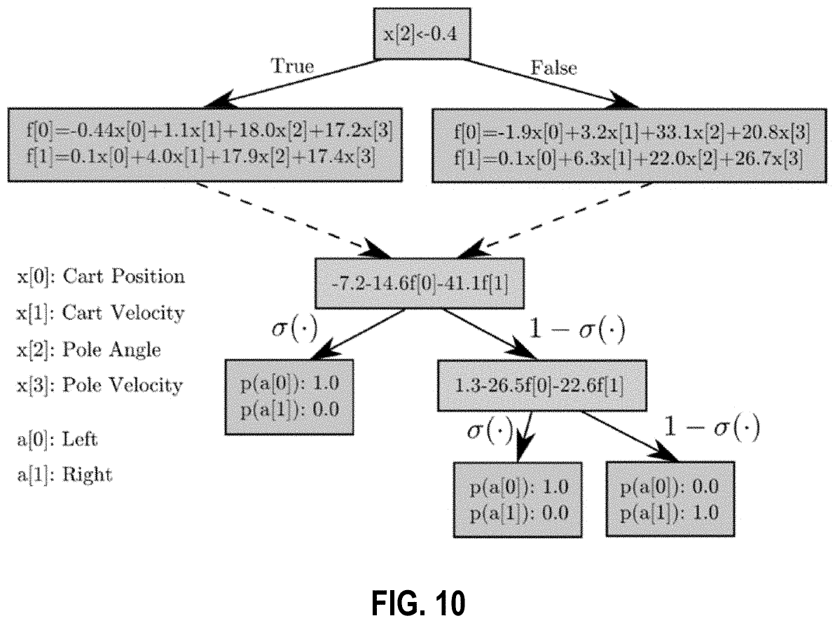

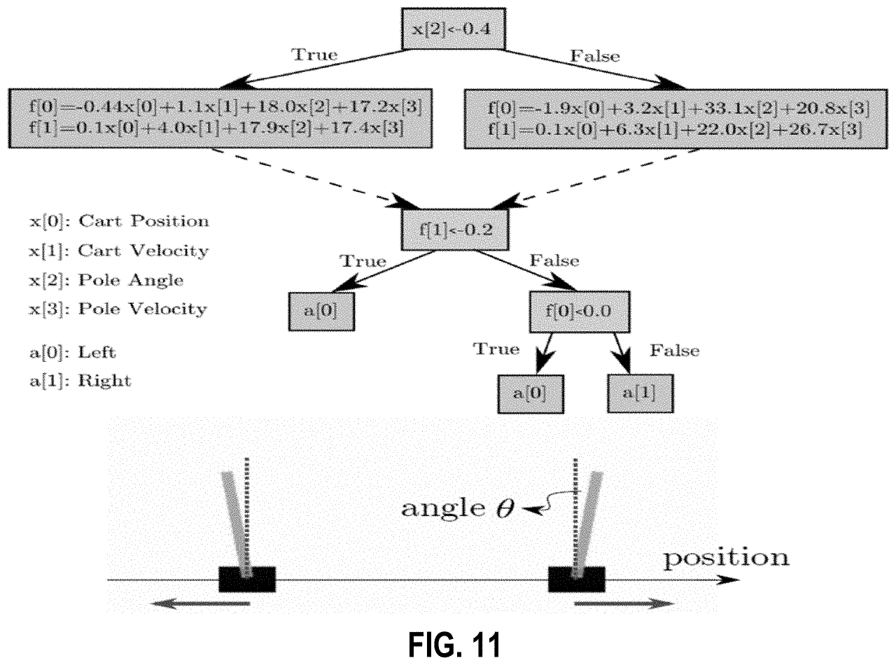

FIG. 10 and FIG. 11 visualize the learned CDT after discretization (i.e., D-CDT), which improves interpretability based on CDT. In FIG. 10, only the feature learning sub-tree is discretized; while in FIG. 11, both the feature learning sub-tree and the decision making sub-tree are discretized. The original SDT and CDT after training are displayed in the Appendix.

FIG. 10 is a Visualization of learned CDT (depth 1+2) after discretization for CartPole-v1: top is the discretized feature learning tree, and bottom is the decision making tree. FIG. 11 is a visualization of learned CDT (depth 1+2) after discretization for CartPole-v1: top is the discretized feature learning tree, and bottom is the discretized decision making tree.

Stability

Can Applicants Show CDT is Better Compared to SDT?

Both the fidelity and stability of mimic models reflects the reliability of them as interpretable models. Fidelity is the accuracy of the mimic model, w.r.t. the original model. It is an estimation of similarity between the mimic model and the original one in terms of prediction results, which is guaranteed to be close to 99% in above tests with SDT-based methods. However, fidelity is not sufficient for reliable interpretations. An unstable family of mimic models will lead to inconsistent explanations of original black-box models. Stability of mimic model is a deeper excavation into the model itself and comparisons among several runs. Previous research has investigated the fidelity and stability of decision trees as mimic models, where the stability is estimated with the fraction of equivalent nodes in different random decision trees trained under the same settings. However, in testing, Applicants use the feature importance given by different runs of a same SDT for measuring the stability.

To testify the stability of applying SDT method with imitation learning from a given agent, Applicants compare the SDT agents of different runs and original agents using certain metric. The original agent Applicants use is the HDT, and the metric for evaluation is assigned feature importance across an episode. Feature importance values can be assigned on a DT by summing up the weights on the decision path for a single instance, which works for both HDT and SDT.

Different Tree Depths: First, the comparison of feature importance (adding up node weights on decision path) for HDT and the learned SDT of different depths in an online decision episode is conducted. All SDT agents are trained for 40 epochs to convergence. The accuracies of three trees are 87.35%, 95.23%, 97.50%, respectively.

Considering SDT of different runs may predict different actions, even if they are trained with the same settings and for a considerable time to achieve similarly high accuracies, Applicants conduct comparisons not only for an online decision process during one episode, but also on a pre-collected offline state dataset by the HDT agent. Applicants hope this can alleviate the accumulating differences in trajectories caused by consecutively different actions made by different agents, and give a more fair comparison on the decision process (or feature importance) for the same trajectory.

Same Tree with Different Runs: Applicants compare the feature importance on an offline dataset, containing the states of the HDT agent encounters in one episode. All SDT agents have a depth of 5 and are trained for 80 epochs to convergence. The three agents have testing accuracies of 95.88%, 97.93%, 97.79%, respectively.

A SDT imitating a pre-trained PPO policy is also involved, which is less well-behaved compared with the other three directly imitating the heuristic agent's behaviours. The feature importance values are evaluated with different approaches as mentioned above.

Extension to Image-Based Environments

Problems of Extending to Image-Based Environments Like Atari Games in OpenAI Gym:
For decision nodes in the tree, linear combinations of image pixels can be meaningless, unlike low-dimensional cases.
The same problem exists for the intermediate features in CDT, a weighted sum of image pixels can be hard to interpret as well.

Therefore the structure of CDT needs to be modified for image-based environments. Experiments on MNIST dataset are conducted and show that the SDT with simple linear relationships on the decision nodes can provide a certain level of explainability. However, it seems only for digits “3” and “8” the filter can be interpretable for human, while other filters still looks like confusion, especially for classification of two sets of multiple digits with top nodes in the tree.

Discussions

First of all, MNIST digits classification may not be a proper task for testing CDT, since Applicants may not expect some useful intermediate features derived from images for classifying the digits. MNIST classification is simply a pattern recognition problem without underlying rules for logical deduction, while the advantages of CDT compared with SDT lie in the simplification of complicated logical deduction process through leveraging hierarchical features.

Applicants discuss the point that most people give tacit consent to: Applicants need to always reduce the hierarchies in either features or decision rules, since any hierarchies will sacrifice simplicity and interpretability, including hierarchical decision rules and hierarchical features. These two hierarchies are complementary to each other. If Applicants discard the hierarchical features like SDT, Applicants need a tree with deeper structure; while if Applicants adopt hierarchical features (i.e., intermediate features) like CDT, the tree will be simplified to have less decision hierarchy. To ensure a certain accuracy/performance for the model/policy on a specific task, the model/policy has to embody the irreducible complexity of the task solution, which comes down to the complexities of features and decision rules, and hierarchy is the way to achieve this kind of complexity. Back to the argument, SDT can be used for transferring the hierarchies in features (e.g., feature maps in convolutional neural networks) into the hierarchies of decision rules, but this does not significantly remove the hierarchies or complexity within the model, since there is no free step for maintaining the model accuracy as well as reducing its complexity. From the example of heuristic agent in LunarLander-v2 environment, Applicants see that the human interpretable model can be a somewhat fair level of both feature hierarchies and decision hierarchies.

On the other hand, even if the DT version of the heuristic agent in LunarLander-v2 environment is given, it is still hard for human to interpret the tree directly. But human can understand the decision rules in heuristic agent with proper explanation, so what is missing here? The answer is that human interpretation is closely related to his knowledge background, world models, understandings of physics and motions in the scenes. Without the connections from numerical relations to physical meanings, human may find hard to interpret something even if the overall hierarchy is simple. This brings up the need to involve knowledge priors in interpreting a model.

Leveraging a certain amount of knowledge prior is essential especially for model with images as input, and different tasks may require significantly different aspects of knowledge. Take RL environments as example. For Freeway-v0 the key features for human to make action decisions are the motions and positions of the cars on the road, rather than the graphical patterns of each car. So a compact set of decision rules for this task should be built on top of the extraction that each car can be simply represent as a point, or a landmark. For CarRacing, apart from the current car position, what matters most is the curvature of the road. So the interpretable decision rules should be built on the recognition of the curvature, and a function to map that curvature to a certain action. Both of these examples testify that at least a linear combination of image pixels will never provide us these useful abstractions, for truly interpretable decision rules. This requires the interpretable model to have the ability to find the way for achieving abstraction for different representations from image pixels.

The proposed CDT model is used for simplifying the decision making process based on compact representation of entities, rather than directly trying to interpret the whole model with raw images as input. This draws a line between the work and other works on interpreting image recognition models. Moreover, since these two categories are orthogonal to each other, and object entity recognition can be a cornerstone for high-level logical decision process, the model may leverage on the extracted low-dimensional representations from interpretable recognition model with images, to achieve a fully-interpretable policy model. The learning process for the recognition model can be unsupervised learning with data samples collected by RL agent, or supervised learning with very few labels.

### CONCLUSION

Applicants proposed CDT in in various embodiments described herein. CDT separately models the feature learning component and the decision making component by two shallow SDTs to encourage feature sharing and thus improves the model's interpretability. Applicants' experiments demonstrated that CDT achieves a better balance between model capacity and model interpretation, when compared to SDT, on two reinforcement learning tasks.

A simple CDT cascades a feature learning DT and a decision making DT into a single model. From the experiments, Applicants show that compared with traditional differentiable DTs (i.e., DDTs or SDTs) CDTs have better function approximation in both imitation learning and full RL settings with a significantly reduced number of model parameters while better preserving the tree prediction accuracy after discretization. Applicants also qualitatively and quantitatively corroborate that the SDT-based methods with imitation learning setting may not be proper for achieving interpretable RL agents due to instability among different imitators in their tree structures, even when having similar performances. Finally, Applicants contrast the interpretability of learned DTs in RL settings, especially for the intermediate features. The analysis supports that CDTs lend themselves to be further extended to hierarchical architectures with more interpretable modules, due to its richer expressivity allowed via representation learning.

Extensions of the approach can further include the investigation of hierarchical CDT settings and well-regularized intermediate features for further interpretability. Additionally, since the present experiments are demonstrated with linear transformations in the feature space, non-linear transformations are expected to be leveraged for tasks with higher complexity or continuous action space while preserving interpretability.

Detailed CDT Architecture

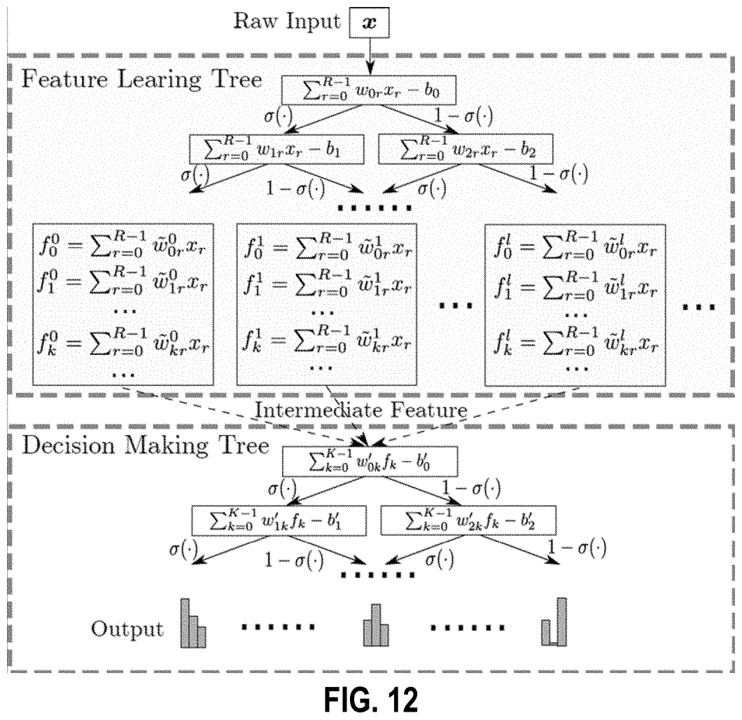

FIG. 12 shows a detailed architecture of CDT: the feature learning tree is parameterized by w and b, and its leaves are parameterized by \tilde{w}, which represents L possible intermediate feature values with a dimension of K; the decision making tree is parameterized by w′ and b′.

SDT Experiments

Observation Statistics in LunarLander-v2

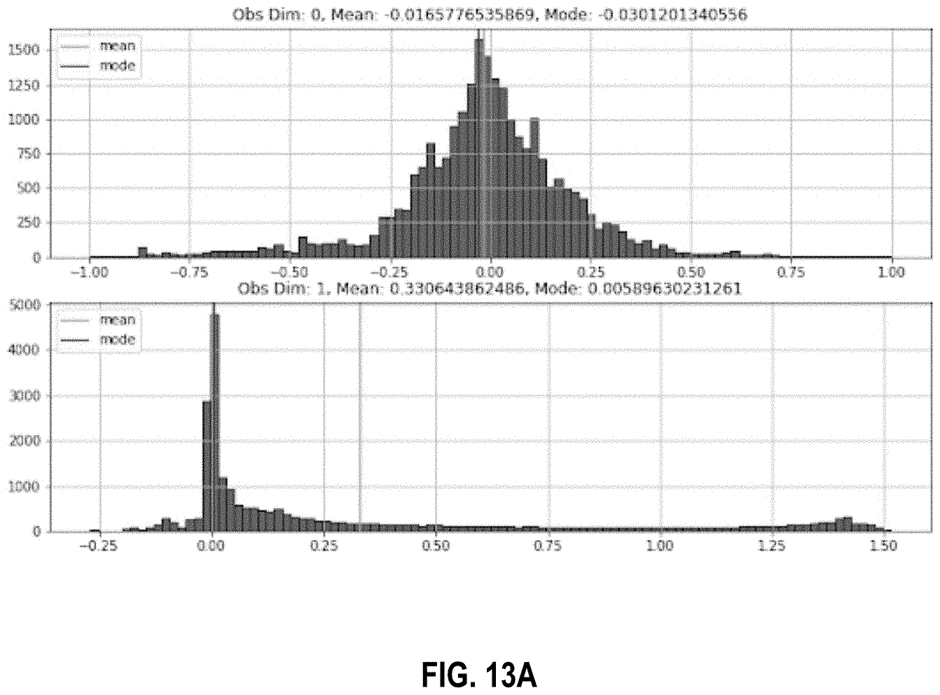

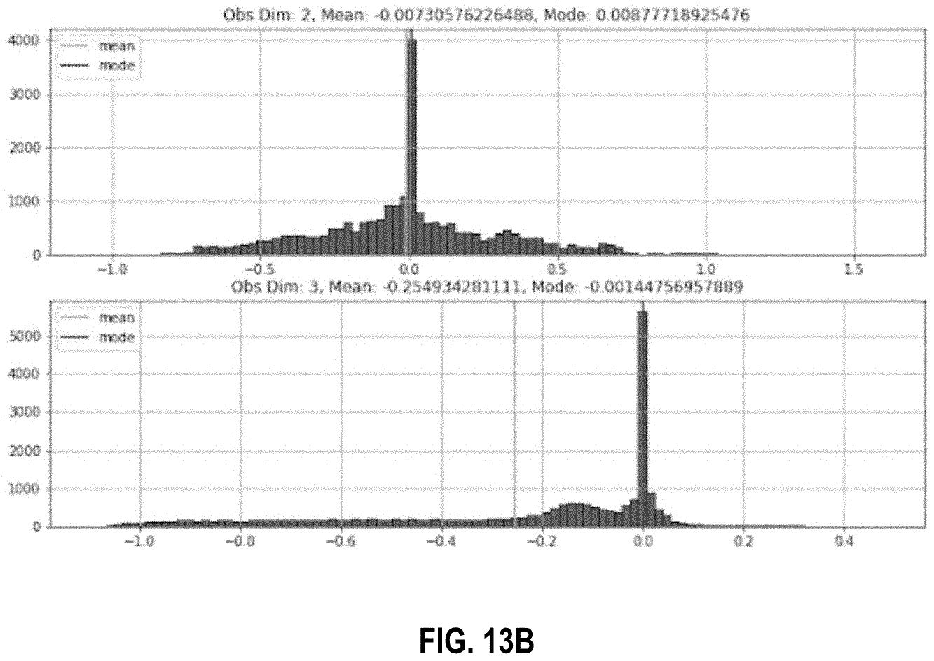

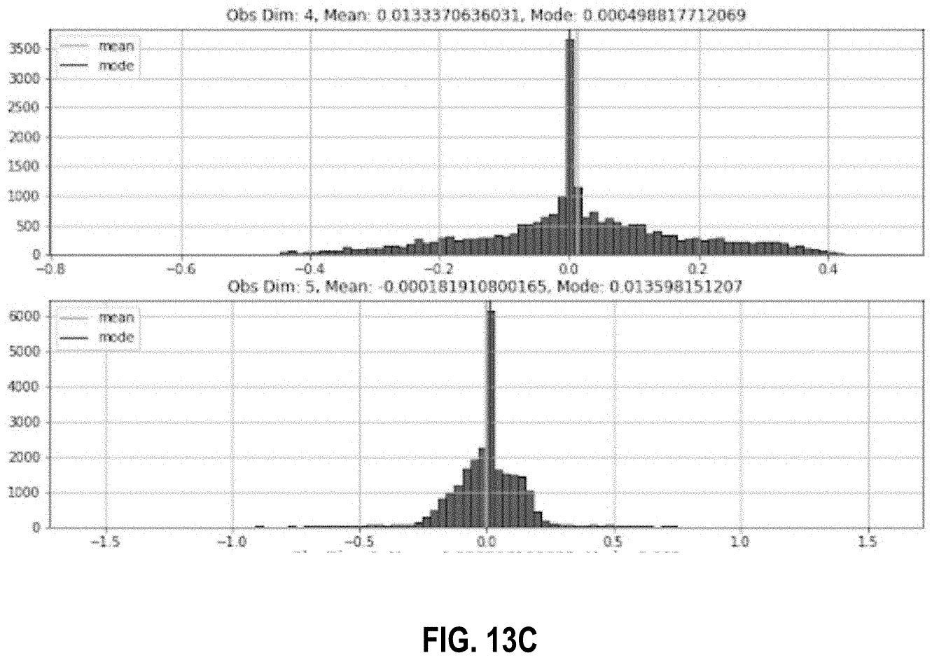

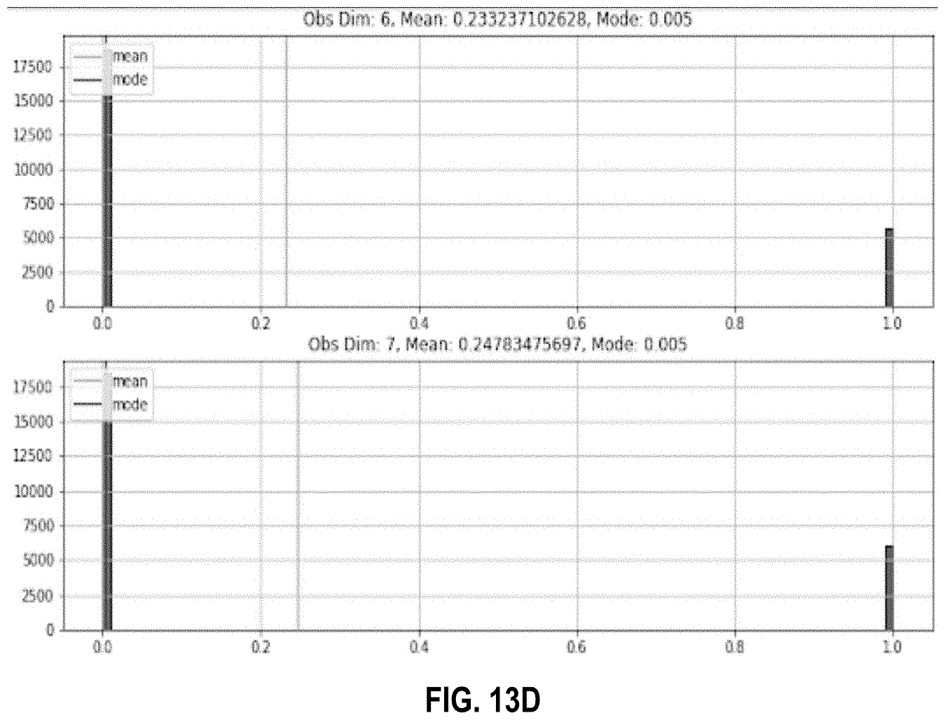

Applicants collect 10000 episodes of samples with the heuristic agent on LunarLander-v2 environment, and use them as the dataset to acquire the observation statistics as shown in FIG. 13A, 13B, 13C, 13D. There are in total 8 dimensions for the observation space in LunarLander-v2, the top six are continuous and the last two are binary. The means and modes are given for each dimension, as well as their value distributions. Applicants can see that most values are in range of [−1,1], therefore Applicants believe that the value ranges will not raise potential problems for discretization operation in this environment. FIG. 13A, 13B, 13C, 13D shows observation statistics for each dimension in LunarLander-v2 with heuristic agent: the top six dimensions are continuous spaces, the last two are binary spaces. Means and modes are given in each dimension.

CDT Visualization

LunarLander-v2

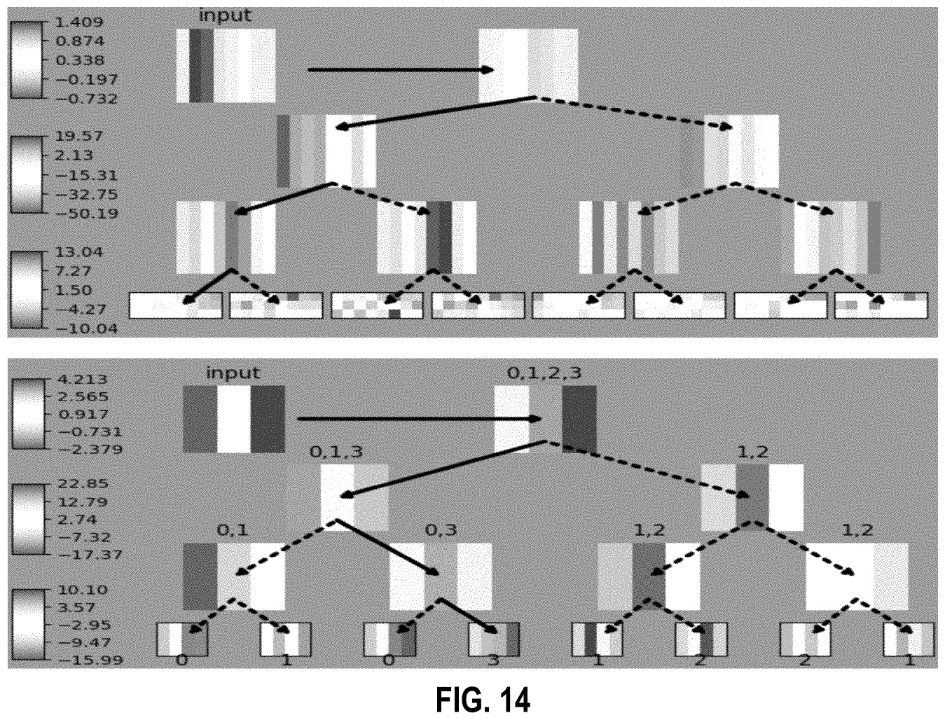

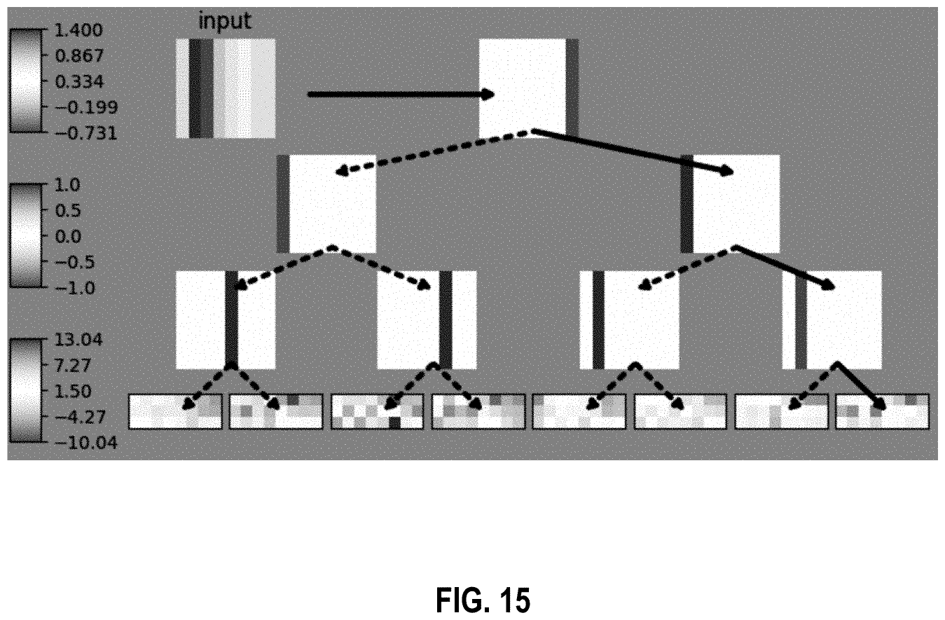

Applicants visualize the CDT (imitation learning) for LunarLander-v2 environment after training as in FIG. 14. The discretized feature learning tree in CDT is also displayed in FIG. 15. FIG. 14 shows a visualization of learned CDT for LunarLander-v2: top is the feature learning tree, and bottom is the decision making tree. FIG. 15 is an rendering of the discretized feature learning tree.

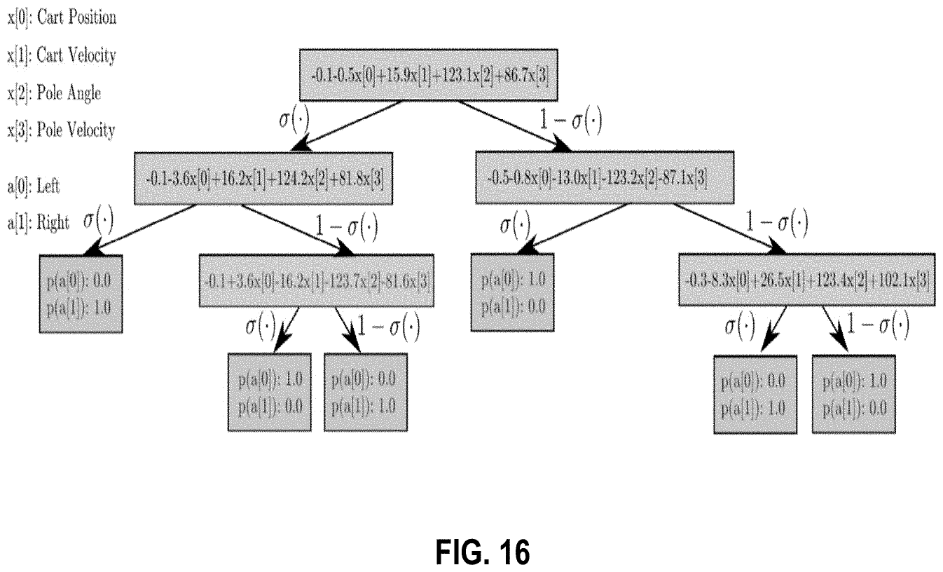

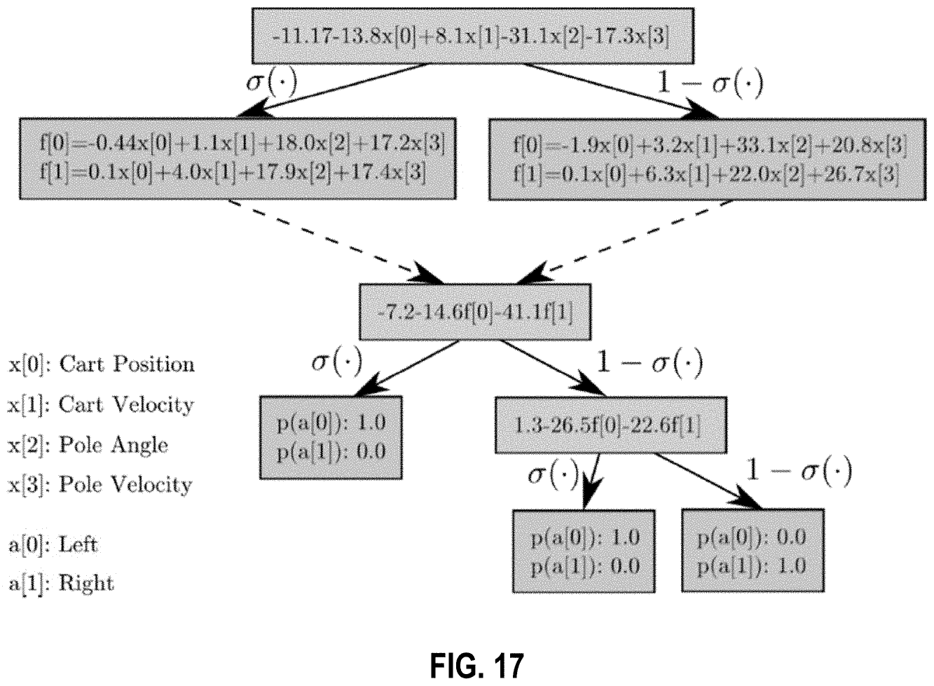

FIG. 16 and FIG. 17 show the visualization of learned SDT and CDT for imitating the behavior of a well-trained PPO policy on CartPole-v1 environment. The training data contains 10000 episodes collected by the PPO policy. FIG. 16 is a visualization of learned SDT (depth 3) for CartPole-v1.

FIG. 17 is a visualization of learned CDT (depth 1+2) for CartPole-v1: top is the feature learning tree, and bottom is the decision making tree.

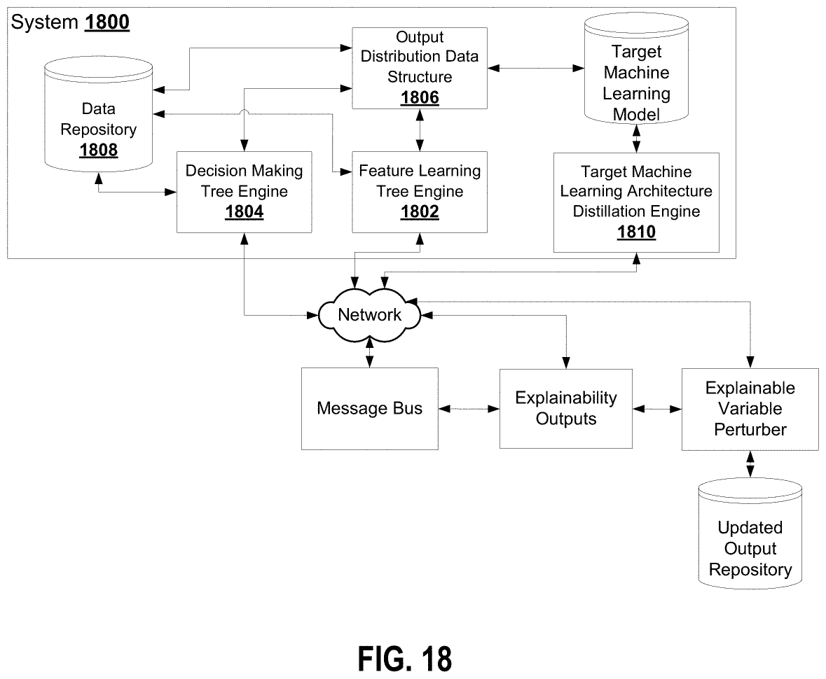

FIG. 18 is a block schematic of an example system adapted for instantiating the cascading differentiable tree data structure, according to some embodiments. The components of the system are shown as examples and can be implemented in different forms. Computerized implementation is contemplated in some embodiments, and system 1800 is a hardware computer system or implemented in the form of software for operation on a hardware computer system, such as being fixated as non-transitory computer readable media having corresponding machine interpretable instruction sets stored thereon.

The system 1800 includes a feature learning tree engine 1802 adapted to maintain a first set of decision tree machine learning architectures denoted as feature learning tree data structures, whereby each of the at least one feature learning tree data structure includes one or more decision nodes that represent the function ϕ(x; w) of raw features x given a set of parameters w and one or more leaf nodes that each represent an intermediate learned feature f based at least on a corresponding intermediate feature representation function ƒ=ƒ (x; \tilde{w}). The feature learning tree data engine 1802 is adapted for instantiating various types of feature learning tree data structures, and in some embodiments, a depth value can be tuned such that the balance between the feature learning trees and the decision making tree data structures can be adjusted. For example the depth value can be received as a parameter value to shift balance during operation.

In a variant embodiment, feature learning tree engine 1802 is adapted for maintain multiple feature learning trees F. These multiple feature learning trees F are coupled, structured, or arranged such that they operate in concert in providing leaf nodes. In a first embodiment, the feature learning tree engine 1802 can provide the trees F in a cascade (e.g., serial coupling). This can be useful in situations where the model being mimicked is very complex and the breaking down of the trees F into separate trees which are then sequentially coupled can help create explainability at each level. In a second embodiment, the feature learning tree engine 1802 can provide the trees F in a parallel approach. This can be useful in situations where model speed is important at the cost of computational resources (e.g., if there are many computational resources available). Various combinations thereof and permutations are possible. For example, there can be trees F in partial parallel/series connection. The balance (e.g., depth) between each of the trees F can be modified.

The system 1800 includes a decision making tree engine 1804 that is adapted to maintain a decision making tree data structure, which includes one or more decision nodes each representing a corresponding function ψ(ƒ; w′) of intermediate learned features f given parameters w′ from the feature representation functions of the feature learning tree data structure. New input data structures (data set x) can be provided to the system 1800 which processes the input data structures through feature learning tree data engine 1802 and decision making tree engine 1804 such that an output distribution data structure 1806 can be generated through traversal of the trees.

Traversal of the trees can include utilizing the feature learning trees to identify a set of candidate leaf nodes and to select a intermediate learned feature set from the set of candidate leaf nodes, which is then passed onto the decision making tree to generate the output distribution data structure.

Similarly, the depth values, in some embodiments, can be tuned such that the balance between the trees can be adjusted. The tree data structures can be stored on data repository 1808, which in some embodiments can be a relational database, a non-relational database, a data storage device, a set of data objects stored in linked lists, etc.

Because the trees utilize decision nodes, it is much easier to obtain explainability of the decision nodes and pathways, relative to latent spaces and interconnections of other types of machine learning architectures, such as deep neural networks. Decision nodes, can be based, in a simplified example, on linear relationships, and can include soft decisions (e.g., probabilistic decisions, such as 80% left/20% right) or discretized, binary decisions. Non-linear relationships can also be used in the decision nodes, at the cost of some of the explainability of the relationships (may be necessary in some cases in view of complexity and performance constraints).

The feature learning tree data engine 1802 and the decision making tree engine 1804 are instantiated such that the parameter weights of the various decision nodes are trained through tuning the weights to either mimic an existing target machine learning architecture (e.g., a target neural network that is not currently very explainable), or to mimic an existing set of decisions and their outcomes to establish a new overall tree structure relating to a desired model.

In a simple example, the system 1800 may be utilized to track gameplay of a game, where the output distribution data structure is directed to logits associated with controls of the game, and x is provided as inputs relating to various state information of the game such that the outputs are adapted to control the game sprite in conducting various actions in furtherance of a goal of winning the game or to maximize a score in the game. In this example, a deep learning reinforcement learning model was trained over 1,000,000 epochs. The deep learning reinforcement learning model achieves good performance in playing the game.

However, it is difficult to establish human-explainable reasons to understand why the game actions proposed/controlled by the deep learning reinforcement learning model are used. Human-explainable reasons can include, for example, time remaining on the game, how far the sprite is from the goal, the position of the sprite in respect of altitude, whether the sprite is in an enlarged state or a shrunken state, etc. A first target machine learning architecture distillation engine 1810 is adapted to interface with the target machine learning architecture to train the feature learning tree(s) and the decision learning tree.

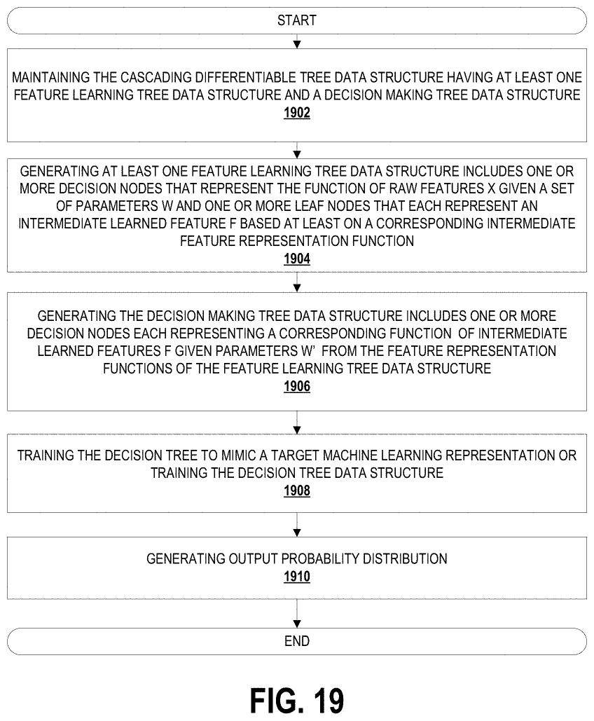

In FIG. 19, an example method 1900 is shown where the training includes attempting to mimic the outputs of deep learning reinforcement learning model in this example by tuning the specific weights of the feature learning tree(s) and the decision learning tree. At 1902, a CDT is maintained having at least a two-part structure that is coupled together and instantiated. At 1904, and 1906 the trees are generated having various depth levels for each of the trees. At 1908, over a number of training epochs, the learning architecture distillation engine 1810 causes shifts such that the output distributions are substantially similar for the same inputs, and an output probability distribution can be generated at step 1910.

After the system 1800 is trained such that the CDT data structure maps onto a target model, the CDT values themselves or parameters can then be used at 1910 to investigate the deep learning reinforcement learning model investigating the weights and the structure of the CDT—e.g., if the decision nodes of the CDT are more explainable (e.g., linear relationships), the co-efficients/parameter weights can be considered to understand human-explainable reasons to understand why the game actions proposed/controlled by the deep learning reinforcement learning model. For example, a movement is proposed because there is little time left on the game level.

In another embodiment, the CDT itself can be modified by system 1800 to perturb node weights on purpose, such that the CDT model is changed to test what happens when human explainable parameters shift. For example, if a game state is changed, or a sprite state is changed (e.g., what if the game sprite is in the shrunken state, or if the amount of time left is changed from 30 seconds to 45 seconds). In this case, the system 1800 can provide a new set of inputs and process them through the CDT data structure to generate an output distribution, which can include logits, normalized logits, etc., representative of a proposed action or control, which can then be analyzed or used to control an input mechanism (e.g., game controller button actuation).

Additional Experiments—Imitation Learning

Performance. The datasets for imitation learning are generated with heuristic agents for environments CartPole-v1 and LunarLander-v2, containing 10000 episodes of state-action data for each environments. The results are provided below at Tables 3 and 4.

TABLE 3
Comparison of CDT and SDT with imitation-learning settings
on CartPole-v1.

| Tree | | | Accuracy | | # of |
|---|---|---|---|---|---|
| Type | Depth | Discretized | (%) | Episode Reward | Params |
| SDT | 2 | X | 94.1 ± 0.01 | 500.0 ± 0.0 | 23 |
| | | ✓ | 49.7 ± 0.02 | 39.9 ± 7.6 | 14 |
| | 3 | X | 94.5 ± 0.1 | 500.0 ± 0.0 | 51 |
| | | ✓ | 50.0 ± 0.01 | 42.5 ± 7.3 | 30 |
| | 4 | X | 94.3 ± 0.3 | 500.0 ± 0.0 | 107 |
| | | ✓ | 50.1 ± 0.1 | 40.4 ± 7.7 | 62 |
| CDT | 1 + 2 | X | 95.4 ± 1.1 | 500.0 ± 0.0 | 38 |
| | | F only | 94.4 ± 0.8 | 500.0 ± 0.0 | 35 |
| | | D only | 84.1 ± 2.8 | 500.0 ± 0.0 | 35 |
| | | F + D | 83.8 ± 2.6 | 497.8 ± 8.4 | 32 |
| | 2 + 1 | X | 95.6 ± 0.1 | 500.0 ± 0.0 | 54 |
| | | F only | 92.7 ± 0.4 | 500.0 ± 0.0 | 45 |
| | | D only | 88.4 ± 1.3 | 500.0 ± 0.0 | 53 |
| | | F + D | 89.0 ± 0.4 | 500.0 ± 0.0 | 44 |
| | 2 + 2 | X | 96.6 ± 0.9 | 500.0 ± 0.0 | 64 |
| | | F only | 91.6 ± 1.3 | 500.0 ± 0.0 | 55 |
| | | D only | 82.9 ± 3.7 | 494.8 ± 19.8 | 61 |
| | | F + D | 81.9 ± 1.8 | 488.8 ± 31.4 | 52 |

CDTs perform consistently better than SDTs before and after discretization process in terms of prediction accuracy, with different depths of the tree. Additionally, for providing a similarly accurate model, CDT method always has a much smaller number of parameters compared with SDT, which improves its interpretability as shown in later sections. However, although better than SDTs, CDTs also suffer from degradation in performance after discretization, which could lead to unstable and unexpected models. Applicants claim that this is a general drawback for tree-based methods with soft decision boundaries in XRL with imitation-learning settings.

TABLE 4
Comparison of CDT and SDT with imitation-learning settings
on LunarLander-v2.

| Tree | | | Accuracy | | # of |
|---|---|---|---|---|---|
| Type | Depth | Discretized | (%) | Episode Reward | Params |
| SDT | 4 | X | 85.4 ± 0.4 | 58.2 ± 246.1 | 199 |
| | | ✓ | 54.8 ± 10.1 | −237.1 ± 121.9 | 94 |
| | 5 | X | 87.6 ± 0.5 | 191.3 ± 143.8 | 407 |
| | | ✓ | 51.6 ± 4.5 | −93.7 ± 102.9 | 190 |
| | 6 | X | 88.7 ± 1.3 | 193.4 ± 161.4 | 823 |
| | | ✓ | 60.2 ± 3.9 | −172.4 ± 122.0 | 382 |
| | 7 | X | 88.9 ± 0.5 | 194.2 ± 138.8 | 1655 |
| | | ✓ | 62.7 ± 2.8 | −233.4 ± 62.4 | 766 |
| CDT | 2 + 2 | X | 88.2 ± 1.6 | 107.4 ± 190.7 | 116 |
| | | F only | 78.0 ± 2.4 | −126.9 ± 237.0 | 95 |
| | | D only | 68.3 ± 10.3 | −301.6 ± 136.8 | 113 |
| | | F + D | 64.4 ± 12.1 | −229.7 ± 256.0 | 92 |
| | 2 + 3 | X | 88.3 ± 1.7 | 168.5 ± 169.0 | 144 |
| | | F only | 70.2 ± 2.3 | −9.7 ± 159.2 | 123 |
| | | D only | 40.7 ± 11.9 | −106.3 ± 187.7 | 137 |
| | | F + D | 35.9 ± 1.5 | −130.2 ± 135.9 | 116 |
| | 3 + 2 | X | 90.4 ± 1.7 | 199.5 ± 123.7 | 216 |
| | | F only | 72.2 ± 8.3 | −14.2 ± 175.6 | 167 |
| | | D only | 78.1 ± 2.5 | 150.8 ± 148.1 | 209 |
| | | F + D | 64.6 ± 4.7 | 7.1 ± 173.6 | 160 |
| | 3 + 3 | X | 90.4 ± 1.2 | 173.0 ± 124.5 | 224 |
| | | F only | 72.0 ± 1.2 | −55.3 ± 178.6 | 195 |
| | | D only | 58.7 ± 8.6 | −91.5 ± 97.0 | 237 |
| | | F + D | 46.8 ± 5.6 | −210.5 ± 121.9 | 188 |

Stability. To investigate the stability of imitation learners for interpreting the original agents, Applicants measure the normalized weight vectors from different imitation-learning trees. For SDTs, the weight vectors are the linear weights on inner nodes, while for CDTs {\tilde{w}, \tilde{w}′} are considered. Through the experiments, the approach is to show how unstable the imitators {L} are. There is a tree agent X∈{V, H, R}, where L′ is another imitator tree agent trained under the same setting, R is a random tree agent, and H is a heuristic tree agent (used for generating the training dataset). The distances of tree weights between two agents L, X are calculated with the following formula:

$$D ( L , X ) = \frac{1}{2 N} {\sum }_{n = 1}^{N} {min}_{m = 1 , 2 , … , M} {‖ {l}_{m} - {x}_{n} ‖}_{1} + \frac{1}{2 M} {\sum }_{m = 1}^{M} {min}_{m = 1 , 2 , … , N} {‖ {x}_{m} - {l}_{n} ‖}_{1}$$

while D̅(̅L̅,̅ X̅)̅ are averaged over all possible Ls and Xs with the same setting. Since there is the heuristic agent for LunarLander-v2 environment and Applicants transform the heuristic agent into a multivariate DT agent, Applicants get the decision boundaries of the tree on all its nodes. So Applicants also compare the differences of decision boundaries in heuristic tree agent H and those of the learned tree agent L. But Applicants do not have the official heuristic agent for CartPole-v1 in the form of a decision tree. For the decision making trees in CDTs, Applicants transform the weights back into the input feature space to make a fair comparison with SDT and the heuristic tree agent. The results are displayed in Table 5, all trees use intermediate features of dimension 2 for both environments. In terms of stability, CDTs generally perform similarly as SDTs and even better on CartPole-v1 environment.

TABLE 5
Tree Stability Analysis. D̅(̅L̅,̅ L̅′̅)̅, D̅(̅L̅,̅ R̅)̅ and D̅(̅L̅,̅ H̅)̅ are average
values of distance between an imitator L and another imitator L′,
or a random agent R, or a heuristic agent H with metric D. CDTs
are generally more stable, but still with large variances over
different imitators.

| Tree | | | | | |
|---|---|---|---|---|---|
| Type | Env | Depth | D̅(̅L̅,̅ L̅′̅)̅ | D̅ (̅L̅,̅ R̅)̅ | D̅ (̅L̅,̅ H̅)̅ |
| SDT | CartPole-v1 | 3 | 0.21 | 0.90 ± 0.10 | — |
| | LunarLander-v2 | 4 | 0.50 | 0.92 ± 0.05 | 0.84 |
| CDT | CartPole-v1 | 1 + 2 | 0.07 | 1.05 ± 0.15 | — |
| | | 2 + 2 | 0.19 | 1.03 ± 0.10 | — |
| | LunarLander-v2 | 2 + 2 | 0.63 | 1.01 ± 0.10 | 0.98 |
| | | 3 + 3 | 0.53 | 0.83 ± 0.06 | 0.86 |

Applicants further evaluate the feature importance with at least two different methods on SDTs to demonstrate the instability of imitation learning settings for XRL. Applicants also display all trees (CDTs and SDTs) for both environments. Significant differences can be found in different runs for the same tree structure with the same training setting, which testifies the unstable and unrepeatable nature by interpreting imitators instead of the original agents.

Applicants claim that the current imitation-learning setting with tree-based models is not suitable for interpreting the original RL agent, with the following evidence derived from the experiments: (i) The discretization process usually degrades the performance (prediction accuracy) of the agent significantly, especially for SDTs. Although CDTs alleviate the problem to a certain extent, the performance degradation is still not negligible, therefore the imitators are not expected to be alternatives for interpreting the original agents; (ii) With the stability analysis in the experiments, Applicants find that different imitators will display different tree structures even if they follow the same training setting on the same dataset, which leads to significantly different decision paths and local feature importance assignments.

Reinforcement Learning

Performance. Applicants evaluate the learning performances of different DTs and NNs as policy function approximators in RL. Every setting is trained for three runs. Applicants use Proximal Policy Optimization algorithm in the experiments. The multilayer perceptron (MLP) model is a two-layer NN with 128 hidden units. The SDT has a depth of 3 for CartPole-v1 and 4 for LunarLander-v2. The CDT has depths of 2 and 2 for feature learning tree and decision making tree respectively on CartPole-v1, while with depths of 3 and 3 for LunarLander-v2. Therefore for each environment, the SDTs and CDTs have a similar number of model parameters, while MLP model has at least 6 times more parameters.

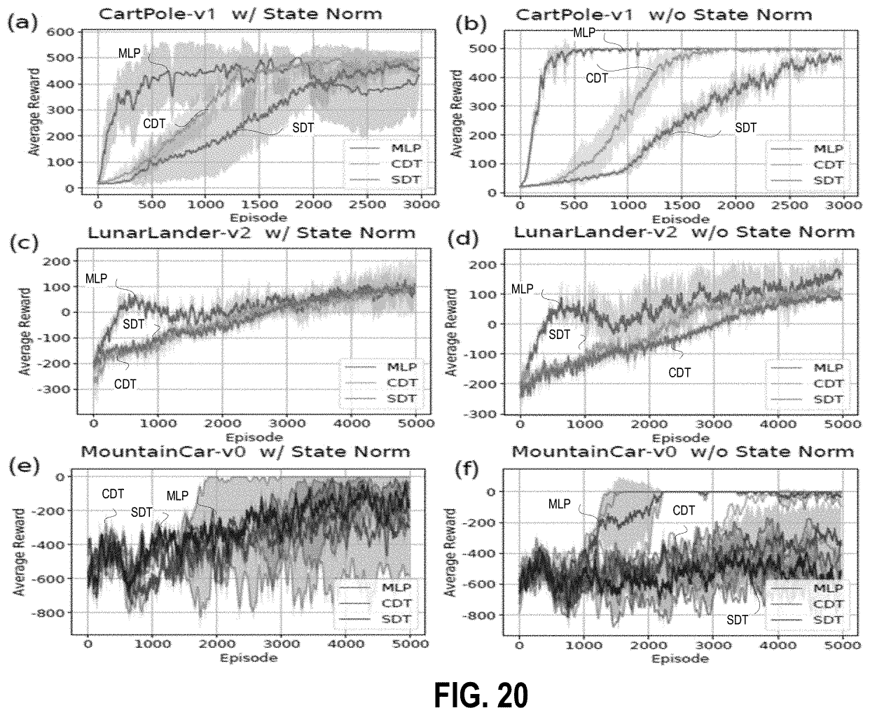

From FIG. 20 at graphs (a)-(f), Applicants can observe that CDTs can at least outperform SDTs as policy function approximators for RL in terms of both sampling efficiency and final performance, although may not learn as fast as general MLPs with a significantly larger number of parameters. FIG. 20 shows a comparison of SDTs and CDTs on three environments in terms of average rewards in RL setting: (a)(c)(e) use normalized input states while (b)(d)(f) use unnormalized ones.

For MountainCar-v0 environment, the MLP model has two layers with 32 hidden units. The depth of SDT is 3. CDT has depths 2 and 2 for the feature learning tree and decision making tree respectively, with the dimension of the intermediate feature as 1. The learning performances are less stable due to the sparse reward signals and large variances in exploration. However, with CDT for policy function approximation, there are still near-optimal agents after training with or without state normalization.

Tree Depth. The depths of DTs are also investigated for both SDT and CDT, because deeper trees tend to have more model parameters and therefore lay more stress on the accuracy rather than interpretability.

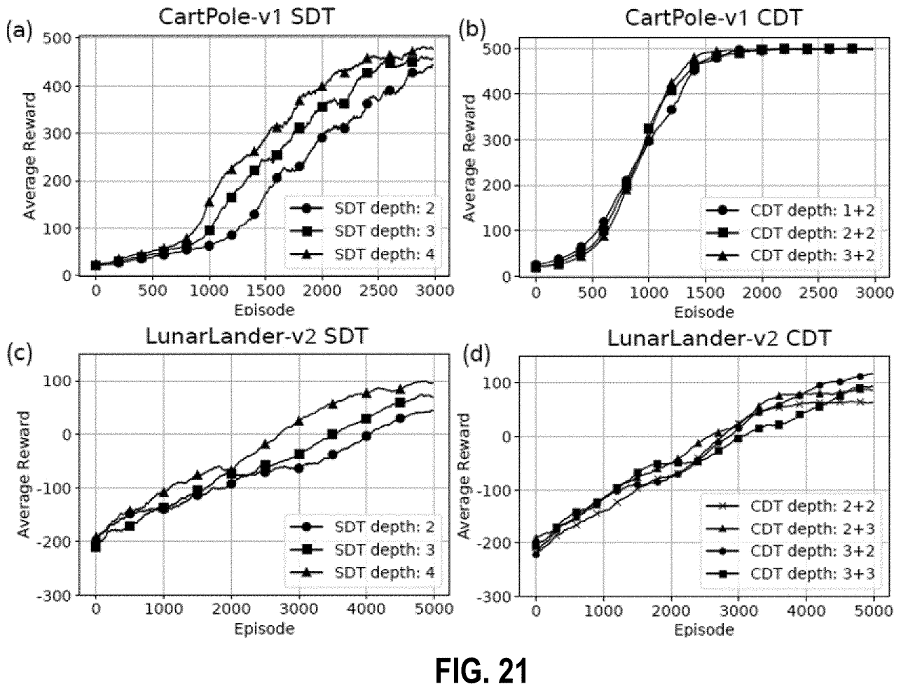

FIG. 21 is a comparison of SDTs and CDTs with different depths (state normalized). (a) and (b) are trained on CartPole-v1, while (c) and (d) are on LunarLander-v2., showing the learning curves of SDTs and CDTs in RL with different tree depths for the two environments, using normalized states as input. From the comparisons, Applicants can observe that generally deeper trees can learn faster with even better final performances for both CDTs and SDTs, but CDTs are less sensitive to tree depth than SDTs.

Interpretability. Applicants display the learned CDTs in RL settings for three environments, compared against some heuristic solutions or SDTs. A heuristic solution¹ for CartPole-v1 is: if 3θ+\dot{θ}>0, push right; otherwise, push left. As shown in the CartPole example of FIG. 11, in the learned CDT of depth 1+2, the weights of two-dimensional intermediate features (ƒ[0] and ƒ[1]) are much larger on the last two dimensions of observation than the first two, therefore Applicants can approximately ignore the first two dimensions due to their low importance in decision making process. So Applicants get similar intermediate features for two cases in two dimensions, which are approximately w₁x[2]+w₂x[3]→wθ+\dot{θ} after normalization (w>0). Based on the decision making tree in learned CDT, it gives a close solution as the heuristic one, yielding if wθ+\dot{θ}<0 push left otherwise push right. ¹Provided by Zhiqing Xiao on OpenAI Gym Leaderboard: https://github.com/openai/gym/wiki/Leaderboard

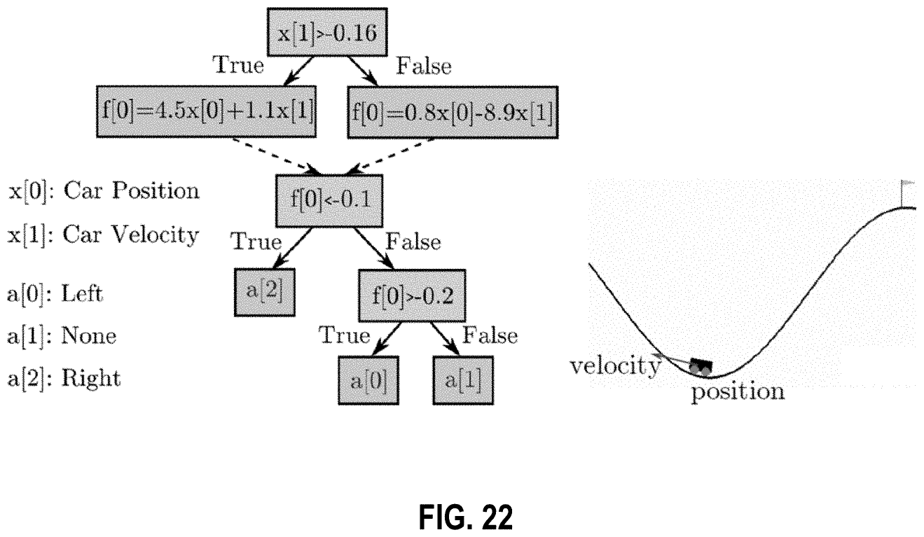

For MountainCar-v0, due to the complexity in the landscape as shown in FIG. 22, interpreting the learned model is even harder. In FIG. 22, on the left, learned CDT (after discretization) is shown, and on the right, a game scene of MountainCar-v0 is shown.

Through CDT, Applicants can see that the agent learns intermediate features as combinations of car position and velocity, potentially being an estimated future position or previous position, and makes action decisions based on that. The original CDT before discretization has depth 2+2 with one-dimensional intermediate features, and its structure is shown in Appendix G.

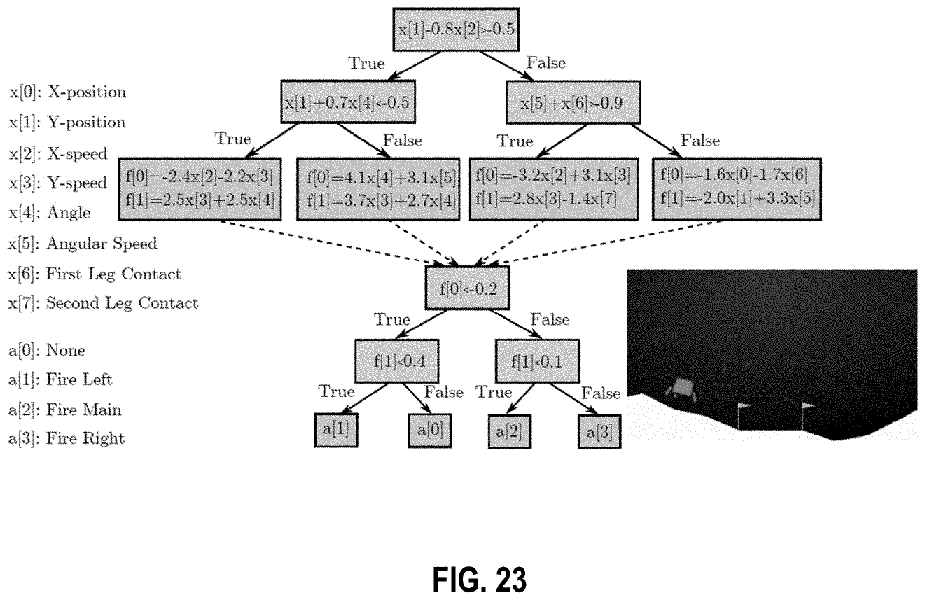

For LunarLander-v2, as in FIG. 23, the learned CDT agent captures some important feature combinations like the angle with angular speed and X-Y coordinate relationships for decision making. FIG. 23 shows the learned CDT (after discretization) for LunarLander-v2 with game scene at the right bottom corner.

### APPENDIX

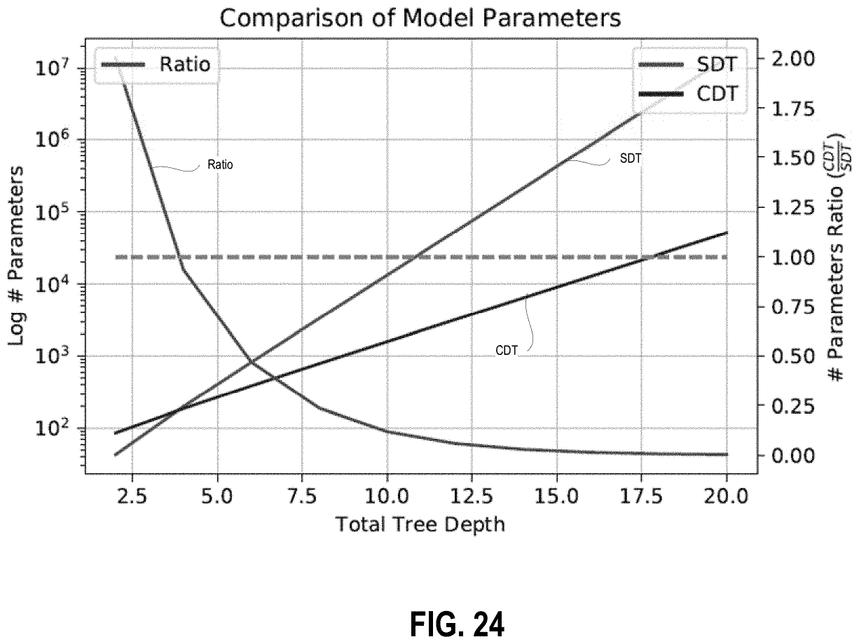

FIG. 24 is a graph showing a comparison of numbers of model parameters in CDTs and SDTs. The left vertical axis is the number of model parameters in log-scale. The right vertical axis is the ratio of model parameter numbers. CDT has a decreasing ratio of model parameters against SDT as the total depth of model increases.

The hyperparameters used in imitation learning are provided in Table 6, below.

TABLE 6
Imitation learning hyperparameters. The “Common”
hyperparameters are shared for both SDT and CDT.

| Tree Type | Env | Hyperparameter | Value |
|---|---|---|---|
| Common | CartPole-v-1 | learning rate | 1 × 10⁻³ |
| | | batch size | 1280 |
| | | epochs | 80 |
| | LunarLander-v2 | learning rate | 1 × 10⁻³ |
| | | batch size | 1280 |
| | | epochs | 80 |
| SDT | Cart Pole-v1 | depth | 3 |
| | LunarLander-v2 | depth | 4 |
| CDT | CartPole-v1 | FL depth | 2 |
| | | DM depth | 2 |
| | | # intermediate variables | 2 |
| | LunarLander-v2 | FL depth | 3 |
| | | DM depth | 3 |
| | | # intermediate variables | 2 |

Additional Imitation Learning Results For Stability Analysis: Both the fidelity and stability of mimic models reflect the reliability of them as interpretable models. Fidelity is the accuracy of the mimic model, w.r.t. the original model. It is an estimation of similarity between the mimic model and the original one in terms of prediction results. However, fidelity is not sufficient for reliable interpretations. An unstable family of mimic models will lead to inconsistent explanations of original black-box models. The stability of the mimic model is a deeper excavation into the model itself and comparisons among several runs. Previous research has investigated the fidelity and stability of decision trees as mimic models, where the stability is estimated with the fraction of equivalent nodes in different random decision trees trained under the same settings. However, in the tests, apart from evaluating the tree weights in different imitators, Applicants also use the feature importance given by different differentiable DT instances with the same architecture and training setting to measure the stability.

Results of Feature Importance in Imitation Learning

To testify the stability of applying SDT method with imitation learning from a given agent, Applicants compare the SDT agents of different runs and original agents using certain metrics. The agent to be imitated from is a heuristic decision tree (HDT) agent, and the metric for evaluation is the assigned feature importance across an episode on each feature dimension. As described in the previous section, the feature importance for local explanation can be achieved in three ways, which work for both HDT and SDT here. The environment is LunarLander-v2 with an 8-dimensional observation in the experiments here.

Considering SDT of different runs may predict different actions, even if they are trained with the same setting and for a considerable time to achieve similarly high accuracies, Applicants conduct comparisons not only for an online decision process during one episode, but also on a pre-collected offline state dataset by the HDT agent. Applicants hope this can alleviate the accumulating differences in trajectories caused by consecutively different actions made by different agents, and give a more fair comparison on the decision process (or feature importance) for the same trajectory.

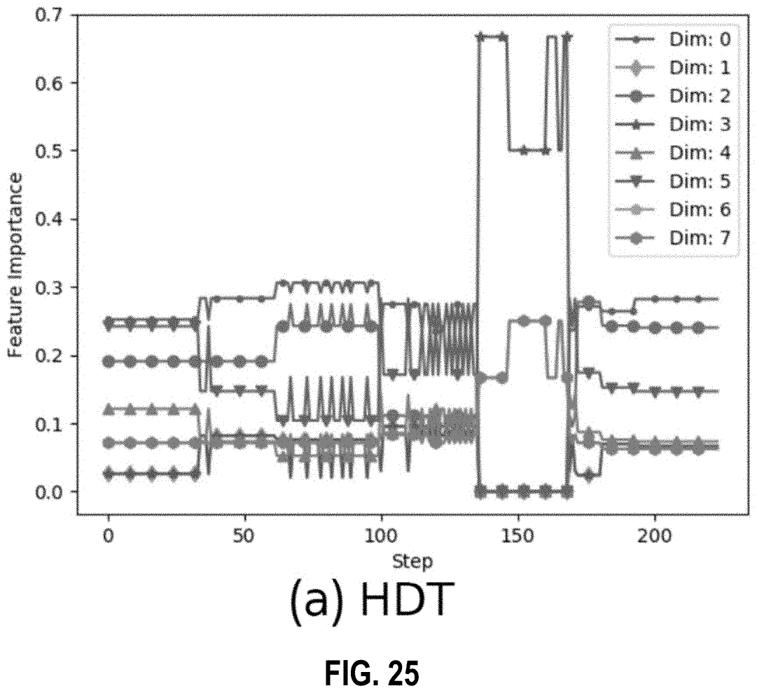

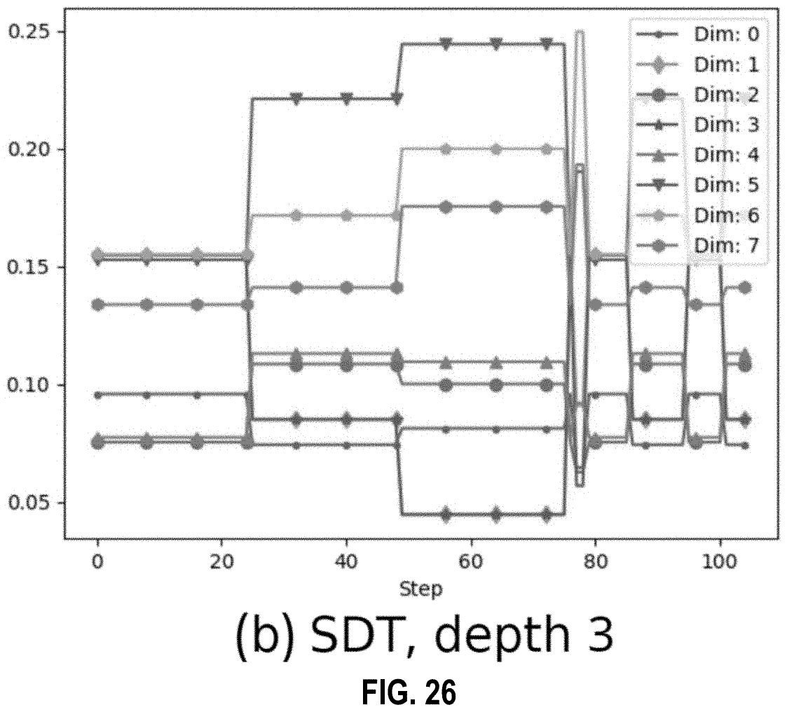

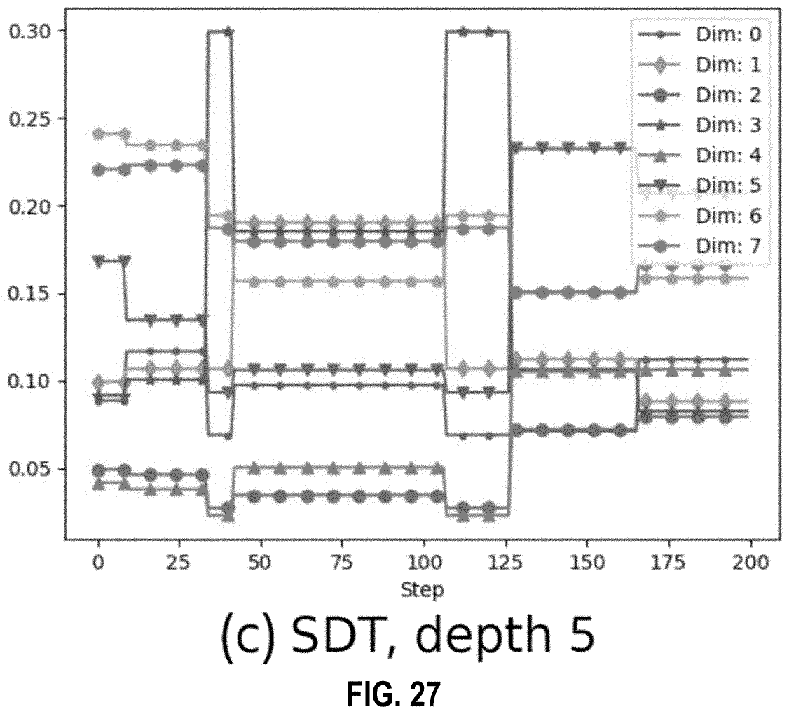

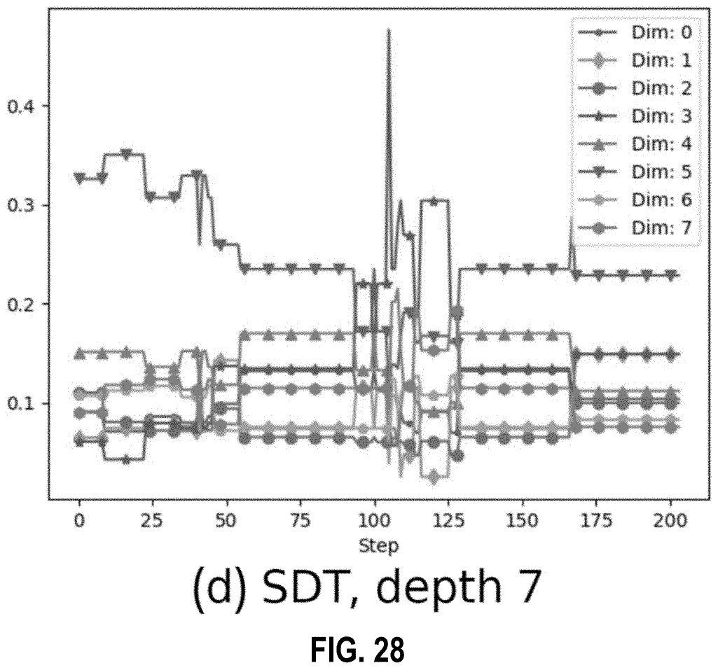

Different Tree Depths. First, the comparison of feature importance (adding up node weights on decision path) for HDT and the learned SDT of different depths in an online decision episode is shown as FIGS. 25-28. All SDT agents are trained for 40 epochs to convergence. The accuracies of three trees are 87.35%, 95.23%, 97.50%, respectively.

FIGS. 25-28 are graphs showing comparison of feature importance (local explanation 1) for SDT of depth 3, 5, 7 with HDT on an episodic decision making process.

From FIGS. 25-28, Applicants can observe significant differences among SDTs with different depths, as well as in comparing them against the HDT even on the episode with the same random seed, which indicates that the depth of SDT will not only affect the model prediction accuracy but also the decision making process.

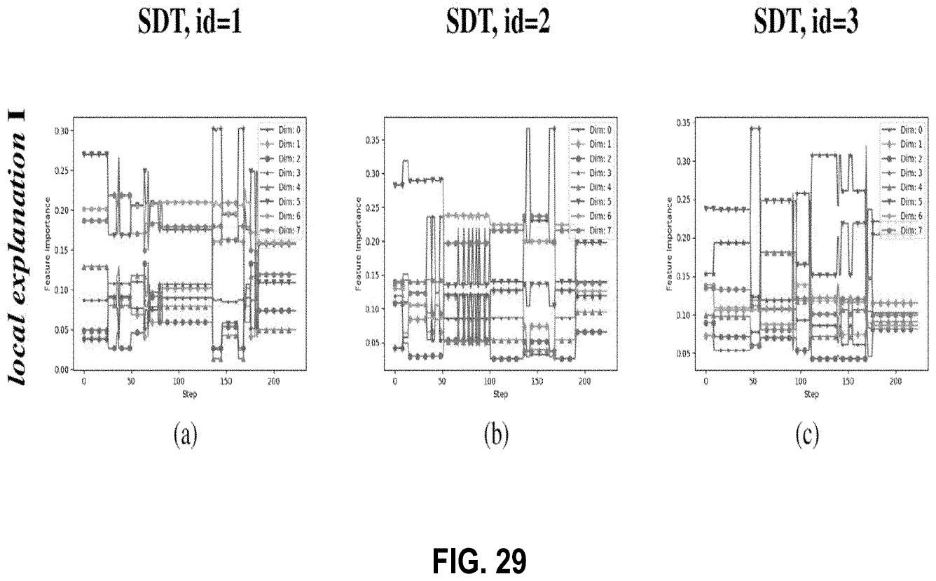

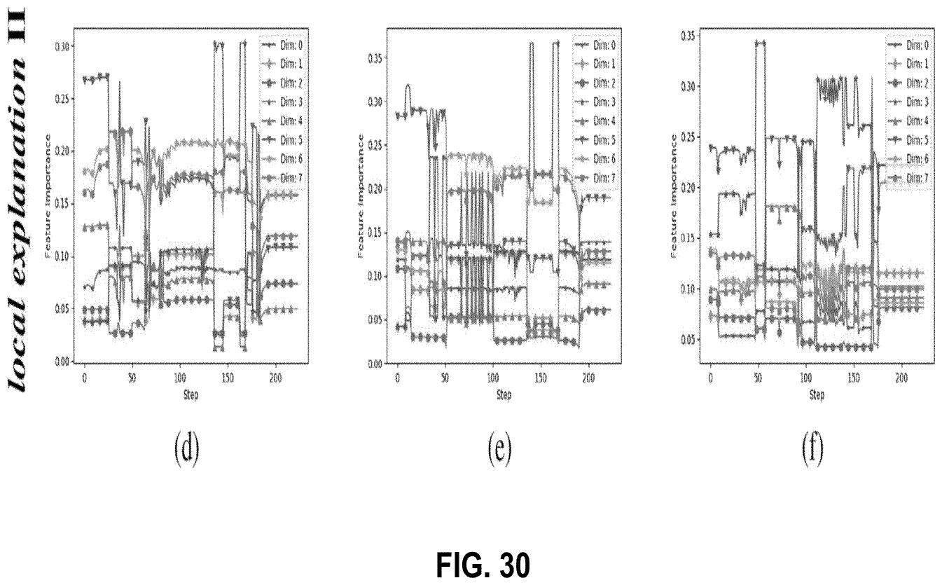

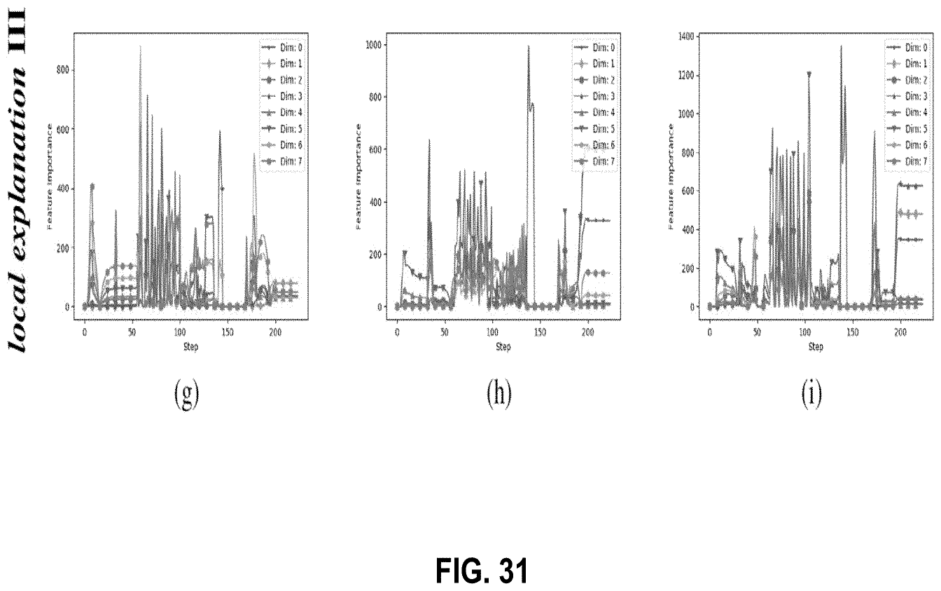

Same Tree with Different Runs. Applicants compare the feature importance on an offline dataset, containing the states of the HDT agent encounters in one episode. All SDT agents have a depth of 5 and are trained for 80 epochs to convergence. The three agents have testing accuracies of 95.88%, 97.93%, and 97.79% respectively after training. The feature importance values are evaluated with different approaches as mentioned above (local explanation 1, 2 and 3) on the same offline episode, as shown in FIGS. 29-31. FIGS. 29-31 provide a comparison of feature importance for three SDTs (depth=5, trained under the same setting) with three different local explanations. All runs are conducted on the same offline episode. In the results, local explanation II and III looks similar, since most decision nodes in the decision path with greatest probability have the probability values close to 1 (i.e. close to a hard decision boundary) when going to the child nodes. From FIGS. 29-31, considerable differences can also be spotted in different runs for local explanations, even though the SDTs have similar prediction accuracies, no matter which metric is applied.

Tree Structures in Imitation Learning

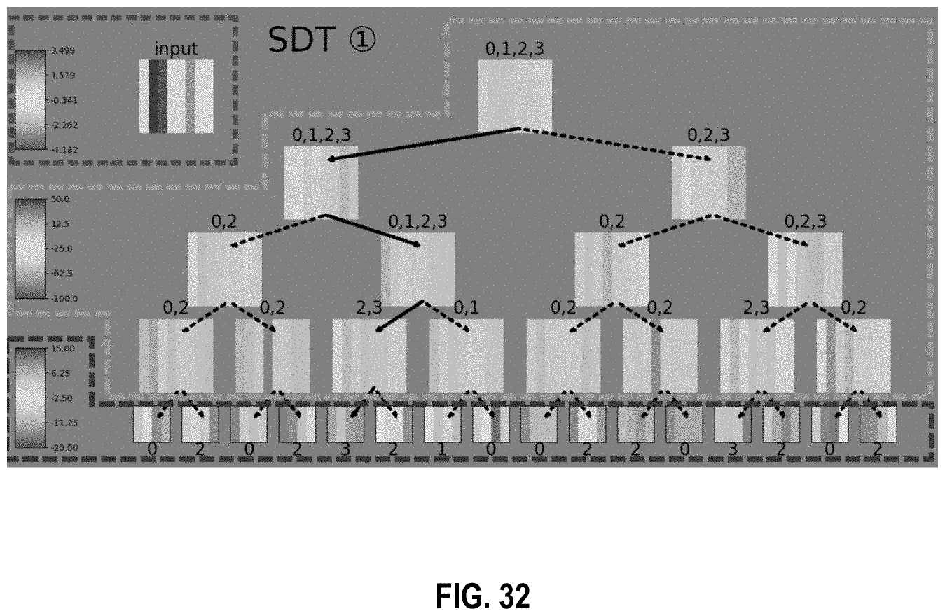

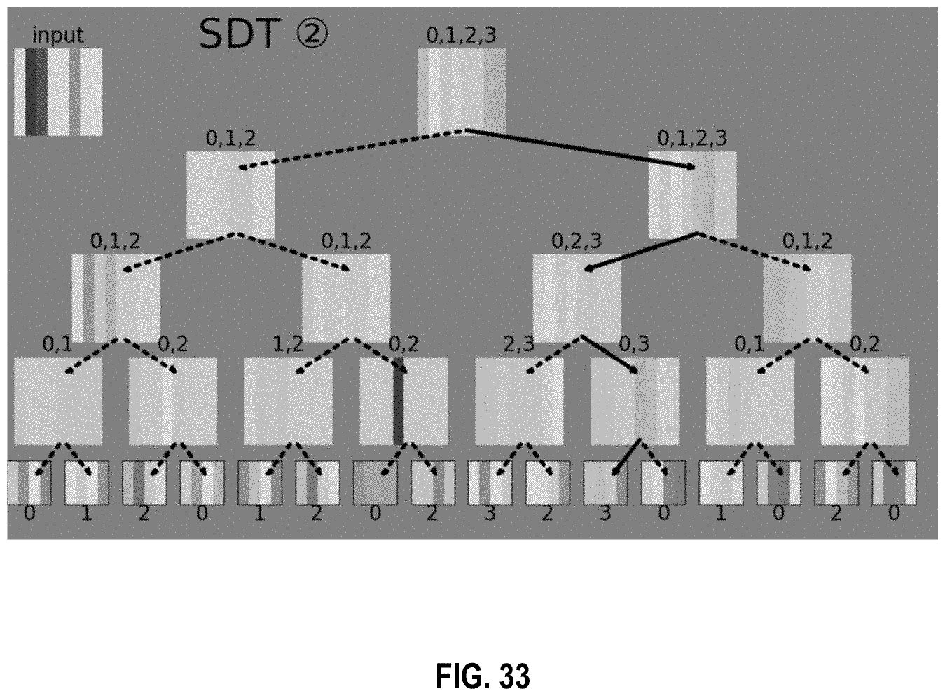

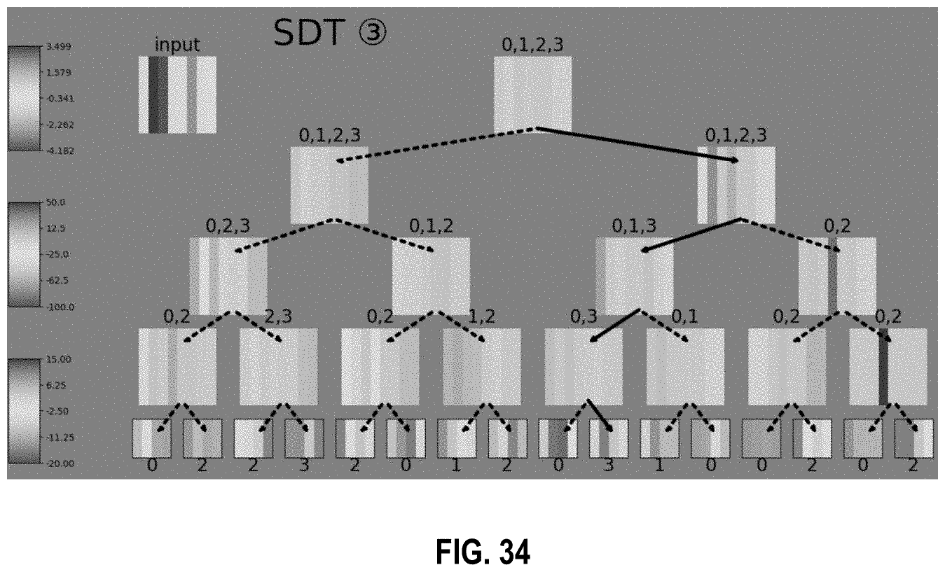

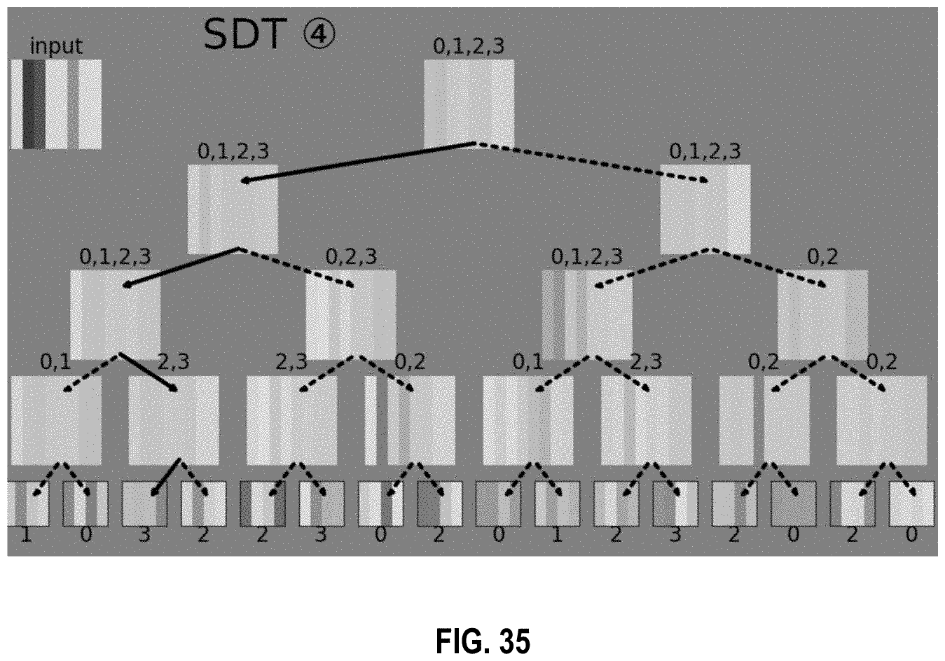

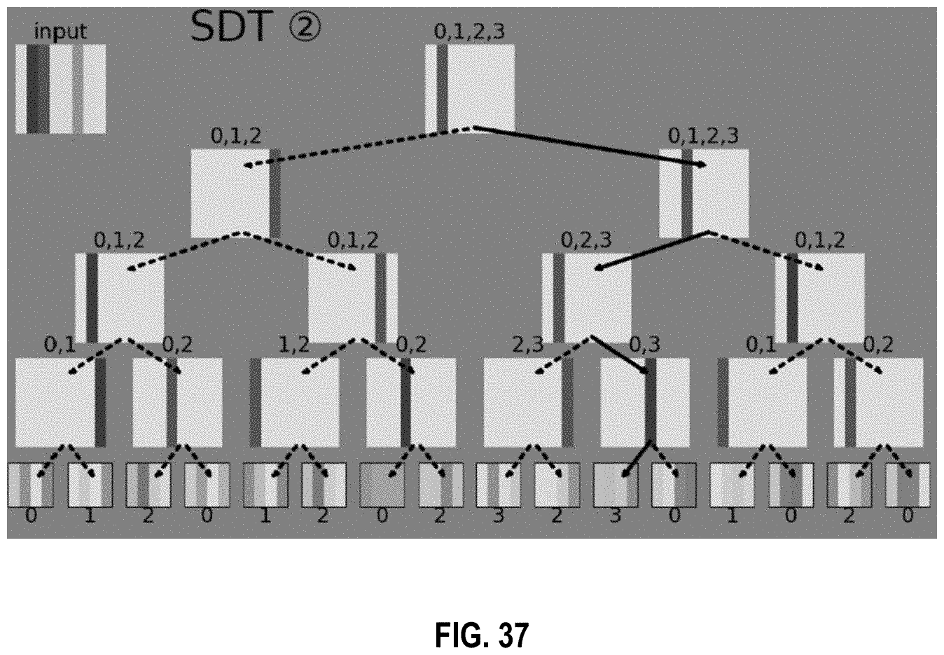

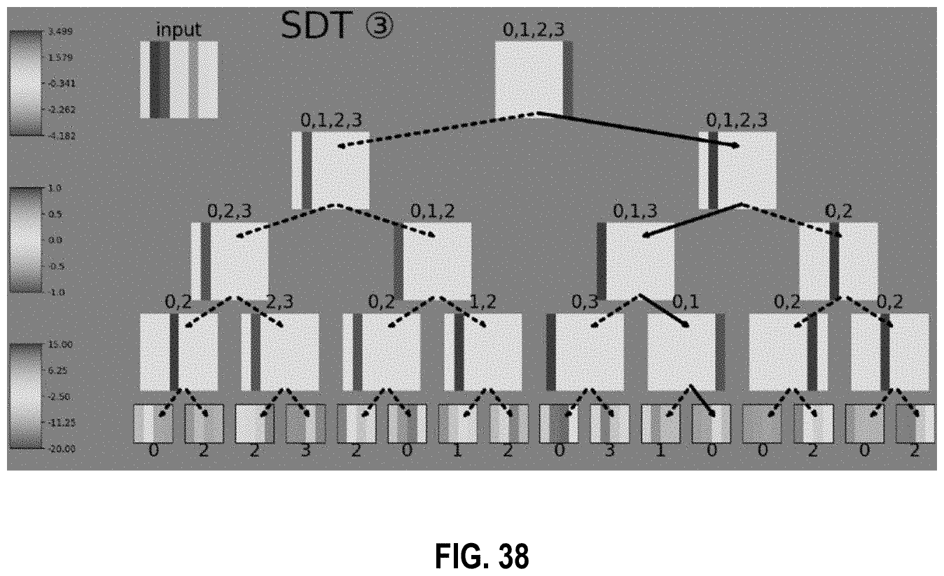

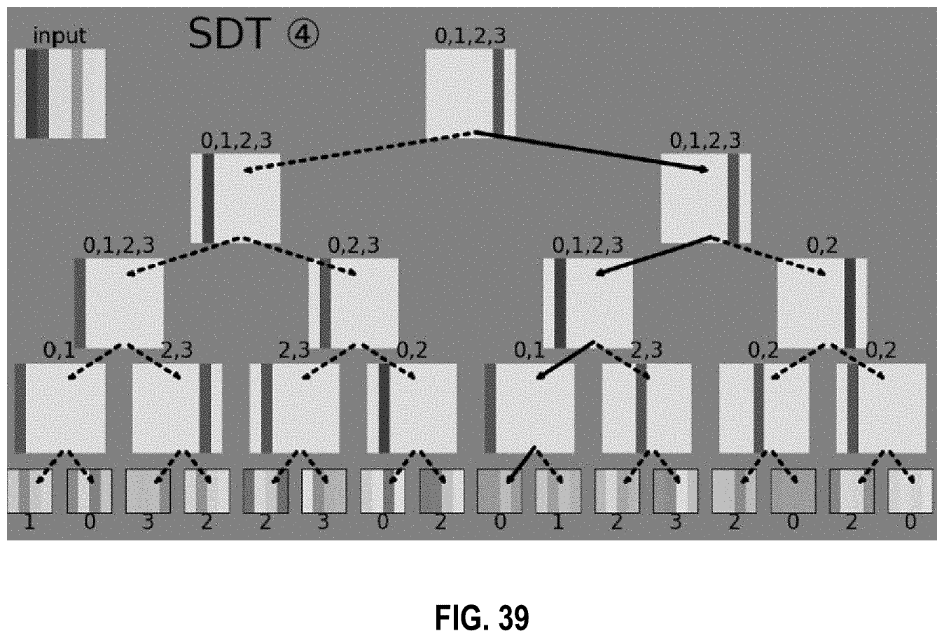

Applicants display the agents trained with CDTs and SDTs on both CartPole-v1 and LunarLander-v2 before and after tree discretization in this section, as in FIG. 32-49.

Each example figure shows trees trained in four runs with the same setting.

Each sub-figure contains one learned tree (plus an input example and its output) with an inference path (i.e., the solid lines) for the same input instance. The lines and arrows indicate the connections among tree nodes.

The colors (shown as gradients if being considered in black and white) of the squares on tree nodes show the values of weight vectors for each node. For feature learning trees in CDTs, the leaf nodes are colored with the feature coefficients. The output leaf nodes of both SDTs and decision making trees in CDTs are colored with the output categorical distributions. Three gradient (color) bars are displayed on the left side for inputs, tree inner nodes, and output leaves respectively, as demonstrated in FIGS. 32-35. FIGS. 32-35 are outputs showing a comparison of four runs with the same setting for SDT (before discretization) imitation learning on LunarLander-v2. The dashed lines with different colors on the left top diagram indicate the valid regions for each color bar, which is the default setting for the rest diagrams.

It remains the same for the rest tree plots. The digits on top of each node represent the output action categories.

Among all the learned tree structures, significant differences can be told from weight vectors, as well as intermediate features in CDTs, even if the four trees are under the same training setting. This will lead to considerably different explanations or feature importance assignments on trees.

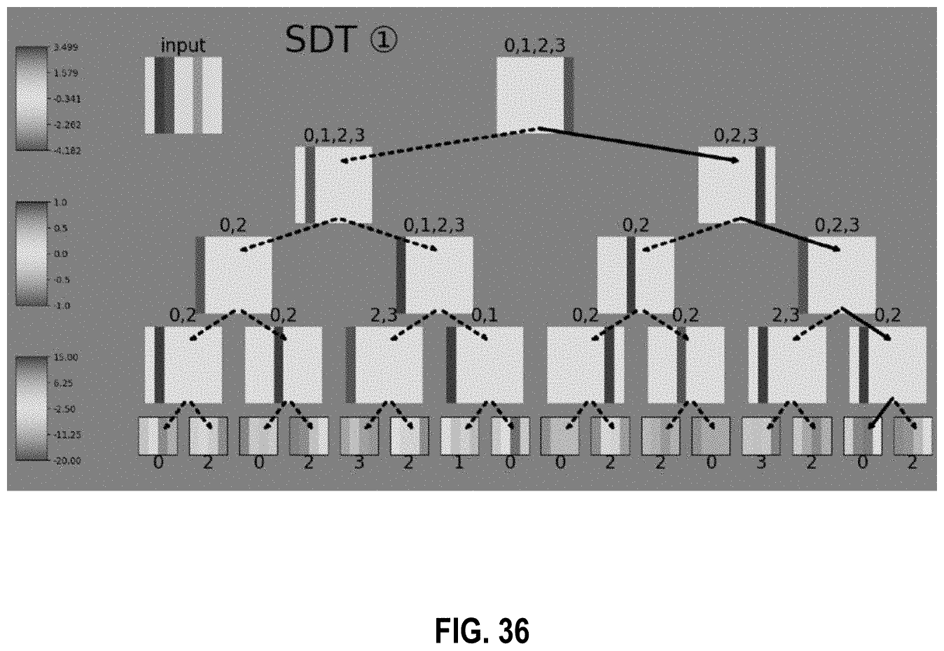

FIGS. 36-39 show comparisons of four runs with the same setting for SDT (after discretization) imitation learning on LunarLander-v2.

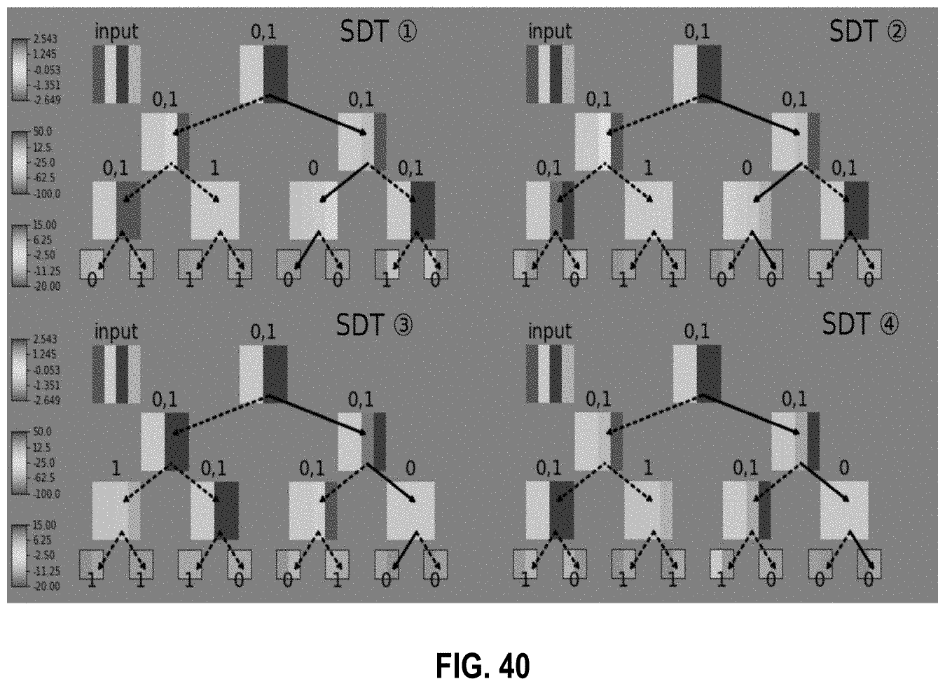

FIG. 40 shows comparisons of four runs with the same setting for SDT (before discretization) imitation learning on CartPole-v1.

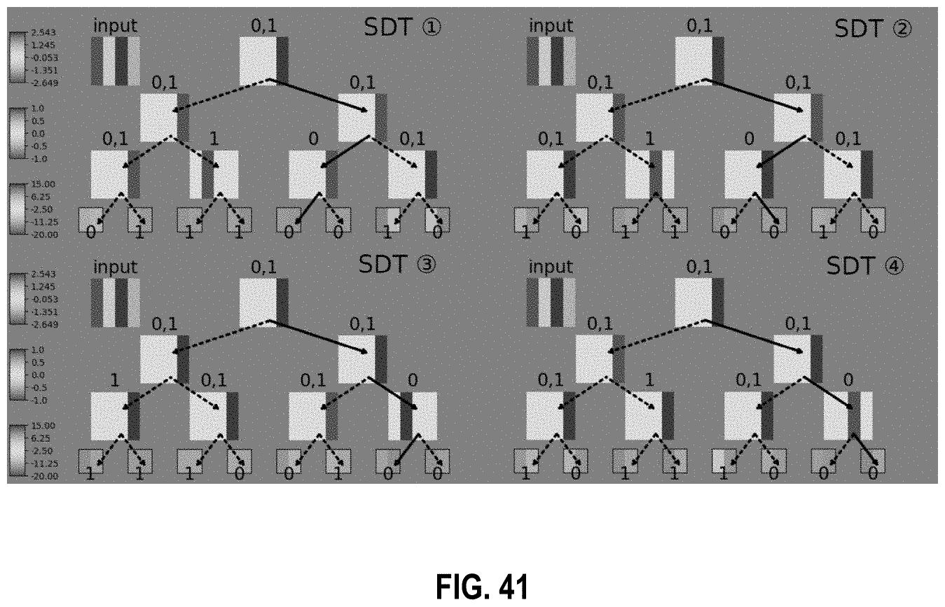

FIG. 41 shows comparisons of four runs with the same setting for SDT (after discretization) imitation learning on CartPole-v1.

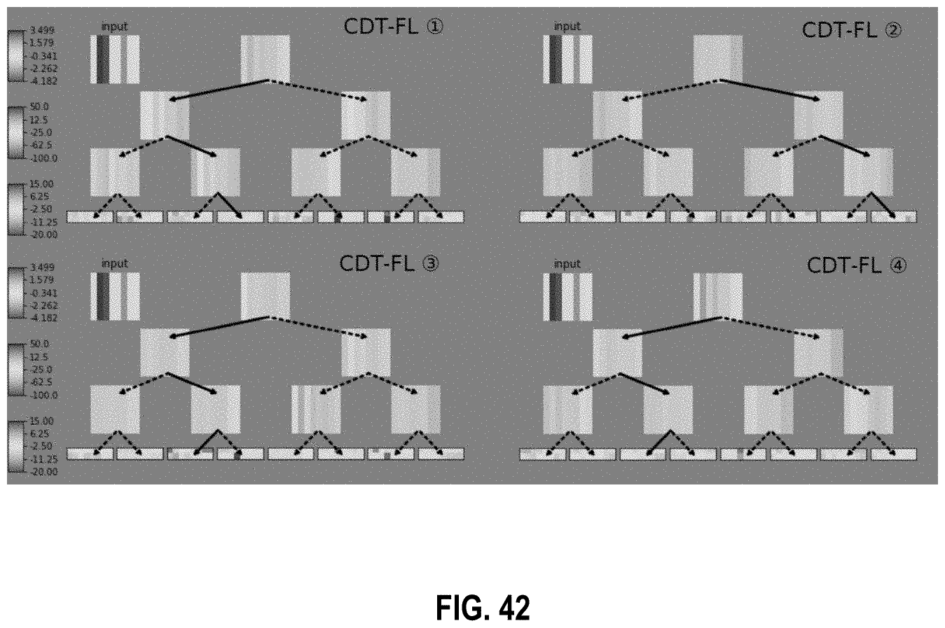

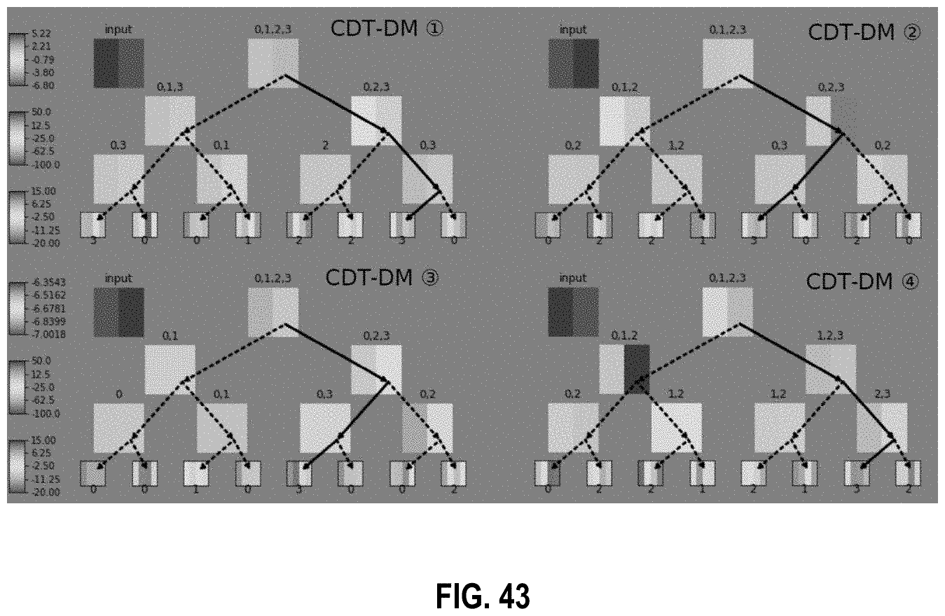

FIG. 42, FIG. 43 shows comparisons of four runs with the same setting for CDT (before discretization) imitation learning on LunarLander-v2: feature learning trees (FIG. 42) and decision making trees (FIG. 43).

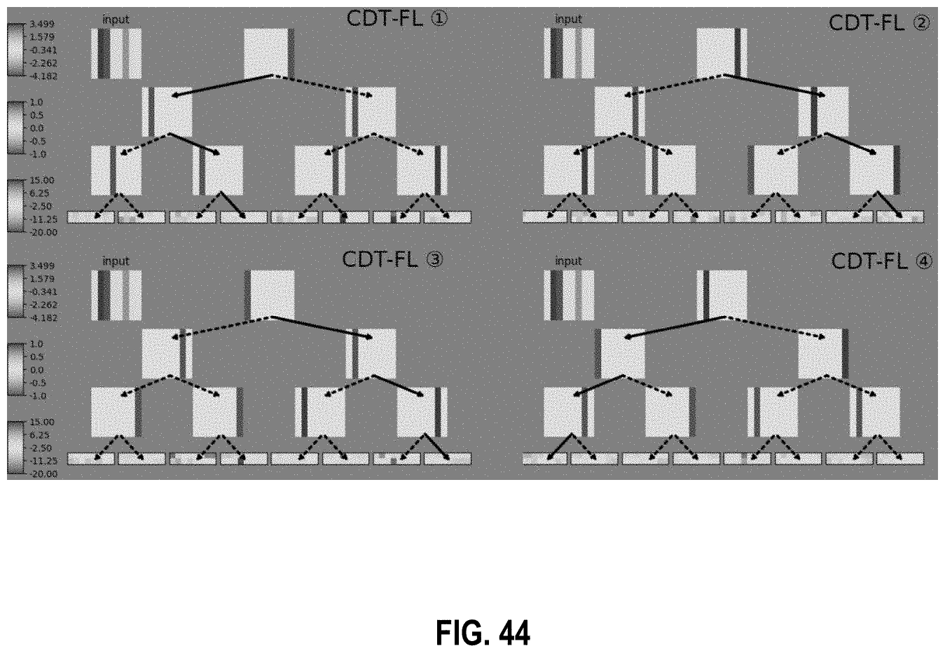

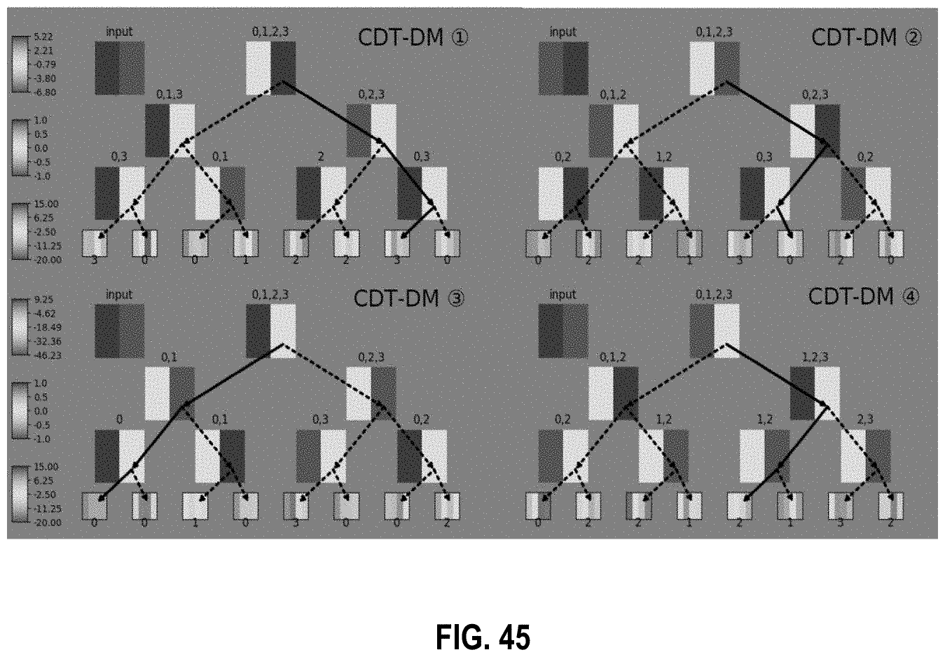

FIG. 44, FIG. 45 shows comparison of four runs with the same setting for CDT (after discretization) imitation learning on LunarLander-v2: feature learning trees (FIG. 44) and decision making trees (FIG. 45).

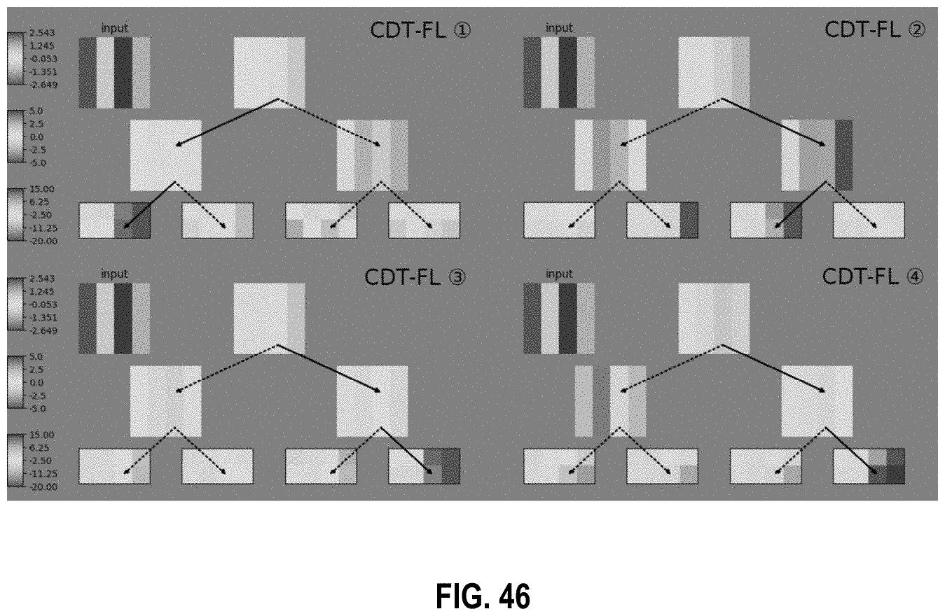

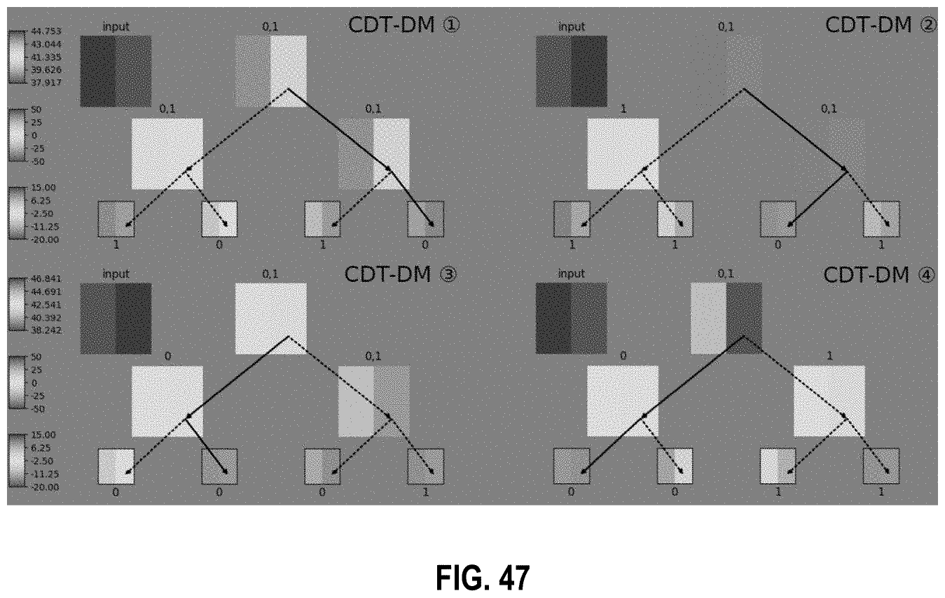

FIG. 46, FIG. 47 shows comparison of four runs with the same setting for CDT (before discretization) imitation learning on CartPole-v1: feature learning trees (FIG. 46) and decision making trees (FIG. 47).

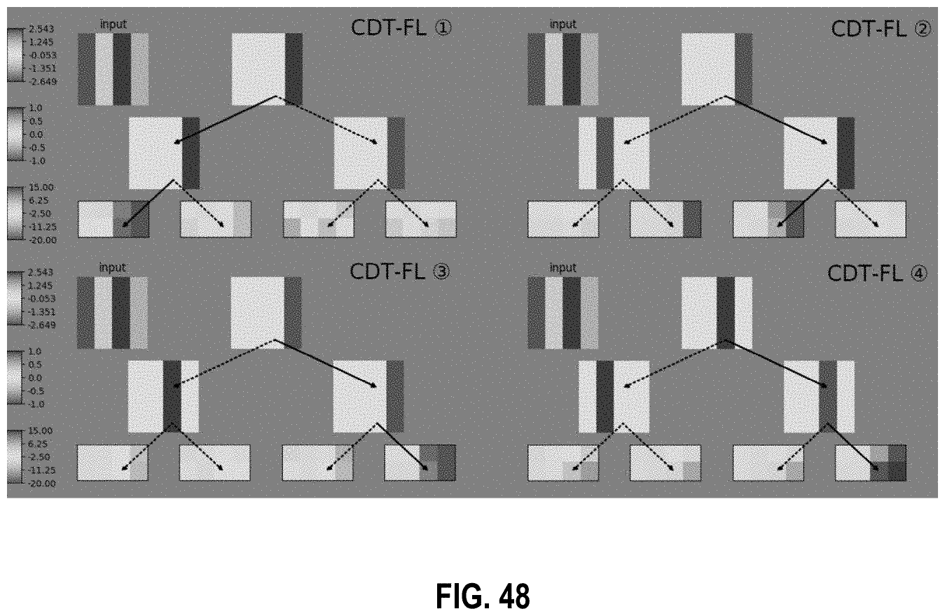

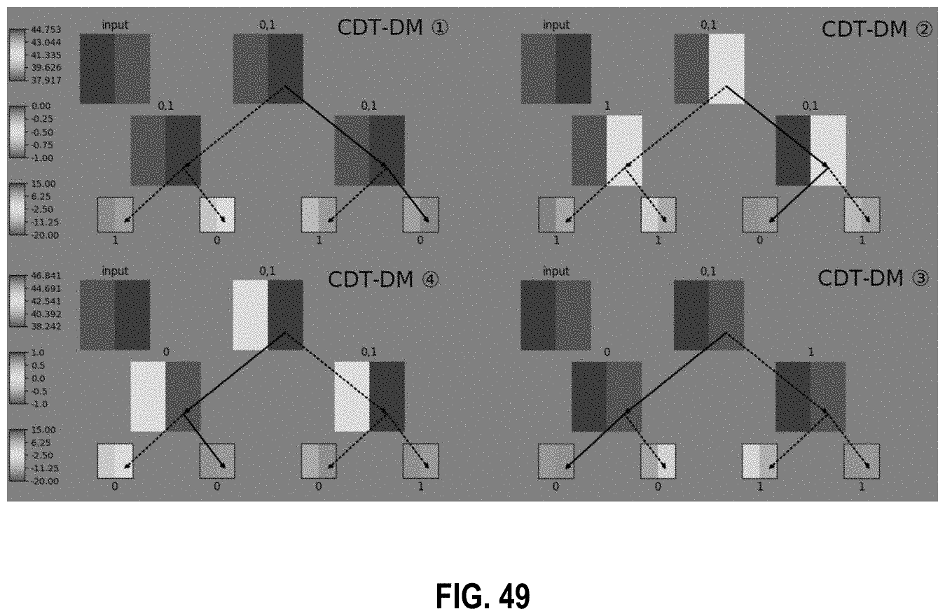

FIG. 48, FIG. 49 shows comparison of four runs with the same setting for CDT (after discretization) imitation learning on CartPole-v1: feature learning trees (FIG. 48) and decision making trees (FIG. 49).

Training Details in Reinforcement Learning

To normalize the states, Applicants collected 3000 episodes of samples for each environment with a well-trained policy and calculate its mean and standard deviation. During training, each state input is subtracted by the mean and divided by the standard deviation.

The hyperparameters for RL are provided in Table 7 for MLP, SDT, and CDT on three environments.

TABLE 7
RL hyperparameters. The “Common” hyperparameters are
shared for both SDT and CDT.

| Tree Type | Env | Hyperparameter | Value |
|---|---|---|---|
| Common | CartPole-v1 | learning rate | 5 × 10⁻⁴ |
| | | γ | 0.98 |
| | | λ | 0.95 |
| | | ϵ | 0.1 |
| | | update iteration | 3 |
| | | hidden dimension | 128 |
| | | (value) | |
| | | episodes | 5000 |
| | | time horizon | 1000 |
| | LunarLander-v2 | learning rate | 5 × 10⁻⁴ |
| | | γ | 0.98 |
| | | λ | 0.95 |
| | | ϵ | 0.1 |
| | | update iteration | 3 |
| | | hidden dimension | 128 |
| | | (value) | |
| | | episodes | 5000 |
| | | time horizon | 1000 |
| | MountainCar-v0 | learning rate | 5 × 10⁻³ |
| | | γ | 0.999 |
| | | λ | 0.98 |
| | | ϵ | 0.1 |
| | | update iteration | 10 |
| | | hidden dimension | 32 |
| | | (value) | |
| | | episodes | 5000 |
| | | time horizon | 1000 |
| MLP | CartPole-v1 | hidden dimension | 128 |
| | | (policy) | |
| | LunarLander-v2 | hidden dimension | 128 |
| | | (policy) | |
| | MountainCar-v0 | hidden dimension | 32 |
| | | (policy) | |
| SDT | CartPole-v1 | depth | 3 |
| | LunarLander-v2 | depth | 4 |
| | MountainCar-v0 | depth | 3 |
| CDT | CartPole-v1 | FL depth | 2 |
| | | DM depth | 2 |
| | | # intermediate variables | 2 |
| | LunarLander-v2 | FL depth | 3 |
| | | DM depth | 3 |
| | | # intermediate variables | 2 |
| | MountainCar-v0 | FL depth | 2 |
| | | DM depth | 2 |
| | | # intermediate variables | 1 |

Additional Reinforcement Learning Results

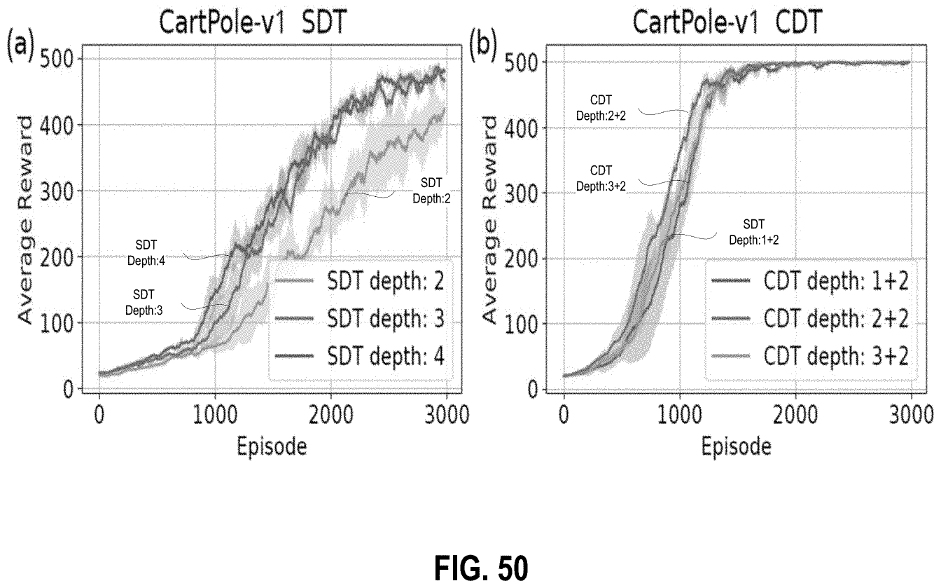

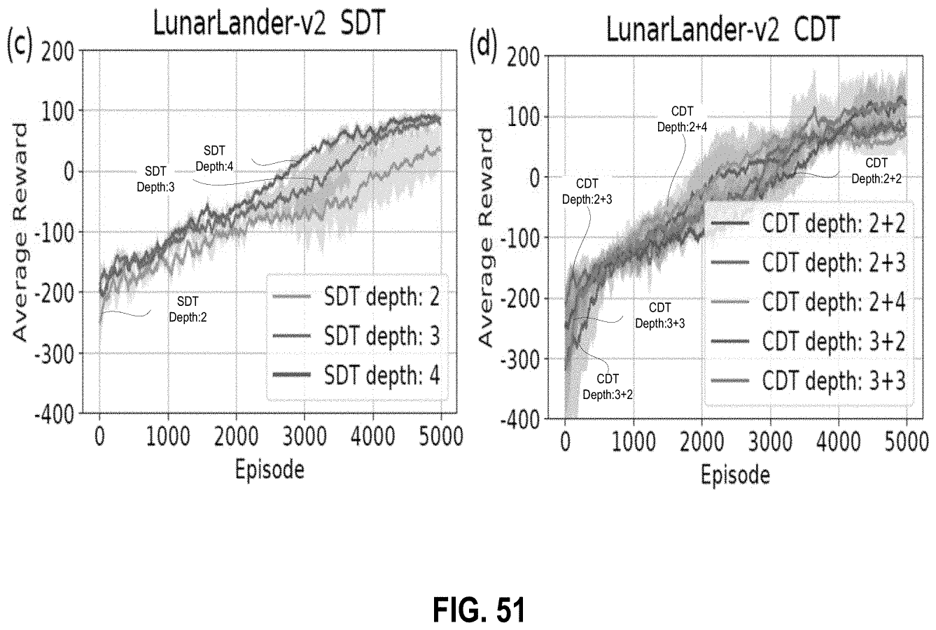

FIG. 50, FIG. 51 displays the comparison of learning curves for SDTs and CDTs with different depths, under the RL settings without state normalization. The results are similar as those with state normalization.

FIG. 50, FIG. 51 are graphs showing comparison of SDTs and CDTs with different depths (state unnormalized). (a) and (b) are trained on CartPole-v1, while (c) and (d) are on LunarLander-v2.

Trees Structures Comparison

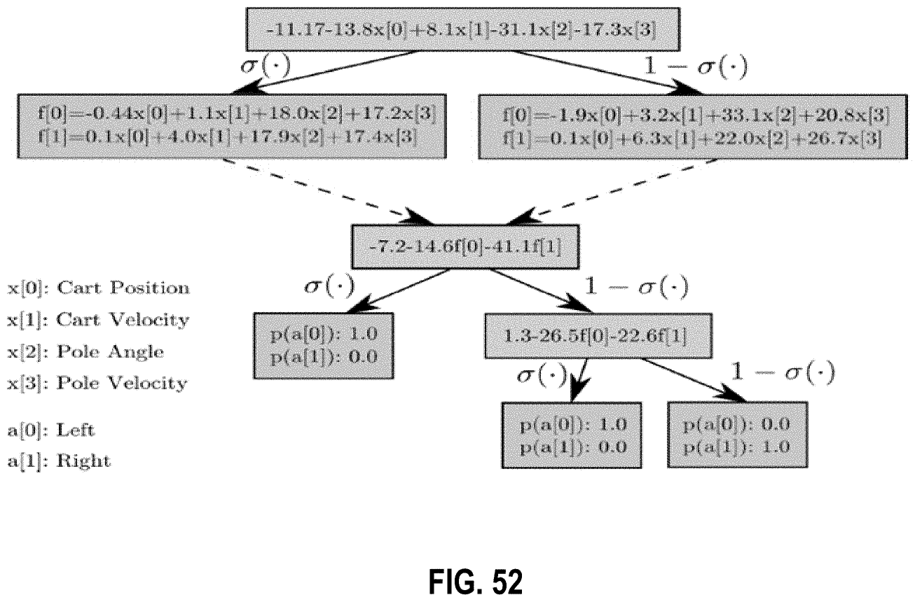

FIG. 52 is a diagram showing the learned CDT (before discretization) of depth 1+2 for CartPole-v1.

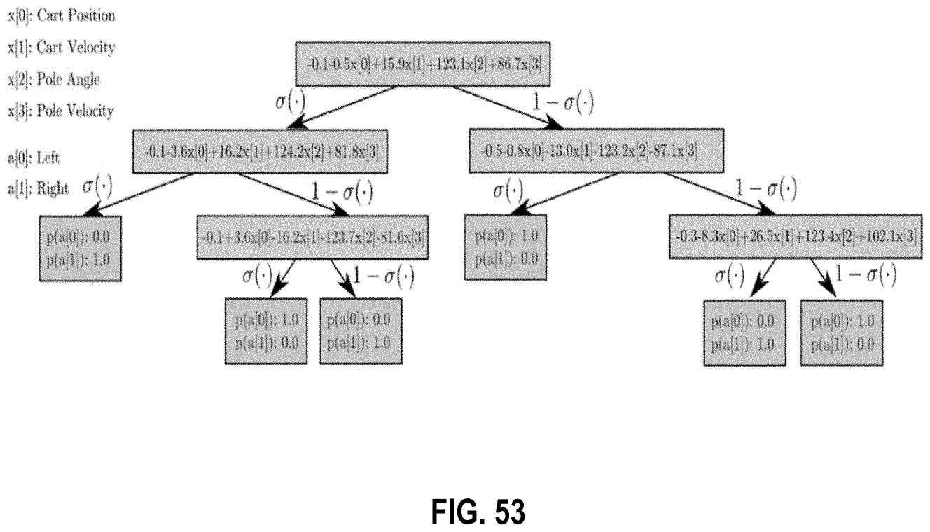

FIG. 53 is a diagram showing the learned SDT (before discretization) of depth 3 for CartPole-v1.

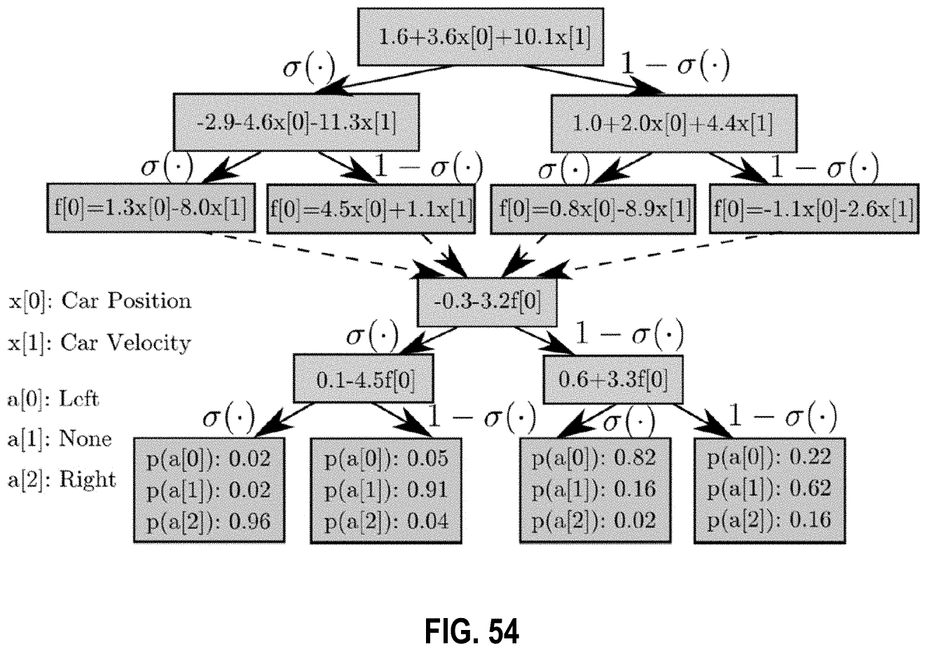

FIG. 54 is a diagram showing the learned CDT (before discretization) of depth 2+2 for MountainCar-v0.

Computer System Implementation

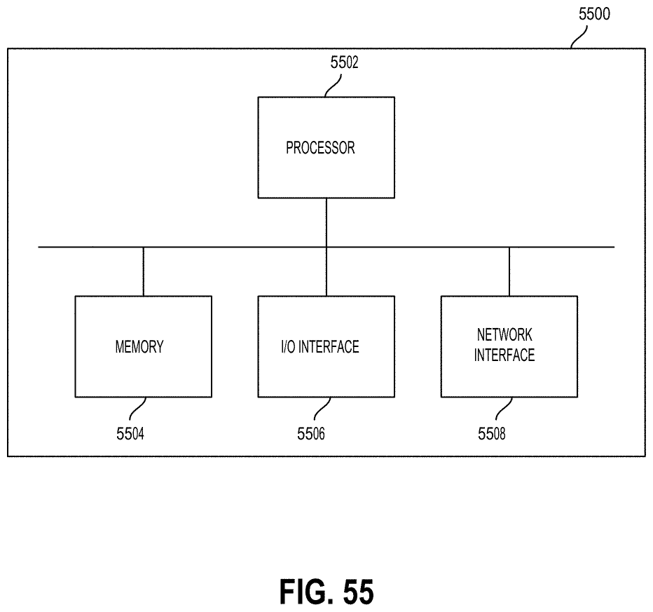

FIG. 55 is an example computer system that can be used to implement a system 1800 as described in various embodiments herein. The system 5500 can include a computer server including software and hardware components, such as a processor 5502, a memory 5504, an input/output interface 5506, and a network interface 5508. The system 5500 is adapted as a specially configured computing device that, in some embodiments, can operate as a software or hardware component of a physical computer server or, in other embodiments, can be a standalone computing device, such as a rack-mounted server appliance.

The system 5500 can receive various inputs through I/O interface 5506 and may be coupled to various message buses or other devices over network interface 5508. These inputs can include raw data data sets, training input/output pairs from target machine learning models to be replicated and converted into explainable form, etc. The system 5500 can generate outputs that are provided through I/O interface 5506 in the form of data sets, such as data structures storing vectors of specific outputs for downstream control, among others. In some embodiments, the output itself is the structure and/or co-efficients or parameter weightings or tunings of the CDTs. This is useful where the CDT is being investigated as an explainable proxy version of the target machine learning model. The message buses can be coupled to devices residing in a data center, and the system 2000 itself can be a device residing in a data center that receives machine learning models to convert into proxy data structures representing CDT versions of the machine learning models.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the embodiments are intended to include within their scope such processes, machines, manufacture, compositions of matter, means, methods, or steps.

As can be understood, the examples described above and illustrated are intended to be exemplary only.

What is claimed is:

1. A system for maintaining a cascading differentiable data structure, the system comprising:
a computer processor operating in conjunction with computer memory and a non-transitory computer readable medium, the computer processor configured to:
maintain the cascading differentiable tree data structure having at least one feature learning tree data structure and a decision making tree data structure, the cascading differentiable tree data structure is capable of generating an output distribution data structure based on processing a set of data values representing a function of raw features x;
wherein each of the at least one feature learning tree data structure includes one or more decision nodes that represent the function ϕ(x; w) of raw features x given a set of parameters w and one or more leaf nodes that each represent an intermediate learned feature f based at least on a corresponding intermediate feature representation function ƒ=ƒ (x; \tilde{w}); and
wherein the decision making tree data structure includes one or more decision nodes each representing a corresponding function ψ(ƒ; w′) of intermediate learned features f given parameters w′ from the feature representation functions of the feature learning tree data structure.

2. The system of claim 1, wherein the system is adapted for improving explainability of a target machine learning architecture, and wherein the cascading differentiable tree data structure is adapted to distill the target machine learning architecture by training the cascading differentiable tree data structure based on the target machine learning architecture to mimic an input-output function of the target machine learning architecture.

3. The system of claim 1, wherein there are two or more feature learning tree data structures that are coupled in a cascade such that an intermediate learned feature f of a preceding feature learning tree data structures is provided as a raw input into a subsequent feature learning tree data structure, and the intermediate learned feature f a final feature learning tree data structure is then provided to the decision making tree data structure.

4. The system of claim 1, wherein there are two or more feature learning tree data structures that are coupled in parallel such that intermediate learned features of a both feature learning tree data structures is concatenated and the concatenation of the intermediate learned features is provided to the decision making tree data structure.

5. The system of claim 1, wherein the decision making tree data structure is utilized to process a perturbed set of intermediate feature representation functions to generate a new output distribution data structure, the perturbed set of feature representation functions being perturbed to modify an explainable parameter represented in the perturbed set of intermediate feature representation functions.

6. The system of claim 1, wherein the functions ϕ(x; w), ƒ=ƒ (x; \tilde{w}), and ψ(ƒ; w′) are linear functions.

7. The system of claim 1, wherein the cascading differentiable tree data structure is a discretized cascading differentiable tree data structure.

8. The system of claim 7, wherein only the at least one feature learning tree data structure is discretized.

9. The system of claim 1, wherein the cascading differentiable tree data structure is utilized in a random forest of decision tree data structures, and generated outputs of the random forest are utilized in concert to determine an aggregated output distribution data structure.

10. The system of claim 1, wherein each leaf node of the at least one feature learning tree data structure represents one possible assignment of intermediate feature values for a total of L possibilities, and during an inference process, the leaf node with the largest probability is used to assign values for the intermediate features.

11. A method for maintaining a cascading differentiable data structure, the method comprising:
maintaining the cascading differentiable tree data structure having at least one feature learning tree data structure and a decision making tree data structure, the cascading differentiable tree data structure is capable of generating an output distribution data structure based on processing a set of data values representing a function of raw features x;
wherein each of the at least one feature learning tree data structure includes one or more decision nodes that represent the function ϕ(x; w) of raw features x given a set of parameters w and one or more leaf nodes that each represent an intermediate learned feature f based at least on a corresponding intermediate feature representation function ƒ=ƒ (x; \tilde{w}); and
wherein the decision making tree data structure includes one or more decision nodes each representing a corresponding function ψ(ƒ; w′) of intermediate learned features f given parameters w′ from the feature representation functions of the feature learning tree data structure.

12. The method of claim 11, wherein the system is adapted for improving explainability of a target machine learning architecture, and wherein the method includes distilling the target machine learning architecture by training the cascading differentiable tree data structure based on the target machine learning architecture to mimic an input-output function of the target machine learning architecture.

13. The method of claim 11, wherein there are two or more feature learning tree data structures that are coupled in a cascade such that an intermediate learned feature f of a preceding feature learning tree data structures is provided as a raw input into a subsequent feature learning tree data structure, and the intermediate learned feature f a final feature learning tree data structure is then provided to the decision making tree data structure.

14. The method of claim 11, wherein there are two or more feature learning tree data structures that are coupled in parallel such that intermediate learned features of a both feature learning tree data structures is concatenated and the concatenation of the intermediate learned features is provided to the decision making tree data structure.

15. The method of claim 11, wherein the decision making tree data structure is utilized to process a perturbed set of intermediate feature representation functions to generate a new output distribution data structure, the perturbed set of feature representation functions being perturbed to modify an explainable parameter represented in the perturbed set of intermediate feature representation functions.

16. The method of claim 11, wherein the functions ϕ(x; w), ƒ=ƒ(x; \tilde{w}), and ψ(ƒ; w′) are linear functions.

17. The method of claim 11, wherein the cascading differentiable tree data structure is a discretized cascading differentiable tree data structure.

18. The method of claim 17, wherein only the at least one feature learning tree data structure is discretized.

19. The method of claim 11, wherein the cascading differentiable tree data structure is utilized in a random forest of decision tree data structures, and generated outputs of the random forest are utilized in concert to determine an aggregated output distribution data structure.

20. A non-transitory computer readable medium storing machine interpretable instructions, which when executed by a processor, cause the processor to perform steps of a method for maintaining a cascading differentiable data structure, the method comprising:
maintaining the cascading differentiable tree data structure having at least one feature learning tree data structure and a decision making tree data structure, the cascading differentiable tree data structure is capable of generating an output distribution data structure based on processing a set of data values representing a function of raw features x;
wherein each of the at least one feature learning tree data structure includes one or more decision nodes that represent the function ϕ(x; w) of raw features x given a set of parameters w and one or more leaf nodes that each represent an intermediate learned feature f based at least on a corresponding intermediate feature representation function ƒ=ƒ (x; \tilde{w}); and
wherein the decision making tree data structure includes one or more decision nodes each representing a corresponding function ϕ(ƒ; w′) of intermediate learned features f given parameters w′ from the feature representation functions of the feature learning tree data structure.
